(19) United States
(12) Patent Application Publication
(10) Pub. No.: US 2023/0008803 A1
(43) Pub. Date: Jan. 12, 2023

(54) PERSONALIZED VISITOR CONNECTION

(71) Applicant: WeWork Companies LLC, New York, NY (US)

(72) Inventors: Alexander Michel Reichert, San Francisco, CA (US); Michael Maurice Weithers, San Francisco, CA (US); Paul Frederick Arnaudo, San Francisco, CA (US)

(21) Appl. No.: 17/695,656

(22) Filed: Mar. 15, 2022

Related U.S. Application Data
(63) Continuation of application No. 16/814,496, filed on Mar. 10, 2020, now abandoned.
Application No. 16/814,496 is a continuation of application No. 15/224,230, filed on Jul. 29, 2016, now abandoned.
(60) Provisional application No. 62/357,192, filed on Jun. 30, 2016.

(51) Int. Cl. G06Q 30/02; H04W 4/02; H04W 4/14

(52) U.S. Cl. CPC G06Q 30/0201; H04W 4/023; H04W 4/14; H04W 84/12

(57) ABSTRACT

Determining a user identity associated with a detected device is disclosed. A presence of a device at a location is detected based at least in part on traffic data obtained from a sensor. An identity of a user associated with the device whose presence is detected at the location is determined. An action is performed based at least in part on the determined user identity.

### CROSS REFERENCE TO OTHER APPLICATIONS

This application claims priority to U.S. Provisional Patent Application No. 62/357,192 entitled PERSONALIZED VISITOR CONNECTION filed Jun. 30, 2016 which is incorporated herein by reference for all purposes.

### BACKGROUND OF THE INVENTION

Technology is increasingly being used to track individuals as they visit retail shops and other locations. As one example, door counting devices can be used by a retail store to track the number of visitors to a particular store (e.g., entering through a particular door or set of doors) each day. As another example, in-store cameras can be used to monitor the movements of visitors (e.g., observing whether they turn right or left after entering the store). A variety of drawbacks to using such technologies exist. One drawback is cost: monitoring technology can be expensive to install, maintain, and/or run. A second drawback is that such technology is limited in the insight it can provide. For example, door counts do not distinguish between employees (who might enter and leave the building repeatedly during the course of the day) and shoppers. A third drawback is that such technology can be overly invasive. For example, shoppers may object to being constantly surveilled by cameras—particularly when the cameras are used for reasons other than providing security (e.g., assessing reactions to marketing displays).

### BRIEF DESCRIPTION OF THE DRAWINGS

Various embodiments of the invention are disclosed in the following detailed description and the accompanying drawings.

FIG. 1A illustrates an example of an environment in which sensors collect data from mobile electronic devices and the collected data is processed.

FIG. 1B depicts a graphical representation of example strengths and durations and how classifications can be made.

FIG. 2 illustrates an embodiment of a traffic insight platform.

FIG. 3 illustrates a variety of example zoning rules and settings.

FIG. 4A illustrates an example of a zoning metric table.

FIG. 4B illustrates an example of a zoning metric table.

FIG. 4C illustrates an example of a zoning metric table.

FIG. 5 illustrates an embodiment of a process for determining qualified devices using zone information.

FIGS. 6-8 show interfaces depicting zoning information for a national retailer at a particular location in Boston.

FIGS. 9-15 show interfaces depicting zoning information for an airport.

FIGS. 16A and 16B show interfaces depicting zoning information for a hotel.

FIGS. 17-20 show examples of interfaces for creating an event.

FIGS. 21-22 show examples of event summary page interfaces.

FIG. 23 shows an example of an interface depicting loyalty information.

FIG. 24 shows an example of an interface in which a comparison between two periods' re-engagement is displayed.

FIG. 25 shows an example of an interface in which options for including visitor loyalty data in a dashboard view is displayed.

FIG. 26 illustrates an embodiment of a process for assessing visitor composition.

FIG. 27-30 depict an example implementation of an events pipeline wrapper script.

FIG. 31 depicts sample data from an event frequency table.

FIG. 32 illustrates an embodiment of a process for determining co-visits by visitors.

FIG. 33 illustrates an embodiment of a process for determining re-visitation by visitors.

FIG. 34 illustrates an embodiment of a process for assessing visitor frequency during an event.

FIG. 35 illustrates an example of an environment in which sensors collect data from mobile electronic devices and information about the users of the mobile electronic devices is obtained.

FIG. 36 illustrates an embodiment of a traffic insight platform, such as platform 170.

FIG. 37 illustrates an example embodiment of a streaming connect engine

FIG. 38 is a diagram illustrating an example embodiment of an opt-out solution.

FIG. 39 is a diagram illustrating an example embodiment of a hybrid opt-in and opt-out solution.

FIG. 40 is an example embodiment of a user interface for initial login.

FIG. 41 illustrates an example experience for shoppers of a store.

FIG. 42 is an example embodiment of an interface for engagement of a shopper in or near a store.

FIG. 43 is an example embodiment of an interface for engagement of a shopper while outside of a store.

FIG. 44 illustrates an example embodiment of a flow in which a device's user is identified and the user is contacted.

FIG. 45 is an example embodiment of interfaces displaying relevant realtime information that can be provided.

FIG. 46 illustrates example interfaces for engagement and personalization.

FIG. 47 is an example embodiment of interfaces for providing rich shopper insights.

FIG. 48 is an example embodiment of a segmentation builder interface.

FIG. 49A illustrates an example embodiment of an interface for exploring zoning.

FIG. 49B illustrates an example embodiment of an interface for exploring zoning.

FIG. 50A illustrates an example embodiment of opt-in portal POC interfaces.

FIG. 50B illustrates an example embodiment of a segmentation builder and export interface.

FIG. 51 illustrates an example embodiment of a segments view for a location.

FIG. 52 illustrates an example embodiment of a segments view.

FIG. 53 illustrates an example showing analysis of behavior of customer segments.

FIG. 54 illustrates an example of email capture and attribution.

FIG. 55 illustrates an example experience for entities utilizing the services of a traffics insight platform.

FIG. 56 is a diagram illustrating an example embodiment of benefits of a multi-location network provided by a traffic insights platform.

FIG. 57 illustrates an example embodiment of capabilities provided by a traffics insight platform.

FIG. 58 illustrates an embodiment of a timeline associated with attributing device visits to the sending of time sensitive emails.

FIG. 59 is a flow diagram illustrating an embodiment of a process for associating a user identity with a device.

FIG. 60 is a flow diagram illustrating an embodiment of a process for obtaining information associated with a user associated with a detected device.

FIG. 61 illustrates an example embodiment of a flow diagram for generating a profile for an anonymous user of a device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

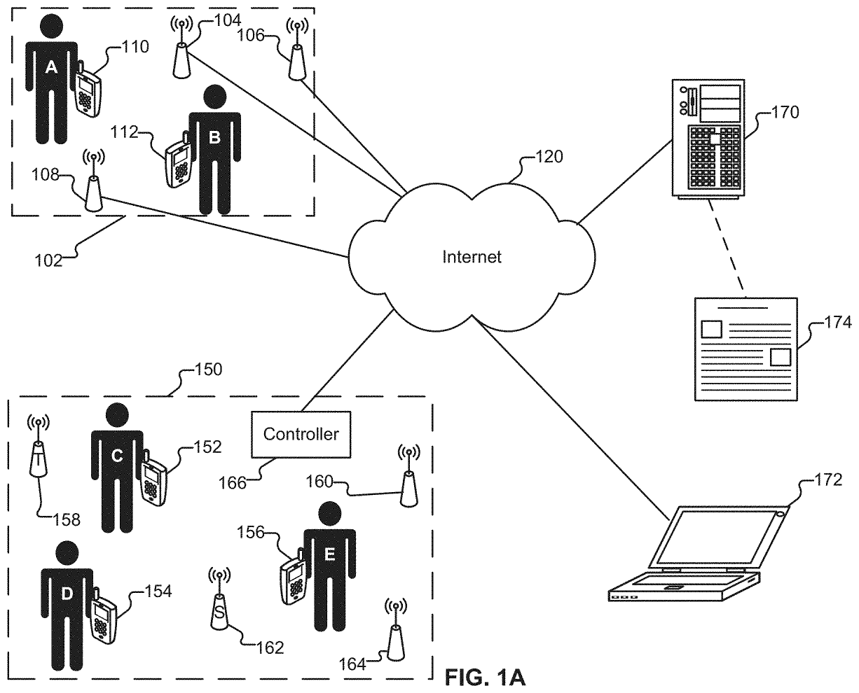

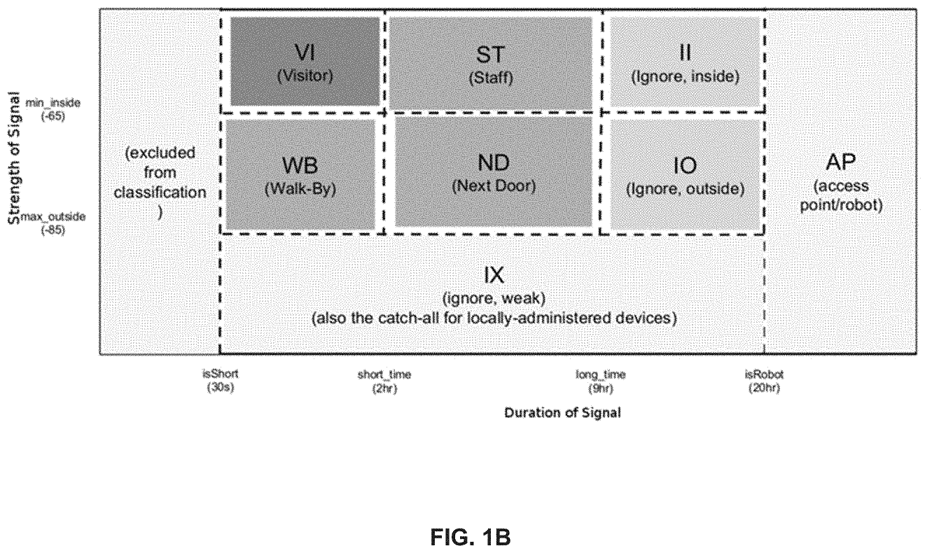

FIG. 1A illustrates an example of an environment in which sensors collect data from mobile electronic devices and the collected data is processed. In the example shown, Alice and Bob are present in a retail space 102. In particular, Alice and Bob are both shoppers shopping at a brick-and-mortar clothing store (hereinafter “ACME Clothing”). Included in retail space 102 are a set of sensors (104-108). Sensors 104-108 are WiFi access points (e.g., offering WiFi service to customers and/or providing service to point-of-sales and other store infrastructure). Sensors 104-108 each detect wireless signals from mobile electronic devices. In the example shown in FIG. 1A, Alice and Bob each carry a mobile device (e.g., cellular phones 110 and 112, respectively).

Also included in the environment shown in FIG. 1A is an airport space 150. Charlie and Dave are passengers in airport space 150, and Eve is an employee at a bookstand. Charlie, Dave, and Eve each carry respective mobile devices 152-156. Sensors, including sensors 158-164 are present in airport space 150.

The sensors depicted in FIG. 1A (i.e., sensors 104-108 and 158-164) are commodity WiFi access points. Other sensors can also be used in conjunction with techniques described herein as applicable. As will be described in more detail below, the sensors included in spaces 102 and 150 can be grouped into zones (an arbitrary collection of sensors). For example, suppose retail space 102 is a two story building, with sensors 108 and 110 on the first floor, and sensor 106 on the second floor. Sensors 108 and 110 can be grouped into a “First Floor” zone, and Sensor 106 can be the sole sensor placed in a “Second Floor” zone.

Floors are one example of zoning, and tend to work well in retail environments (e.g., due to WiFi resolution of approximately 10 meters). Other segmentations can also be used for zoning (including in retail environments), depending on factors such as wall placement, as applicable. As another example, airport space 150 might have several zones, corresponding to areas such as “Ticketing,” “A Gates,” “B Gates,” “Pre-Security Shops,” “A Gate Security,” “Taxis,” etc. Further, the zones can be arranged in a hierarchy. Using airport space 150 as an example, two hierarchical zones could be: Airport-Terminal 1-A Gates and Airport-Terminal 2-Pre-Security Shops.

As will be described in more detail below, signal strength and signal duration can be used to classify devices observed by a sensor. FIG. 1B depicts a graphical representation of example strengths and durations and how classifications can be made. Signal strength can be used as an indicator of whether an observed device is within the geographic confines of a sensor's zone. In some embodiments, if the device is determined to be within the geographic boundaries of the sensor's zone, it is classified as a visitor. If the signal is weak enough that it is determined to be outside the boundaries of the sensor's zone, it is determined to be a walk-by. If a zone has more than one sensor, multiple sensor readings can be used to determine if a device is a visitor or a walk-by. Certain devices can also be determined to be access points or other devices that do not belong to visitors or walk-bys, as illustrated in FIG. 1B. By measuring the length of time that the device is seen, for example, a determination can be made (e.g., probabilistically) whether a device belongs to staff, happens to be an access point inside the zone, and/or is otherwise a device type that should be ignored (e.g., a printer or point-of-sales terminal).

Onboarding

In the following discussion, suppose a representative of ACME Clothing would like to gain insight about shopper traffic in the store. Examples of information ACME Clothing would like to learn include how many shoppers visit the second floor of the store in a given day, how much total time shoppers spend in the store, and how much time they spend on the respective floors of the store. Using techniques described herein, ACME Clothing can leverage commodity WiFi access points to learn the answers to those and other questions. In particular, in various embodiments, ACME Clothing can leverage the access points that it previously installed (e.g., to provide WiFi to shoppers and/or staff/sales infrastructure) without having to purchase new hardware.

In various embodiments, ACME Clothing begins using the services of traffic insight platform 170 as follows. First, a representative of ACME Clothing (e.g., via computer 172) creates an account on platform 170 on behalf of ACME Clothing (e.g., via a web interface 174 to platform 170). ACME Clothing is assigned an identifier on platform 170 and a variety of tables (described in more detail below) are initialized on behalf of ACME Clothing.

A first table (e.g., a MySQL table), referred to herein as an “asset table,” stores information about ACME Clothing and its sensors. The asset table can be stored in a variety of resources made available by platform 170, such as relational database system (RDS) 242. To populate the table, the ACME representative (hereinafter referred to as Rachel) is prompted to provide information about the access points present in space 102, such as their Media Access Control (MAC) addresses, and, as applicable, vendor/model number information. Rachel is also asked to optionally provide grouping information (e.g., as applicable, to indicate that sensors 108 and 110 are in a “First Floor” group and 112 is in a “Second Floor group). The access point information can be provided in a variety of ways. As one example, Rachel can be asked to complete a web form soliciting such information (e.g., served by interface 174). Rachel can also be asked to upload a spreadsheet or other file/data structure to platform 170 that includes the required information. The spreadsheet (or portions thereof) can be created by Rachel (or another representative of ACME Clothing) or, as applicable, can also be created by networking hardware or other third party tools. Additional (optional) information can also be included in the asset table (or otherwise associated with ACME Clothing's account). For example, a street address of the store location, city/state information for the location, time-zone information for the location, and/or latitude/longitude information can be included, along with end-user-friendly descriptions (e.g., providing more information about the zones, such as that the “Zone 1” portion of ACME includes shoes and accessories, and that “Zone 2” includes outerwear).

The zoning hierarchy framework is flexible and can easily be modified by Rachel, as needed. For example, after an initial set up ACME Clothing's zones, Rachel can split a given zone into pieces, or combine zones together (reassigning sensors to the revised zones as applicable, adding new sensors, etc.). The asset table on platform 170 will be updated in response to Rachel's modifications.

In some embodiments, Rachel is asked to provide MAC addresses (or other identifiers) of known non-visitor devices. For example, Rachel can provide the identifiers of various computing equipment present in space 102 (e.g., printers, copiers, point of sales terminals, etc.) to ensure that they are not inadvertently treated by platform 170 as belonging to visitors. As another example, Rachel can provide the identifiers of staff-owned mobile computing devices (and designate them as belonging to staff, and/or designate them as to be ignored, as applicable). As will be described in more detail below, Rachel need not supply such MAC addresses, and platform 170 can programmatically identify devices that are probabilistically unlikely to belong to visitors and exclude them from analysis as applicable.

In the example of FIG. 1A, ACME Clothing is a single location business. Techniques describes herein can also be used in conjunction with multi-location businesses. In such a scenario, additional hierarchical information can be provided during onboarding. As one example, a retail store with 50 locations could organize its access points into geographical or other regions (e.g., with West Coast-California-Store 123-First Floor-AA:12:34:56:78:FF and West Coast-Nevada-Store 456-Second Floor-BB:12:34:56:67:FF being two examples of information supplied to platform 170 about two sensors). In some cases, a parent company may own stores of multiple brands. For example, Beta Holding Company may own both “Beta Electronics Retail” and “Delta Electronics Depot.” The assets table for Beta Holding Company can accordingly include the respective brand names in the hierarchy of access points if desired (e.g., “Beta Holding Company-Beta Electronics Retail-California-Store 567 . . . ” and “Beta Holding Company-Delta Electronics Depot-Texas-Store 121 . . . ”).

Ingesting Sensor Data

Rachel is provided (e.g., via interface 174) with instructions for configuring sensors 104-108 to provide platform 170 with data that they collect. Typically, the collected data will include the MAC addresses and signal strength indicators of mobile devices observed by the sensors, as well as applicable timestamps (e.g., time/duration of detection), and the MAC address of the sensor that observed the mobile device. For some integrations, the information is sent in JSON using an existing Application Programming Interface (API) (e.g., by directing the hardware to send reporting data to a particular reporting URL, such as http://ingest.euclidmetrics.com/ACMEClothing or hardware vendor tailored URLs, such as http://cisco.ingest.euclidmetrics.com or hp.ingest.euclidmetrics.com, as applicable, where the data is provided in different formats by different hardware vendors). Accordingly, the configuration instructions provided to Rachel may vary based on which particular hardware (e.g., which manufacturer/vendor of commodity access point) is in use in retail space 102. For example, in some cases, the sensors may report data directly to platform 170 (e.g., as occurs with sensors 104-108). In other cases, the sensors may report data to a controller which in turn provides the data to platform 170 (e.g., as occurs with sensors 158-164 reporting to controller 166).

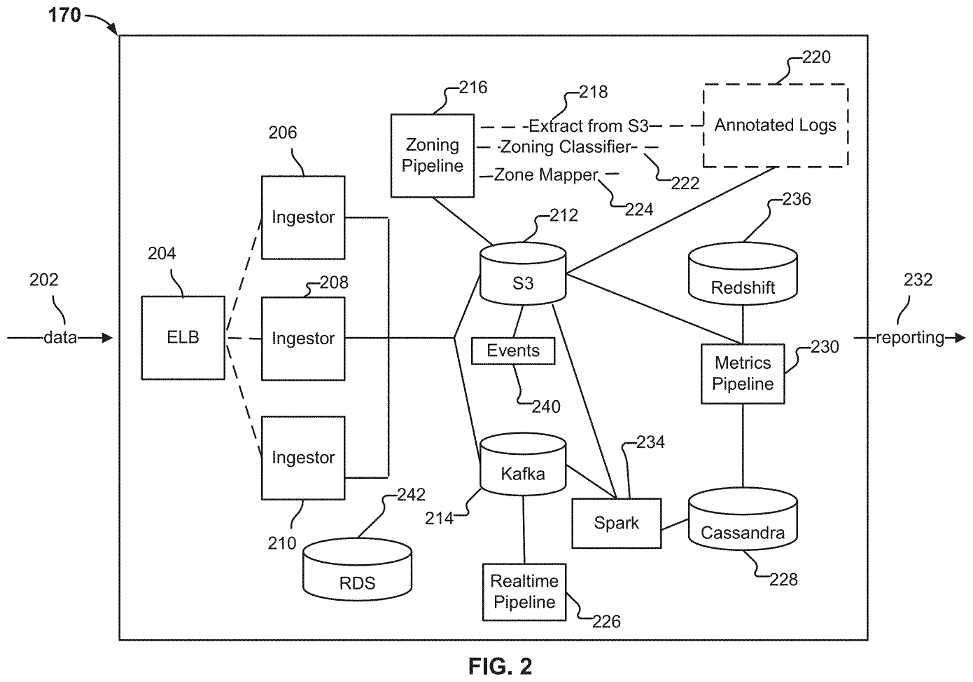

In the example environment shown in FIGS. 1A, and in FIG. 2, platform 170 is implemented using cloud computing resources, such as Amazon Web Services (AWS) Google Cloud, or Microsoft's Azure. Resources described herein (or portions thereof) can also be provided by dedicated hardware (e.g., operated by an entity on behalf of itself, such as a governmental entity). Whenever platform 170 is described as performing a task, a single component, a subset of components, or all components of platform 170 may cooperate to perform the task. Similarly, whenever a component of platform 170 is described as performing a task, a subcomponent may perform the task and/or the component may perform the task in conjunction with other components. Various logical components and/or features of platform 170 may be omitted and the techniques described herein adapted accordingly. Similarly, additional logical components/features can be added to appliance 170 as applicable.

As shoppers, such as Alice and Bob, walk around in retail space 102, data about the presence of their devices (110 and 112) is observed by sensors (e.g., sensors 104-108) and reported to platform 170. For example, the MAC addresses of devices 110/112, and their observed signal strengths are reported by the observing sensors. The ingestion of that data will now be described, in conjunction with FIG. 2.

FIG. 2 illustrates an embodiment of a traffic insight platform, such as platform 170. Platform 170 receives data 202 (via one or more APIs) into an AWS elastic cloud load balancer (204), which splits the ingestion infrastructure across multiple EC2 instances (e.g., ingestors 206-210). The ingestors create objects out of the received data, which are ultimately written (e.g., as JSON) to disk (e.g., as hourly writes to S3) 212 and a real time messaging bus (e.g., Apache Kafka).

The ingestors are built to handle concurrent data ingestion (e.g., using Scala-based spray and Akka). As mentioned above, data provided by customers such as ACME Clothing typically arrives as JSON, though the formatting of individual payloads may vary between customers of platform 170. As applicable, ingestors 206-210 can rewrite the received data into a canonical format (if the data is not already provided in that format). For example, in various embodiments, ingestors 206-210 include a set of parsers specific to each customer and tailored to the sensor hardware manufacturer(s) used by that customer (e.g., Cisco, Meraki, Xirrus, etc.). The parsers parse the data provided by customers and normalize the data in accordance with a canonical format. In various embodiments, additional processing is performed by the ingestors. In particular, the received MAC addresses of mobile devices are hashed (e.g., for privacy reasons) and, in some embodiments, compared against a list of opted-out MAC addresses. Additional transformations can also be performed. For example, in addition to hashing the MAC address, a daily seed can be used (e.g., a daily seed used for all hashing operations for a 24-hour period), so that two different hashes will be generated for the same device if it is seen on two different days. If data is received for a MAC that has opted-out, the data is dropped (e.g., not processed further). One way that users can opt-out of having their data processed by platform 170 is to register the MAC addresses of their mobile devices with platform 170 (e.g., using a web or other interface made available by platform 107 and/or a third party).

As a given ingestor processes the data it has received, it writes to a local text log. Two example log lines written by an ingestor instance (e.g., ingestor 206) and in JSON are as follows:

```
  Apr. 8, 2015 4:00:00 PM org.apache.jsp.index_jsp_jspService
  INFO: {″SN″:″40:18:B1:38:7A:40', ″pf″:1, ″ht″:[{″sl″:-
89,″ot″:1396972150,″s2″:46122,″is″:667, ″sm″:″88329B″,
″so″:-89, ″sc″:-89, ″il″:0, ″sh″:-86, ″ct″:1396972151, ″si″:
″b533c82bfeef4232″,″ih″:624, ″ap″:0, ″cn″:6, ″ss″:-
526, ″cf″:5180, ″i3″:243039545, ″s3″:-4044994, ″i2″:391057}],
″tp″:″ht″, ″sq″:846077, ″vs″:3}
  Apr. 8, 2015 4:00:00 PM org.apache.jsp.index_jsp_jspService
  INFO: {″sn″:″40:18:B1:39:32:C0″, ″pf″:1, ″ht″:[{″sl″:-
68, ″ot″:1396972136, ″s2″:54162, ″is″:1285, ″sm″:″68A86D″,
″so″:-53, ″sc″:-61, ″il″:20, ″sh″:-
52, ″ct″:1396972138, ″Si″:″2e5e1d2807e5d3ad″, ″is″:604,
″ap″:0, ″cn″:15, ″ss″:-898, ″cf″:2437, ″i3″:22667320, ″s3″:-
3290416, ″i2″:420062}], ″tp″:″ht″, ″sq″:830438, ″vs″:3}
```

In the above example log lines, “sn” is a serial number (or) MAC of the sensor that observed a mobile device (i.e., that has transmitted the reporting data to platform 107, whether directly or through a controller). The “pf” is an identifier of the customer sending the data. The “ht” is an array of detected devices, and includes the following:

s1: minimum signal strength

ot: timestamp of first frame (unix time in seconds)

s2: sum of the signal strength squared (to calculate variance)

is: sum of intervals (in seconds)

sm: station organizationally unique identifier or manufacturer identifier

so: first signal strength detected

sc: last signal strength detected

il: minimum interval (in seconds)

sh: maximum signal strength

ct: timestamp of last frame (unix time in seconds)

si: station identifier/detected device identifier, hashed

ih: maximum interval (in seconds)

ap: a flag indicating whether the reporting sensor is an access point or not

cn: count of number of frames summarized in this message for this device

ss: summation of signal strength (a negative number)

cf: frequency last frame received on

i3: sum of interval cubed

s3: sum of signal strength cubed (to calculate skew)

i2: sum of interval squared

The “tp” value indicates the type of message (where “ht” is a hit—a device being seen by the sensor, and “hl” is a health message—a ping the sensor sends during periods of inactivity). The “sq” value is a sequence number—a running count of messages from the sensor (and, in some embodiments, resets to zero if the sensor reboots). The “vs” value is a version number for the sensor message.

Once an hour, a script (e.g., executing on ingestor 206) gzips the local ingestor log and pushes it to an S3 bucket. The other ingestors (e.g., ingestor 208 and 210) similarly provide gzipped hourly logs to the S3 bucket, where they will be operated on collectively. The logs stored in S3 are loaded (e.g., by a job executing on the S3 bucket) into MySQL and Redshift, which is in turn used by metrics pipeline 230.

Further, as the ingestors are writing their local logs, threads on each of the ingestors (e.g., Kafka readers) tail the logs and provide the log data to a Kafka bus for realtime analysis (described in more detail below) on an EC2 instance.

Zoning Pipeline

A variety of jobs execute on platform 170. Zoning-related jobs are represented in FIG. 2 as “zoning pipeline” 216. Various portions of the zoning pipeline are written in scripting languages (e.g., as python scripts) or written using S3 tools, etc., as applicable. The zoning pipeline is collectively executed by a cluster of EC2 instances working in parallel (e.g., using a Map Reduce framework) and runs as a batch job (e.g., runs once a day). Other pipelines described herein (e.g., realtime pipeline 226 and metrics pipeline 230) are similarly collections of scripts collectively executed by a cluster of EC2 instances.

Extract from S3

Each day (or another unit of time, as applicable, in alternate embodiments), the following occurs on platform 170. In a first stage, “Extract from S3” (218) the zoning pipeline reads the logs (provided by ingestors 206-210) stored in an S3 bucket the previous day. A “metadata join” script executes, which annotates the log lines with additional (e.g., human friendly) metadata. As one example, during the execution of the metadata join, the MAC address of a reporting sensor (included in the log data) is looked up (e.g., in an asset table) and information such as the human friendly name of the owner of the sensor (e.g., “ACME Clothing”), the human friendly location (e.g., “SF Store” or “Store 123, the hierarchy path (as applicable), etc. are annotated into the log lines. Minute-level aggregation is also performed, using the first seen, last seen, and max signal strength values for a given minute for a given device at a given sensor to collapse multiple lines (if present for a device-sensor combination) into a single line. So, for example, if sensor 108 has made six reports (in a one minute time interval) that it has seen device 122, during minute level aggregation, the six lines reported by sensor 108 are aggregated into a single line, using the strongest maximum signal strength value.

The output of the “Extract from S3” process (annotated log lines, aggregated at the minute level) is written to a new S3 bucket for additional processing. As used hereinafter, the newly written logs (i.e., the output of “Extract from S3”) is a daily set of “annotated logs.”

Zoning Classification

The next stage of the zoning pipeline makes a probabilistic determination of whether a given mobile electronic device for which data has been received (e.g., by platform 170 from retail space 102) belongs to a shopper (or, in other contexts, such as airport space 150, other kinds of visitors, such as passengers) or represents a device that should (potentially) be excluded from additional processing (e.g., one belonging to a store employee, a point-of-sale terminal, etc.). The filtering determination (e.g., “is visitor” or not) is made using a variety of features/parameters, described in more detail below. The determination is described herein as being made by a “zoning classifier” (222) which is a piece of zoning pipeline 216 (i.e., is implemented using a variety of scripts collectively executing on a cluster of EC2 instances, as with the rest of the zoning pipeline).

During processing of the most recently received daily log data (i.e., the most recently processed annotated logs), zoning classifier 222 groups that daily log data by device MAC. For example, all of Alice's device 110 log entries are grouped together, and all of Bob's device 112 log entries are grouped together. The grouped entries are sorted by timestamp (e.g., with Alice's device 110's first time stamp appearing first, and then its second time stamp appearing next, etc.). In various embodiments, a decision tree of rules is used to filter devices. In some embodiments, at each level, the tree branches, and non-visitor devices are filtered out. One example of a filtering rule is the Boolean, “too short.” This Boolean can be appended to any device seen for less than thirty seconds, for example. The “too short” Boolean is indicative of a walk-by—someone who didn't linger long enough to be considered a visitor. A second example of a filtering rule is the Boolean, “too long,” which is indicative of a “robot” device (i.e., not a personal device carried by a human). This Boolean can be appended to any device (e.g., a cash machine, printer, point of sale terminal, etc.) that is seen for more than twenty hours in a given day, for example.

More complex filtering rules can also be employed. As one example, suppose Eve (an employee at a bookstand in airport space 150) has a personal cellular phone 156. On a given day (e.g., where Eve works a four hour shift), Eve's device 156 might appear to be similar to a passenger's device (e.g., seen in various locations within the airport over a four hour period of time). However, by examining a moving ten-day window of annotated log data, Eve's device can be filtered from consideration of belonging to a customer. Accordingly, in various embodiments, zoning classifier 222 reads the last ten days (or another appropriate length of time) of annotated logs into RAM, and provides further annotations (e.g., as features) appended to each row of the annotated logs stored in RAM. As one example, a feature of “how many days seen” can be determined by examining the last ten day of annotated log data, and a value (e.g. “2” days or “3” days, etc.) associated with a given device, as applicable, and persisted in memory. Further, if the number of days exceeds a threshold (three days or more), an additional feature “exhibits employee-like behavior” can be associated with Eve's device. Another feature, “seen yesterday” can similarly be determined used to differentiate visitors from employees.

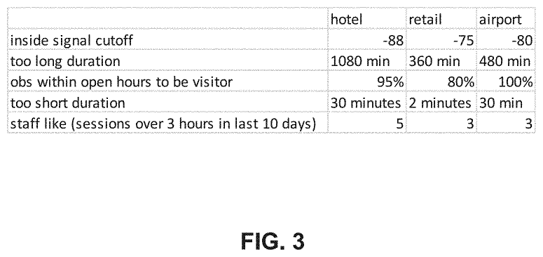

Example rules and settings for a variety of kinds of customers are shown in FIG. 3. Rules (and threshold values, also referred to herein as parameters) can be customized based on customer type/customer needs (e.g., via interface 174), and form a “zoning” model for each location. As one example, one filtering rule that can be used is “seen within hours of operation” (the hours of which will vary based on customer, and can be defined as a parameter, e.g., by an employee like Rachel). Similarly, while a single retail example is shown in FIG. 3, different retail environments can specify different parameters/thresholds for those features as applicable. For example, parameters applicable to a boutique clothing store on Rodeo Drive (with too short=30 seconds or repeat visits in ten days>2 being indicative of an employee device) may be different from those applicable to a grocery store in Topeka (with too short=120 seconds or repeat visitors in ten days>4 being indicative of an employee device). Some features may have binary parameters indicative of whether or not a device is a visitor or not. For example, if a device is flagged as being observed “too long,” a zoning model can use that information to conclude that the device is not a visitor. Other features may have varying weights assigned to them, and the determination of whether a device is a visitor or not may be made dependant on the combination of features observed (and the weights assigned). For example, a high number of repeat visits to a coffee shop, while indicative of an employee device, could also plausibly be a loyal customer device. Accordingly, a zoning model for the coffee shop may weight repeat visits as being less probative of whether a device belongs to a customer or not. In various embodiments, platform 170 makes available a variety of default zoning models (e.g.: hotel, indoor shopping mall, outdoor shopping mall, etc.) which can be customized as applicable (e.g., by a user of computer 172 via interface 174).

An example of a device which could survive a filtering decision tree is one that is seen more than 30 seconds, seen fewer than five hours, has a received signal strength indicator (RSSI) of at least 50, and is not seen more than twice in the last ten days. Such a device is probabilistically likely to be a visitor. Devices which are not filtered out are labeled with a Boolean flag of “is visitor” and processing on the data for those devices continues. In various embodiments, the annotated log data for the day being operated on (i.e., for which metrics, described in more detail below, are calculated) is referred to as a “qualified log” once employee/printer/etc. devices have been removed and only those devices probabilistically corresponding to visitors remain. The next stage of classification is to determine “sessions” using the qualified log lines.

As used herein, a “pre-session” is a set of qualified log lines (for a given mobile electronic device) that split on a gap of 30 or minutes. A pre-session is an intermediate output of the zoning classifier. Suppose Alice's device 110 is observed (e.g., by sensor 108) for fifteen minutes, starting at 13:01 on Monday. The annotated log contains fifteen entries for Alice (due to the minute-level aggregation described above). The zoning classifier generates a pre-session for Alice, which groups these fifteen entries together. Suppose Bob's device 112 is observed (e.g., by sensor 108) for two minutes, then is not observed for an hour, and then is seen again for an additional ten minutes on Monday. The zoning classifier will generate two pre-sessions for Bob because there is a one hour gap (i.e., more than 30 minute gap) between times that Bob's device 112 was observed. The first pre-session covers the two minute period, and the second pre-session covers the ten minute period. As yet another example, if Charlie's device 152 is observed for four consecutive hours on a Wednesday, Charlie will have a single pre-session covering the four-hour block of annotated logs pertinent to his device's presence being detected in airport space 150.

In some cases, a pre-session may include data from only a single sensor. As one example, suppose Alice is on the second floor of retail space 102 (which only includes a single access point, sensor 106). Alice's pre-session might accordingly only include observations made by sensor 106. In other cases, a pre-session may include data from multiple sensors. As one example, suppose Charlie (a passenger) arrives at airport space 150, checks in for his flight (in the Ticketing area), purchases a magazine at a pre-security shop, proceeds through security, and then walks to his gate (e.g., gate A15). Charlie is present in airport space 150 for four hours, and his device 152 is observed by several sensors during his time in airport space 150. As mentioned above, Charlie's pre-session is (in this example) four hours long. In some cases, a single sensor may have observed Charlie during a given minute. For example, when Charlie first arrives at airport space 150, his device 152 is observed by a sensor (158) located in the Ticketing area for a few minutes. Once he is checked in, and he walks toward the pre-security shopping area, his device 152 is observed by both the Ticketing area sensor (158) and a sensor (162) located in the pre-security shopping area for a few minutes. Suppose, for example, twenty minutes into Charlie's presence in airport space 150, device 152 is observed by both sensor 158 (strongly) and sensor 162 (weakly). As Charlie gets closer to the stores, the signal strength reported with respect to his device will become weaker with respect to sensor 158 and stronger with respect to sensor 162. In various embodiments, the classifier examines each minute of a pre-session, and, where multiple entries are present (i.e., a given device was observed by multiple sensors), the classifier selects as representative the sensor which reported the strongest signal strength with respect to the device. A variety of values can be used to determine which sensor reported the strongest signal strength for a given interval. As one example, the max signal strength value (“sh”) can be used. In various embodiments, this reduction in log data being considered is performed earlier (e.g., during minute level aggregation), or is omitted, as applicable.

Next, a zone mapper 224 (another script or set of scripts operating as part of zoning pipeline 216) annotates each line of each pre-session and appends the zone associated with the observing sensor (or sensor which had the strongest signal strength, as applicable). Returning to the example of Charlie walking around inside airport space 150, the following is a simplified listing of a portion of log data associated with Charlie's device 152. In particular, the simplified data shows a timestamp and an observing sensor:

09:50—AP4

. . .

10:00—AP4

10:01—AP4

10:02—AP2

10:03—AP1

10:04—AP3

10:05—AP2

. . .

10:15—AP2

Suppose AP1, AP2, and AP3 are each sensors present in the “A Gates” section of airport space 150, and AP4 is a sensor present in the security checkpoint area. The zone mapper annotates Charlie's log data as follows:

09:50—AP4—Security

. . .

10:00—AP4—Security

10:01—AP4—Security

10:02—AP2—A-Gates

10:03—AP1—A-Gates

10:04—AP3—A-Gates

10:05—AP2—A-Gates

. . .

10:15—AP2—A-Gates

The Zone mapper then collapses contiguous minutes in which the device was seen in the same zone into a single object (referred to herein as a “session”), which can then be stored and/or used for further analysis as described in more detail below. A device level “session,” labeled by a zone, is the output of the classification process. In various embodiments, the session object includes all (or portions of) the annotations made by the various stages of the zoning pipeline. In the example of Charlie, the excerpts above indicate that he spent twelve minutes in the security area (from 9:50-10:01) and fourteen minutes in the A-Gates area (10:02-10:15). Two sessions for Charlie will be stored (e.g., in a MySQL database/S3 or other appropriate storage): one corresponding to his twelve minutes in security, and one corresponding to his fourteen minutes in security, along with additional data, as applicable.

Realtime Pipeline

Returning to FIG. 2, as previously mentioned, as ingestors 206-210 write their local logs, threads on each of the ingestors (e.g., Kafka readers) tail the logs and provide the log data to a Kafka bus for realtime analysis on an EC2 instance. As a data source, S3 is inexpensive and reasonably fast. Kafka is more expensive, but significantly faster.

Realtime pipeline 226 operates in a similar manner to zoning pipeline 216 except that it works on a smaller time scale (and thus with less data). For example, instead of operating on ten days of historical data, in various embodiments, the realtime pipeline is configured to examine an hour of historical data. And, where the zoning pipeline executes as a daily batch operation, the realtime pipeline batch operation occurs every five minutes. And, instead of writing results to S3, the realtime pipeline writes to Cassandra (228) tables, which are optimized for parallel reads and writes. The realtime pipeline 226 also accumulates the qualified log data. In some embodiments, a list of banned devices is held in memory, where the devices included on that list are selected based on being seen “too long.” Such devices (e.g., noisy devices pinging every two seconds for 20 hours) might be responsible for 60-80% of traffic, and excluding them will make the realtime processing more efficient.

As will be described in more detail below, metrics generated with respect to zoning pipeline data will typically be consumed via reports (e.g., served via interface 174 to an administrator, such as one using computer 172). Metrics generated with respect to realtime pipeline data are, in various embodiments, displayed on television screens (e.g., within airport space 150) or otherwise made publicly available (e.g., published to a website), as indicators of wait times, and refresh frequently (e.g., once a minute). In some embodiments, realtime data can be used to trigger email or other messages. For example, suppose a given checkpoint at a particular time of day typically has a wait time of approximately five minutes (and a total number of five to ten people waiting in line). If the current wait time is twenty minutes and/or there are fifty people in line (e.g., as determined by realtime pipeline 226), platform 170 can output a report (e.g., send an email, an SMS, or other message) to a designated recipient or set of recipients, allowing for the potential remediation of the congestion.

Realtime analysis using the techniques described herein is particularly useful for understanding wait times (e.g., in security, in taxi lines, etc.) and processes such as hotel check-in/check-out. An example use of analysis performed using the zoning techniques described herein is determining how visitors move through a space. For example, historical analysis can be used to determine where to place items/workers/etc. based on flow.

Zoning/Realtime Metrics

Platform 170 includes a metrics pipeline (230) that generates metrics from the output of the zoning pipeline (and/or realtime pipeline as applicable). Various metrics are calculated on a recurring basis (e.g., number of visitors per zone per hour) and stored (e.g., in RedShift store 236). In various embodiments, platform 170 uses a lambda architecture for the metrics pipeline (and other pipelines, as applicable). One example implementation of metrics pipeline 230 is a Spark cluster (running in Apache Mesos). In the case of realtime metrics generation (e.g., updating current security line and/or taxi line wait times), analysis is performed using a Spark Streaming application (234), which stores results in Cassandra (228) for publishing.

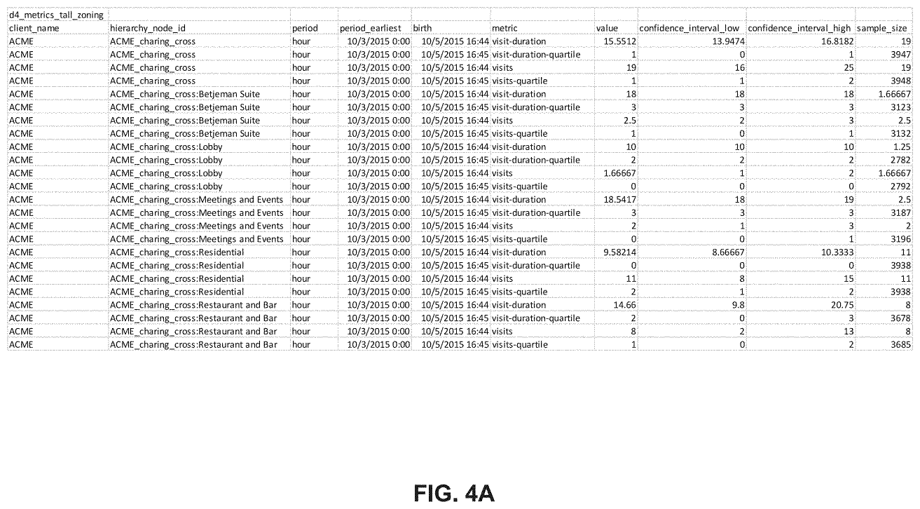

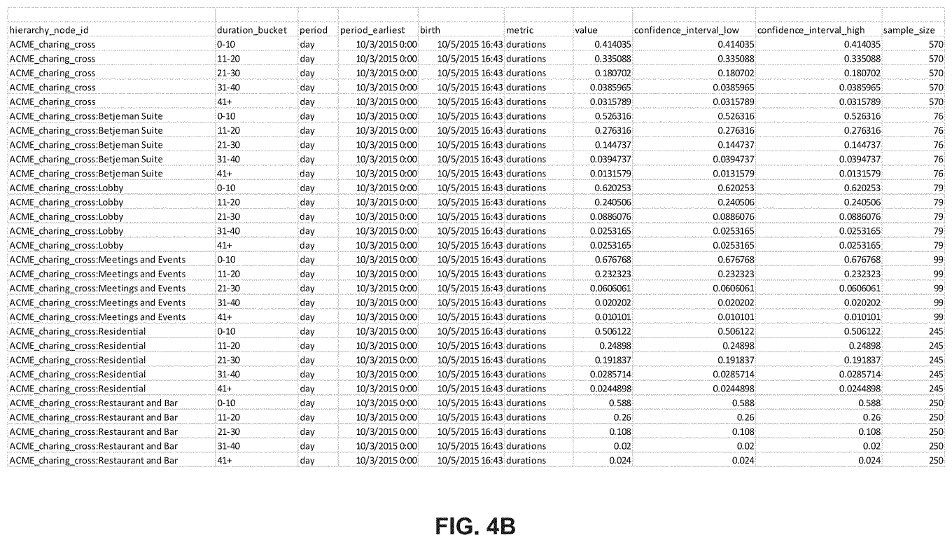

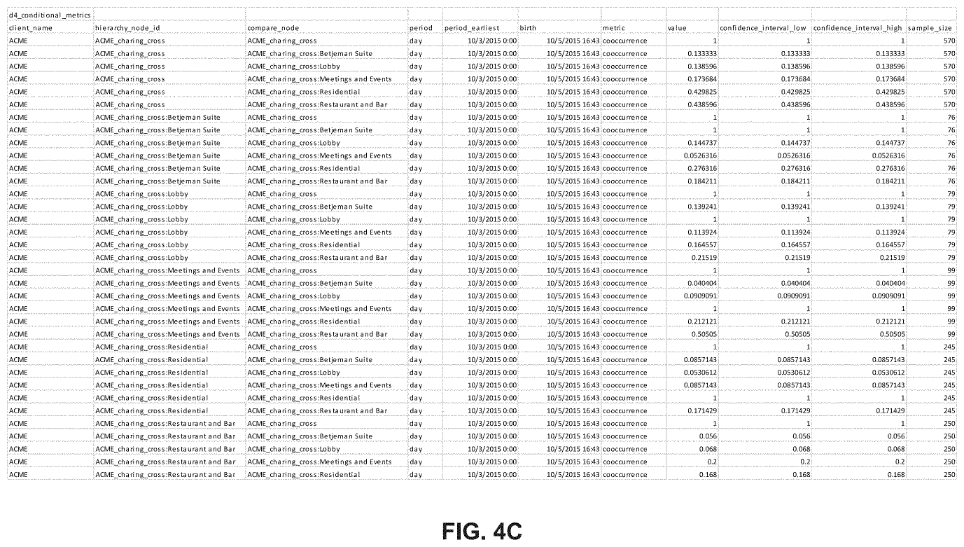

Summaries used to generate reports 232 (made available to end users via one or more APIs provided by platform 170) are stored in MySQL. Such stored metrics will include a time period, a zone, and a metric name value. Sample zoning metric tables are shown in FIGS. 4A-4C. In particular, Table 4A holds metrics about visits and durations in the daily/hourly/15-minute level. Table 4B holds a histogram of duration times: within a given time period in a given location, how many visitors were around for 0-10, 11-20, 21-30, 31-40, and more than 41 minutes. Table 4C holds conditional metrics looking at the device level: a pairwise examination of different zones—of the people seen in one zone, what percentage of them were also seen at another zone. Additional metrics can also be determined and are described in more detail below.

Reporting data 232 is made available to representatives of customers of platform 170 (e.g., Rachel) via interface 174. As another example, reporting data 232 is made available to airport space 150 visitors (e.g., via television monitors, mobile applications, and/or website widgets), reflecting information such as current wait times.

For metrics calculated on an hourly basis, any sessions that do not include that time period are ignored during analysis. For example, to determine a visit count at 2 am (i.e., of those visitors present in a location at any time between 2 am and 3 am, in which zones were they located?), only those sessions including a 2 am prefixed timestamp are examined, and a count is made for each represented zone (e.g., two visitors at Ticketing, six visitors at security, etc.).

One example of a metric that can be determined by metrics pipeline 230 is “what is the current average wait time for an individual in line for security at airport space 150?” One way to evaluate the metric is for metrics pipeline 230 to examine results of the most recently completed realtime pipeline job execution (stored in memory) for recently completed sessions where visitors were in the security zone, and determine the average length of the sessions. Metrics for other time periods (e.g., “what was the average wait at 8:00 am”) can be determined by taking the list of sessions and re-keying it by a different time period. Additional examples of metrics that can be calculated in this manner (keying on a zone, a time period, and a metric) include “how many visitors were seen each hour in the food court?” and “what was the average amount of time visitors spent in the A-gates on Tuesday?” Percentiles can also be determined using the data of platform. For example, “what was the 75^{th} percentile amount of time a visitor spent in the security zone on Tuesday?” or “what was the 99^{th} percentile?”

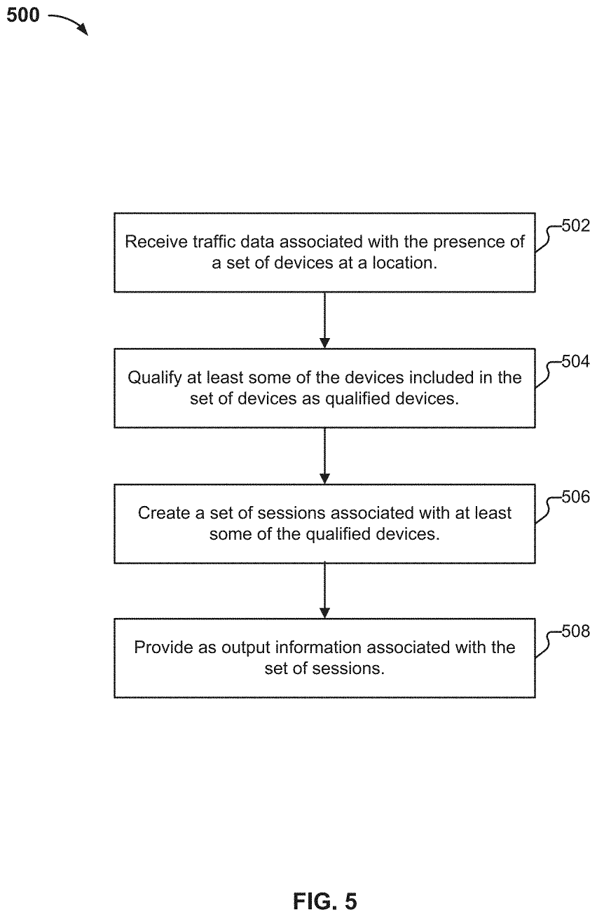

FIG. 5 illustrates an embodiment of a process for determining qualified devices using zone information. In various embodiments, process 500 is performed by platform 170. The process begins at 502 when traffic data associated with the presence of a set of devices at a location is received. As one example, such traffic data is received at 502 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 502 of the process may be repeated several times (e.g., with data about the observation of device 112 also being received at 502, whether from sensor 108, or another sensor, and/or from a controller). At 504, at least some of the devices included in the set of devices are qualified as qualified devices. As one example, at 504 zoning pipeline 216 evaluates data associated with the devices (e.g., by applying a decision tree of rules to log lines associated with the devices and obtained from storage 212). As another example, at 504 realtime pipeline 226 evaluates data associated with the devices (e.g., by comparing the devices against a list of banned devices). In both the cases of zoning pipeline 216 and realtime pipeline 226, at 504, those devices that are not disqualified (i.e., survive the decision tree analysis, are not on the banned list, or otherwise are not disqualified) are designated as qualified devices. At 506, a set of sessions associated with at least some of the qualified devices is created. As one example, at 506, zoning pipeline 216 determines a device-zone-duration 3-tuple for a qualified device using received traffic data or a representation thereof, an example of a session. An example of such a 3-tuple is: device 110, seen from 10:00 to 10:14, in ACME Clothing—First Floor. As another example, at 506, realtime pipeline 226 determines a device-zone-duration 3-tuple for a qualified device using received traffic data or a representation thereof. An example of such a 3-tuple is: device 152, seen from 12:45 to 12:59, in Airport-Terminal 1-A Gates. Finally, at 508, information associated with the set of sessions is provided as output. One example of such output being provided at 508 includes metrics pipeline 230 providing metrics to either/both of Redshift 236 and Cassandra 228 (in conjunction with either the zoning pipeline or realtime pipeline, or both, as applicable). Another example of such output being provided at 508 includes the rendering or other provision of metrics to a user in an interface, such as via interface 174 or a television screen located in airport space 150 (in communication with platform 170). The following section provides additional information regarding a variety of interfaces usable in conjunction with techniques described herein.

Zoning/Realtime Interfaces

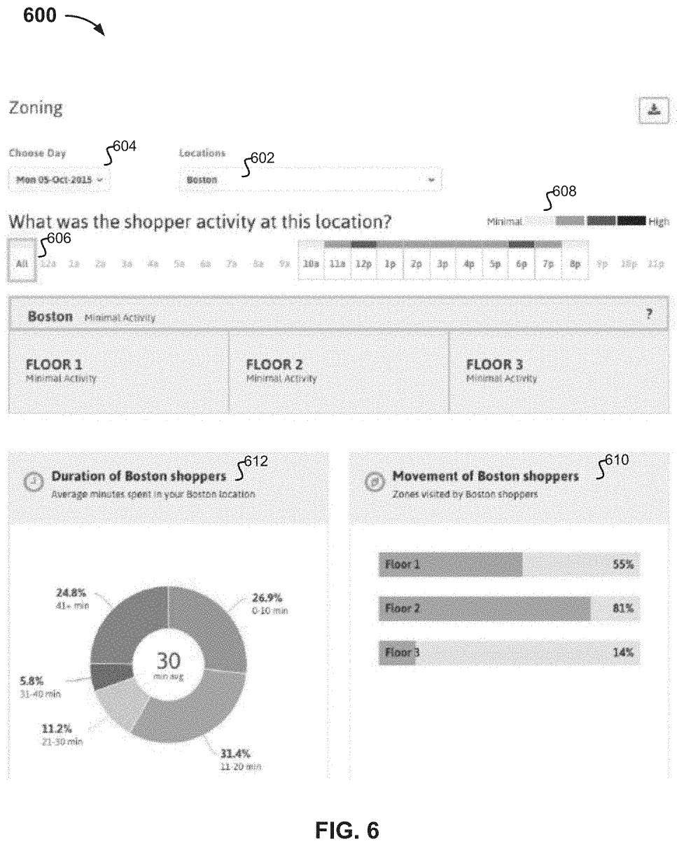

FIG. 6 shows an interface depicting zoning information for a national retailer at a particular location in Boston. Interface 600 is an example of data that can be presented to a user (e.g., a customer representative like Rachel) via interface 174. By clicking region 602, the user can select a particular location in the chain. By clicking region 604, the user can choose what time range of data to view (e.g. a particular day). By clicking region 606, the user can choose whether to see the data across an entire day, or by hour. As shown in FIG. 6, the entire days' worth of data is being displayed. As shown in region 608, in order to provide a relative estimate for how busy a particular zone is at a certain time (without counts), a quartile index of Minimal, Low, Medium, High activity is used. Region 610 quantifies the percent of cross visitation within a certain location. When the store as a whole is selected (as is the case in this view) the user sees what percentage of all shoppers visited the different zones within a location. When a certain zone is selected, the chart will show what percentage of shoppers that visited the selected zone also visited a different zone. Region 612 shows the breakdown of duration across all zones within a location. When the user selects a particular zone this chart updates with zone specific information.

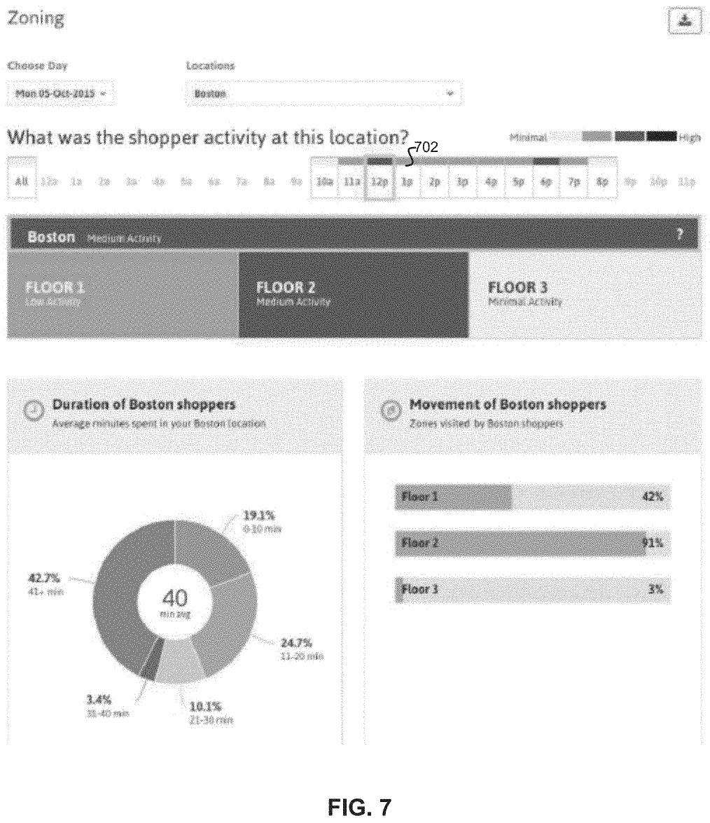

FIG. 7 shows an interface depicting zoning information for a national retailer at a particular location in Boston. When an hour is selected (702), all data below updates.

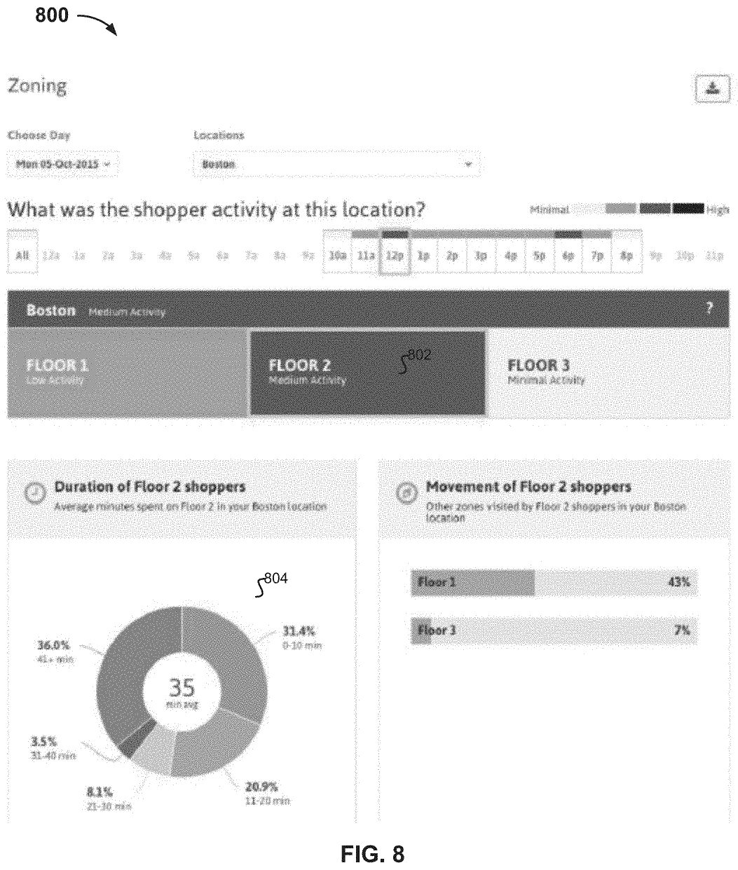

FIG. 8 shows an interface depicting zoning information for a national retailer at a particular location in Boston. When a zone is selected (802), all data below updates. The level of activity is calculated, in some embodiments, by comparing the amount of traffic in a zone to a historical average (e.g., not relative to other zones). As shown in region 804, a viewer of interface 800 can learn the duration breakdown of the visitors to a particular floor.

Suppose the average visitor to floor one of a store (which offers housewares) stays fifteen minutes, and an additional 25% of visitors to floor one stay between 21 and 30 minutes. Further suppose that of those store visitors that visit the second floor, they stay on the floor a much shorter time on average (e.g., stay an average of six minutes on the second floor). If “big purchase” items (e.g., furniture) are located on the second floor, the comparatively short amount of time spent on the second floor indicates that visitors are not buying furniture.

As another example, a representative of a grocery store could use a set of interfaces similar to those shown in FIGS. 6-8 to determine how visitors interact with different regions (defined using zones) in the store. For example, suppose the grocery store is split into a dairy zone (at the back of the store), a middle zone (in the center of the store, where high value items are placed), and two zones (to the left and right of the middle zone, respectively) where inexpensive items are placed. Interfaces provided by platform 170 can show how visitors interact with those zones. For example, the grocery store may be laid out the way it currently is on the assumption that most shoppers need dairy items and will take the shortest path to the dairy (i.e., go through the center of the store), passing by the high value items and placing some of those high value items into their carts. Using techniques described herein, the store layout can be assessed, e.g., with embodiments of the interfaces shown in FIGS. 6-8 indicating the concurrence between visitors to the dairy section and each of the three other sections of the store, the amount of time they spend in each region, etc.

A representative of the national retailer can also use interfaces such as those shown in FIGS. 6-8 to inform staffing and other decisions. For example, suppose that Monday visitor traffic to the Boston location typically sees the bulk of visitors staying on the first floor, with significantly fewer visitors visiting the second and third floors. Instead of staffing all three floors equally throughout the week, additional staff can be placed on the first floor on Mondays, with fewer staff being placed on the second and third floors on those days.

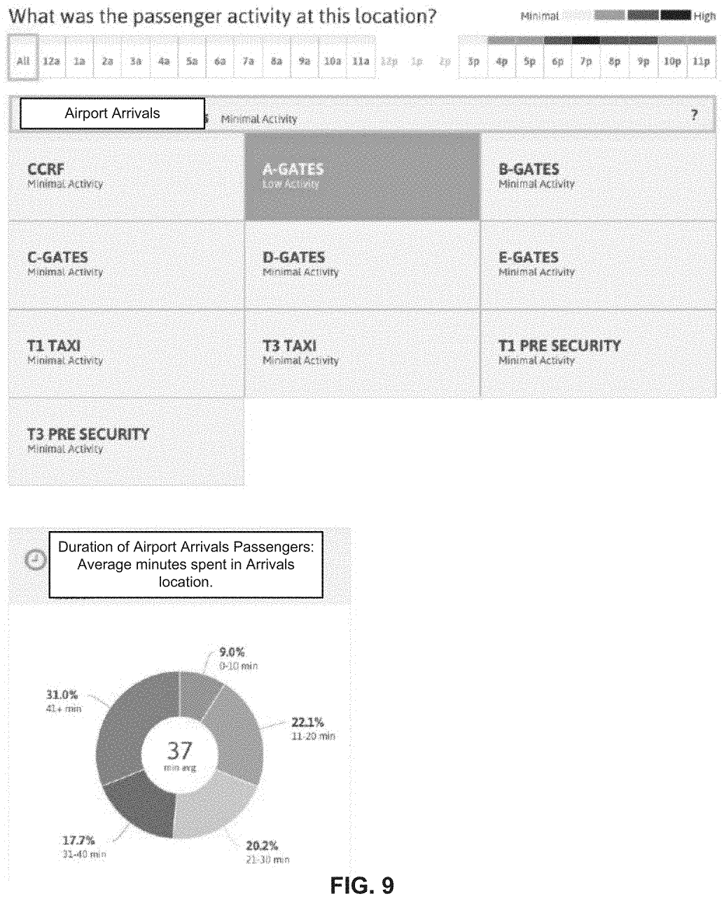

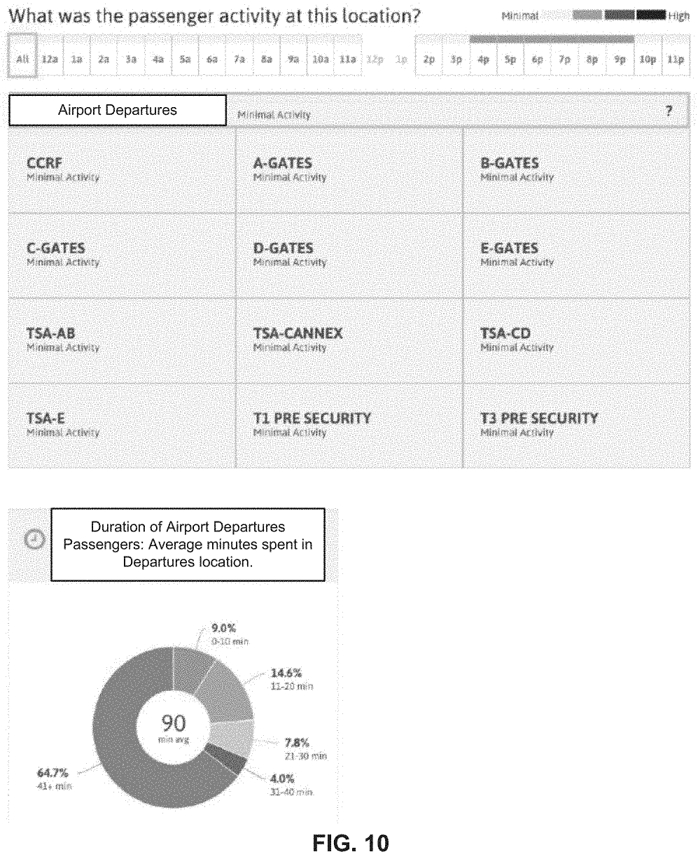

FIG. 9 shows an interface depicting zoning information for an airport. Similar to zoning for retail spaces, zoning for airport spaces can be leveraged to view activity and duration by hour in different zones of the airport. Airport zoning includes arriving and departing zones. Platform 170 can identify what devices are arriving at the airport and what devices are departing by zone. For example, on the arrivals side, passengers typically progress from gates, passed security and/or ticketing, to baggage claim. The numbers of those individuals visiting the taxi zone vs. the limo zone vs. the rental car zone can be determined using techniques described herein. Determinations can also be made about what percentage of arriving passengers stop to shop, stop for lunch, etc., in accordance with techniques described herein, and, how long those activities take arriving passengers, on average. A departures example is depicted in FIG. 10.

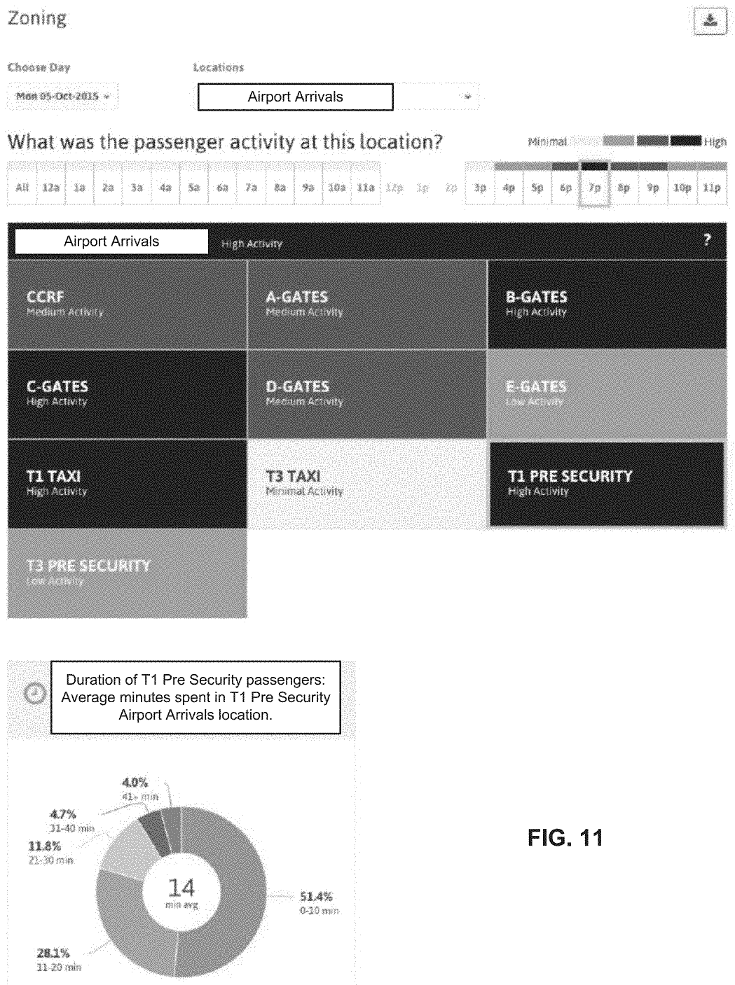

As seen in FIG. 11, activity and duration for zoning for airports, like zoning for retail, can be viewed on an hourly basis.

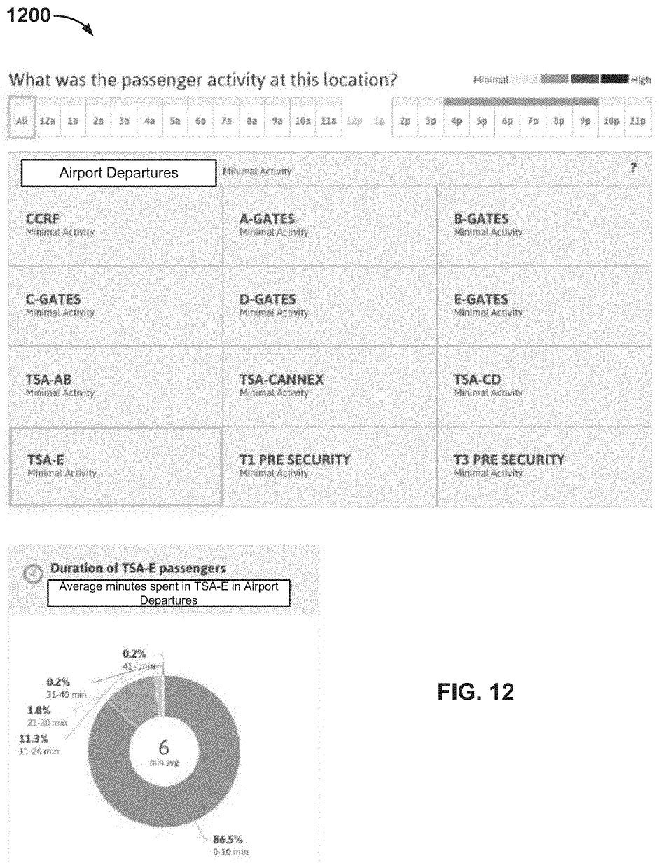

As seen in FIG. 12, security areas can be used as zones and, the activity and duration of security lines measured. The impact of the duration of time passengers spend in security lines on those passengers visiting other areas of the airport can be evaluated using techniques described herein and interfaces such as interface 1200. For example, if there is a very high spike in security wait times, passengers will probably be late for their flights, will have less time to shop/eat, and will be going straight to the gates. And, when security lines are shorter, more co-visits through the shopping/eating zones will occur. Using techniques described herein, the impact of security lines can be quantified and visualized, allowing for more informed decisions to be made (e.g., about staffing).

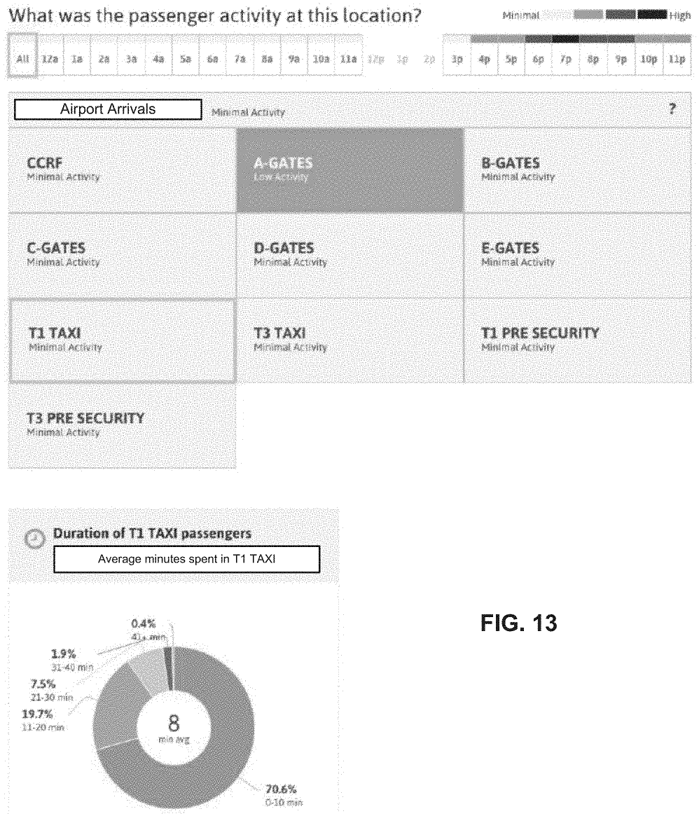

Taxi lines can also be analyzed (see FIG. 13).

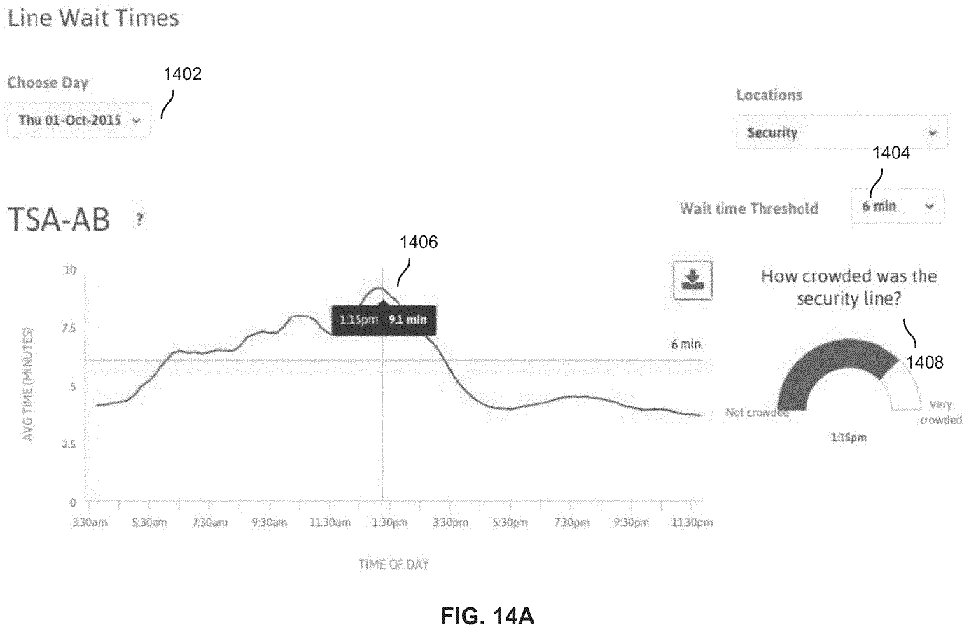

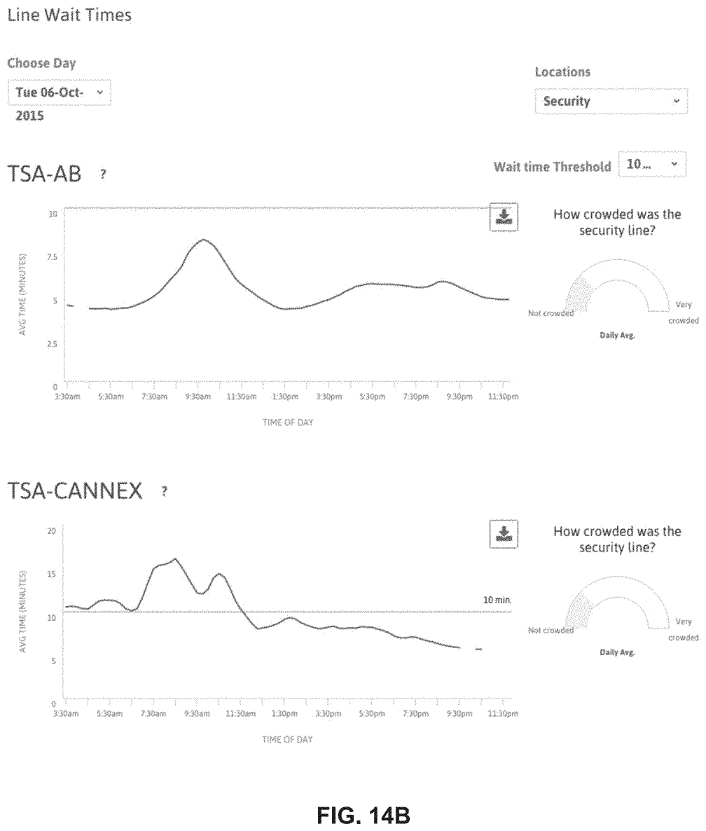

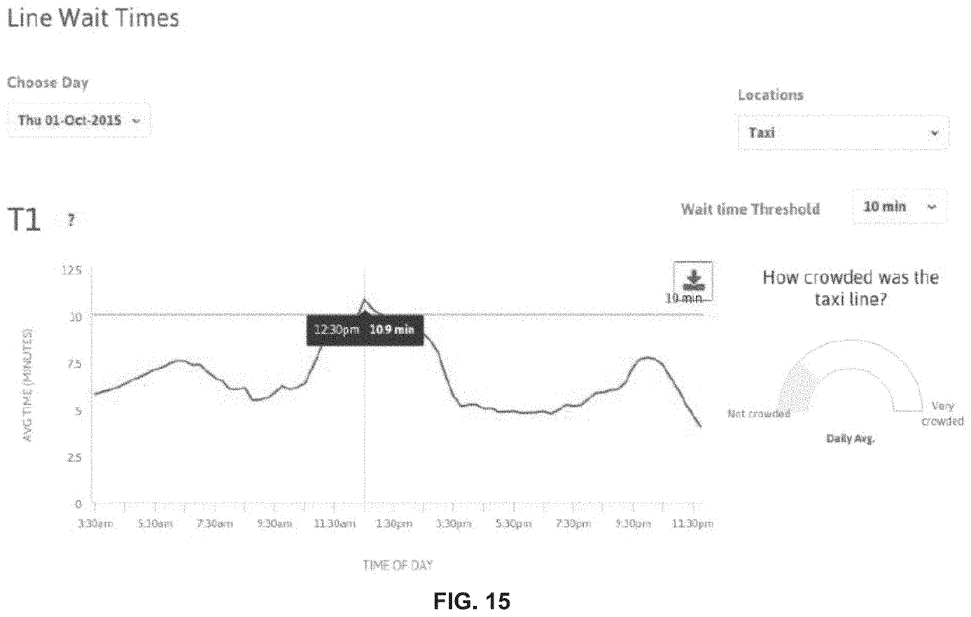

FIG. 14A shows an interface for viewing line wait times at airports. In region 1402, users can choose what time range of duration/activity data to view for different zones. In region 1404, users can set different thresholds to quickly identify if the wait times for a fifteen minute period breached the selected threshold. In region 1406, duration is reported in fifteen minute increments. In region 1408, a depiction of crowding per zone is shown. FIG. 14B shows an additional security line interface. Taxi line wait information can similarly be seen in the interface shown in FIG. 15.

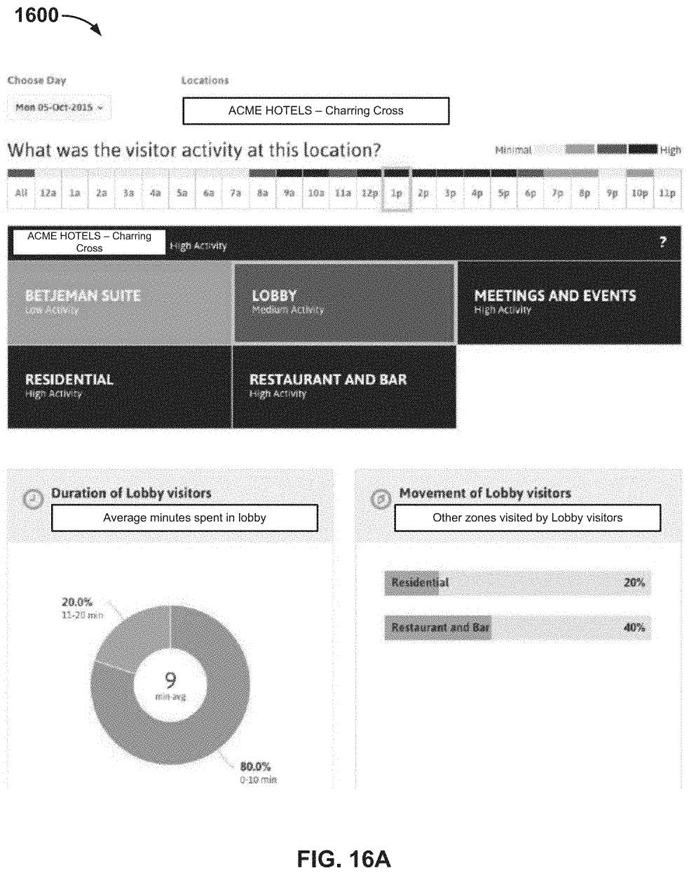

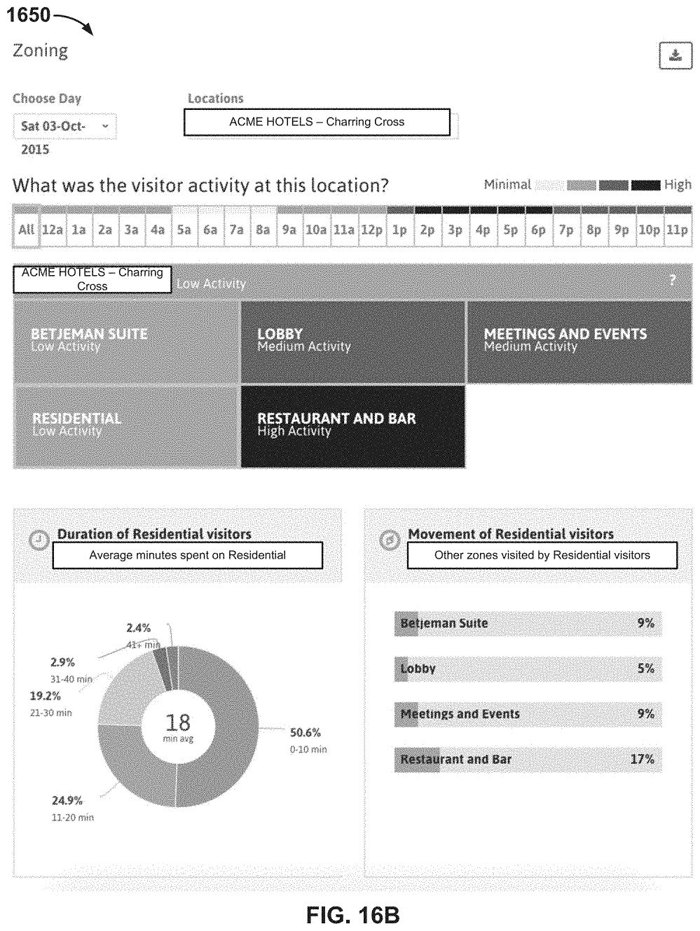

FIG. 16A shows an interface depicting zoning information for a hotel. The activity, duration, and cross visits on an hourly basis is shown in FIG. 16A for all zones in the selected hotel. FIG. 16B shows an additional hotel interface. Using techniques described herein and interfaces such as interfaces 1600 and 1650, a representative of the hotel can determine which parts of the hotel are busy and when. Further, insight such as which portion of hotel restaurant visitors are not guests of the hotel can be determined (e.g., by looking at the co-visits between the restaurant and areas of the hotel that only a guest would typically visit (e.g., the check-in area or guest rooms). As mentioned above, in some embodiments, a representative of a customer of platform 170 (e.g., an administrator acting on behalf of a hotel) configures platform 170 with a list of known employee device IDs so that they can be excluded from analysis performed by platform 170. In the context of a hotel, registering employee devices can be particularly helpful, where hotel guests and hotel employees may have significantly more similar movements/duration patterns than those between shoppers and retail clerks.

Additional Information Regarding Metrics

As explained above, platform 170 periodically (e.g., on hourly and daily intervals) computes various metrics with respect to visitor data. In some embodiments, the metrics are stored in a relational database system (RDS 242) table called “d4_metrics_tall.” The metrics can also/instead be stored in other locations, such as Redshift 236. The records are used to compute metrics across various time periods per customer, zone, and device. A description of column names in “d4_metrics_tall” is provided below.

| Column Name | Use |
|---|---|
| client_name | Stores the customer name |
| hierarchy_node_id | Stores the “zone” name |
| Period | Specifies if this metric is |
| | from an hourly or daily |
| | raw log processing |
| period_earliest | The start time of the period. |
| Birth | The processing time of the |
| | period, or when the batch |
| | processing was run |
| Metric | The type of metric being |
| | calculated from the raw |
| | logs (see below) |
| Value | The calculated value of the metric |
| confidence_interval_ | Used to specify the certainty |
| low and | of the calculated value of |
| confidence_ | the metric |
| interval_high | |
| sample_ size | The amount of data processed |
| | to calculate the value of the |
| | metric |

The following is a list of example metrics that can be computed by platform 170.

| Metric name | Description |
|---|---|
| bounce-rate | The percentage of visitors who enter the |
| | store and then leave within 2 minutes |
| capture-rate | The percentage of devices that meet the |
| | criteria for a visitor |
| engagement-rate | The percentage of visitors who enter the |
| | store and remain for at least 20 minutes |
| first-tier-dur | Visits fitting within the first tier duration |
| second-tier-dur | Visits fitting within the second tier duration |
| third-tier-dur | Visits fitting within the third tier duration |
| fourth-tier-dur | Visits fitting within the fourth tier duration |
| lapsed-30-ratio | The percentage of visitors who count as lapsed |
| recent-30-ratio | The percentage of visitors counting as recent |
| repeat-ratio | The percentage of repeat visits |
| total-opportunity | The total number of visitors during the period, |
| | used to calculate other metrics |
| visit-duration | The duration of a specific visit |
| Visits | The total number of visits during a period |
| Walkbys | The percentage of recorded devices that are |
| | classified as walk-bys |

Hourly Metrics: Every hour, platform 170 calculates metrics for each zone and customer across all data collected for the previous hour. One example hourly report is the hourly report by sensor (FIRES), which collates the customer, zone, sensor, and timestamp at which each device is seen.

Daily Metrics: Each 24-hour period, HRBS reports are aggregated into a daily summary by span (DSBS). This report keys metrics on a combination of customer, zone, and device. For each key, the report will collect several timestamps. These include the last time a device was seen as a visitor, the last time a device was seen as a walk-by, the maximum device signal strength over the entire 24-hour period, the sum of the signal, the sum of the signal squared, the sum of the signal cubed, the event count, the inner and outer duration in seconds, and the device type. The device type includes but is not limited to visitor, walk-by, and access point.

Daily metrics are also calculated across all devices seen during that day. Using previously calculated metrics, platform 170 will then calculate a number of other statistics.

Daily metrics also include statistics covering the duration of visits. Visit length is split into distinct tiers. For example, tier 1 could be less than 5 minutes, tier 1 could be 5 to 15 minutes, and so forth. The daily metrics include which percentage of visitors fit into each tier of visit duration.

In various embodiments, aggregated daily metrics (e.g., the DSBS), are stored in RDS 242 in a table called “daily_summary_by_span”. A description of various fields used as a key in “daily_summary_by_span” is provided below. Other fields in the table are used to record specific metrics and time information for specific devices in customers and zones.

| Field | Description |
|---|---|
| the_date_local | The date the record covers |
| span_name | Name of the customer |
| zone_name | Name of the zone |
| device_id | The unique ID for the measured |
| | device |
| manufacturer_id | The unique ID used to identify |
| | the manufacturer of the device |

Platform 170 also calculates long-term metrics and presents them in reports. Among these long-term reports is a 30-day report, which includes the percentage of visiting devices which have been seen in a zone more than once in the last 30 days, and, in some embodiments, the percentage of lapsed visiting devices. Lapsed devices are those which have not visited a specific zone in 30 or more days. These percentages are calculated per zone and included in a report that is prepared for each customer.

Historical data is also stored and can be queried (e.g., by historical data parsing script, function, or other appropriate element). In various embodiments, a query of historical data is performed against Redshift 236. Results are cached in S3 (212) and read by Scala code in Spark (234). Examples of metrics that can be calculated using these resources include:
First time a device was seen in a customer's zones (across all historical data)
Last time the device was seen as a visitor
Last time the device was seen as a walk-by
Maximum signal strength over the entire reporting period
Number of sensor observations recorded during the entire reporting period for this device
Total duration of the device's visits to the zone during the reporting period

Events

In various embodiments, platform 170 provides customers with the ability to designate a discrete time period as an operational event, allowing for analytics to be performed in the context of the event. An event can be an arbitrary designation of a date range (e.g., “March 2016” and can also correspond to promotional or other events (e.g., “Spring Clearance”). The following are examples of scenarios in which events might be created within platform 170:
An analytics manager from a fast casual restaurant can enter the dates and expected revenue from a recent promotion to understand if offers/menu items drew the expected results. The analytics manager might share the information with marketing colleagues to influence future campaigns, in addition to the necessary leadership as part of a reporting exercise.
A regional operations manager at a mid-sized specialty retailer can use an event to understand the effectiveness of a training program on his team's ability to engage customers. For example, suppose the manager has noticed a declining engagement rate month-on-month. The manager can use eventing to understand if the new educational program drew his expected engagement result and further had an impact on sales in his stores during a particular period.
A marketing campaign manager from a national bank chain is responsible for driving new visitor traffic into the new bank-cafe hybrid locations. The locations serve coffee and tea but not food. The manager can use eventing to compare the performance of different food vendors. For example, the manager could run a campaign with a waffle company one week and then a scone vendor a few weeks later. Using eventing, the manager can leverage AB testing to select the better long-term food partner in encouraging storefront conversion and new visitor traffic.

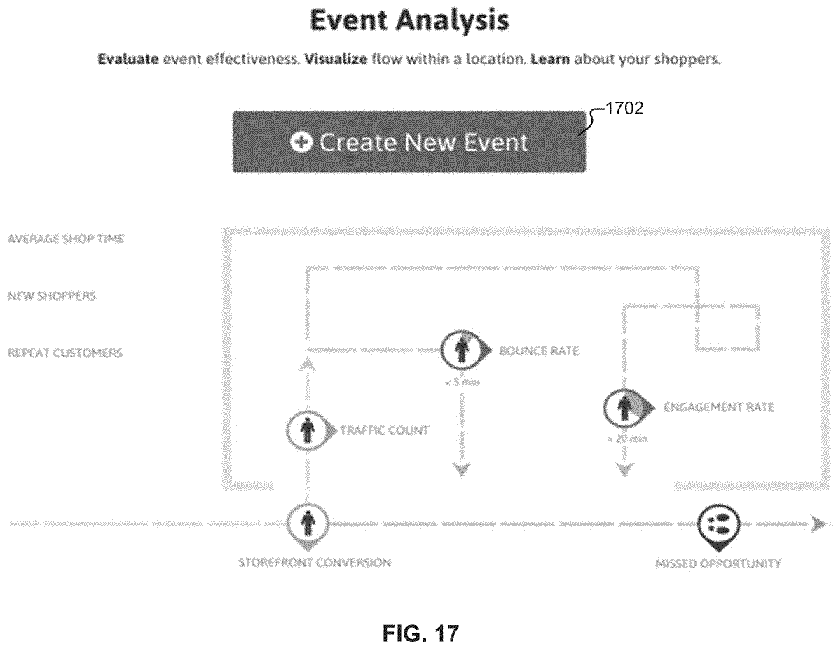

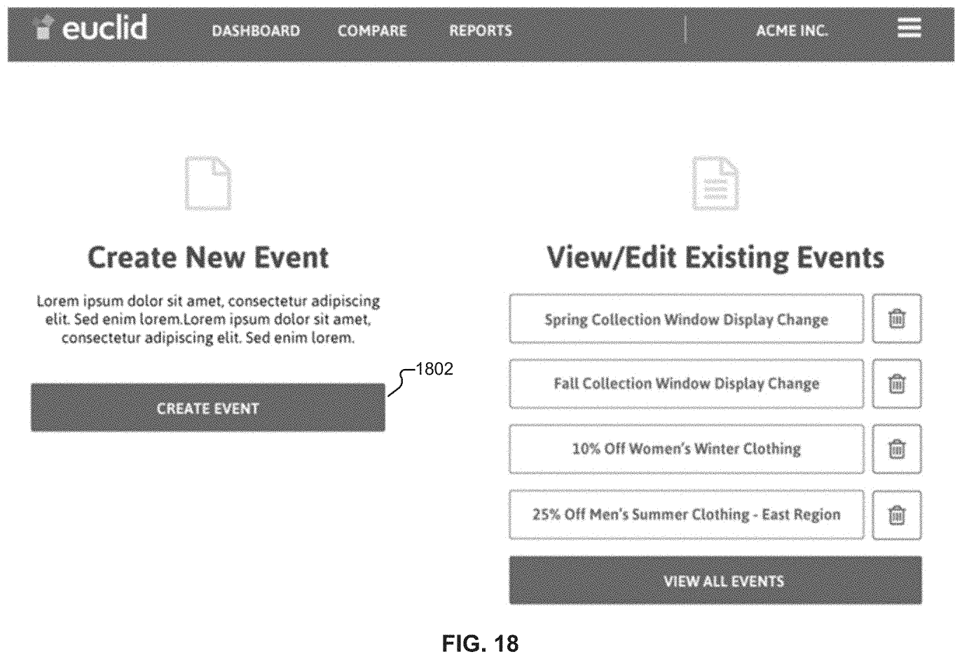

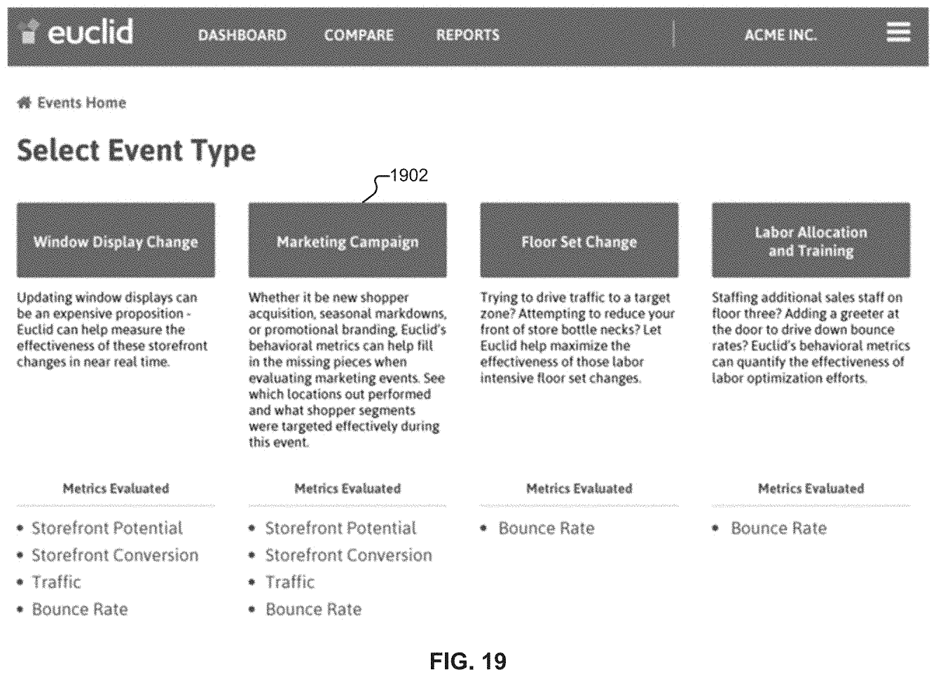

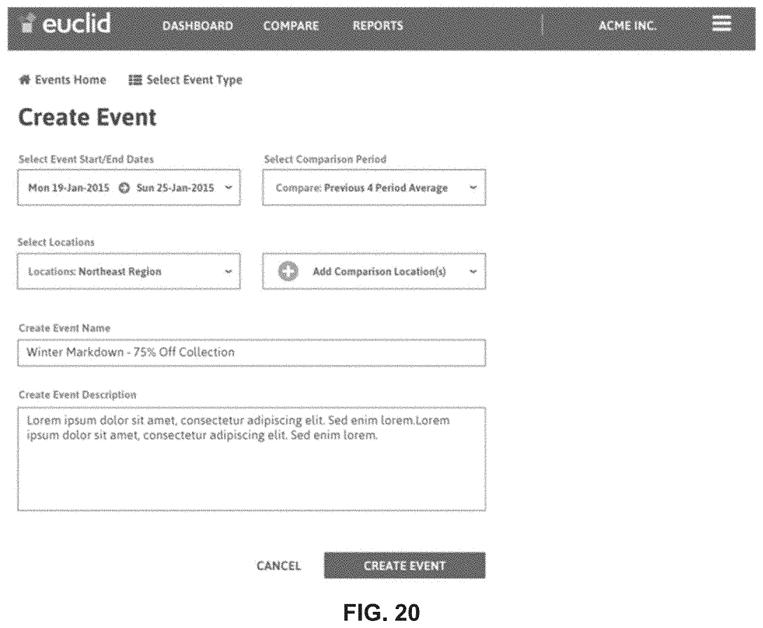

In the following example, suppose Rachel has been tasked with creating an event and evaluating visitor traffic associated with the event. A sample interface for creating an event is shown in FIG. 17 (and is an example of an interface that can be provided by platform 170, e.g., via interface 174). An alternate interface for initiating the creation of an event is shown in FIG. 18. To create a new event, Rachel clicks on region 1702 (or region 1802, as applicable). After doing so, Alice is presented with the interface shown in FIG. 19, where she is asked to pick a type of event. Suppose Alice picks “Marketing Campaign” by selecting region 1902. She is presented with the interface shown in FIG. 20 in response and prompted to supply various information with respect to event creation. Note that an event can be created retroactively. For example, Alice can create a “Winter Markdown” event for ACME on platform 170 even after the date range specified for the event has ended, allowing for retroactive analysis of data pertinent during the specified date range.

In particular, in the interface shown in FIG. 20, Alice is prompted to create an event by adding an event name, event description, location (whether an individual location or hierarchy level), date range for the event, and (optionally) expected sales for the event.

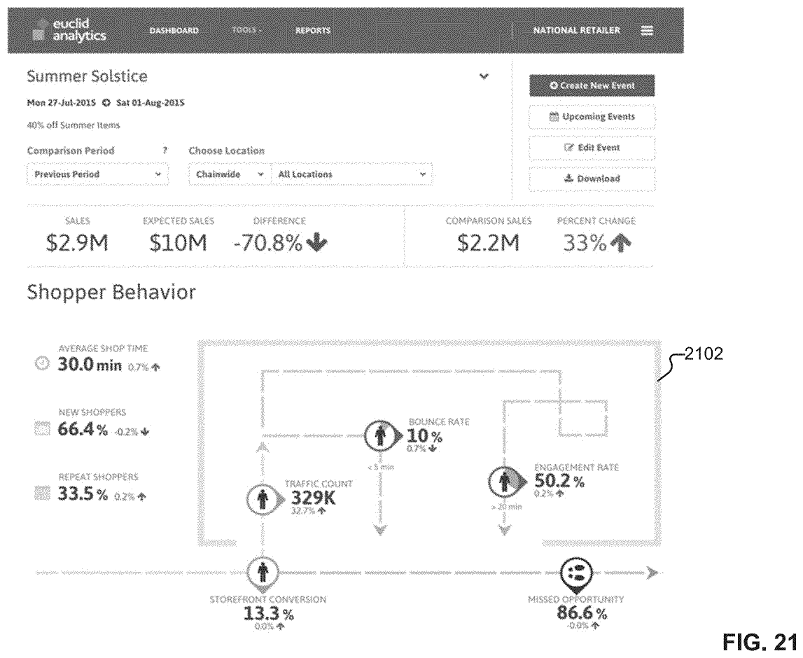

Once the event is created (and has commenced), Alice can view the performance of the event in a summary page interface, an embodiment of which is shown in FIG. 21. From the summary page interface, Alice can select specific locations, update the comparison period, edit the event, create a new event, and view upcoming events.

The summary page interface includes a metrics box 2102. In the example shown in FIG. 21, “storefront conversion” indicates how effective a location was at getting visitors into the location. “Traffic count” is count of visitors. “Bounce rate” indicates the number of visitors who left within five minutes.

Visitor Profile

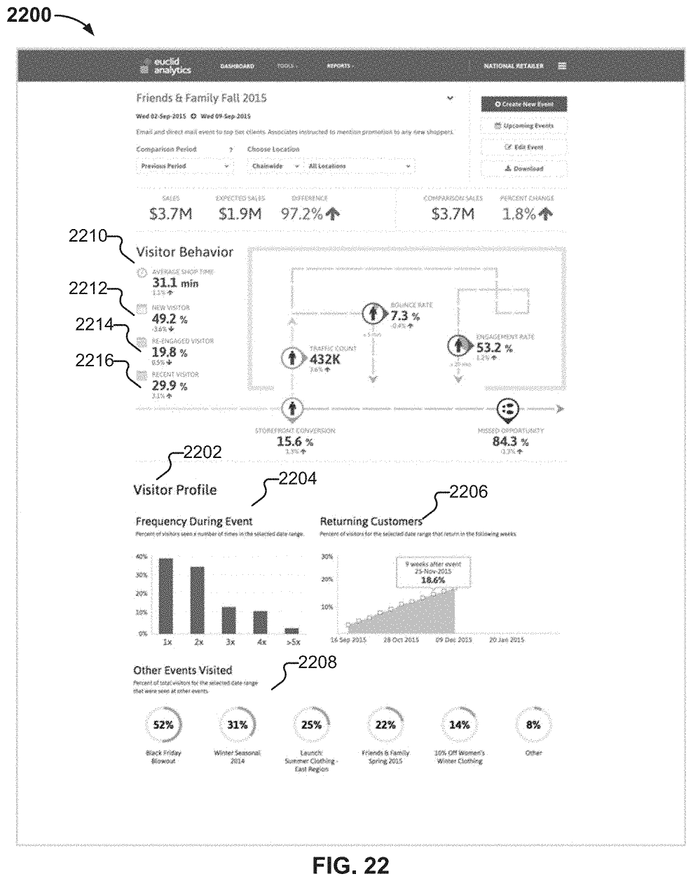

An alternate embodiment of a summary page interface is shown in FIG. 22. The summary page shown in FIG. 22 includes a visitor profile section 2202. The visitor profile provides Alice with an understanding of the type of customers entering a location during an event. In particular, the summary includes three kinds of evaluations: Frequency During Event (2204), Returning Visitors (2206), and Other Events Visited (2208). Each section provides a different view into the loyalty profile of the event visitors.

The event frequency (2204) is the ratio of visitors who are recorded at an event across distinct segments of time. For example, an event lasting three days might have event frequencies measured in 1-day increments. An event frequency report in such a scenario would indicate that a certain number of visitors were recorded during only one total day of the event, a smaller number during two separate days of the event, and an even smaller number during all three days of the event. An event frequency report can also include the total sample size or number of devices recorded during the event. In various embodiments, event frequency reports are stored in S3 or another appropriate location, allowing multiple events to be compared using multiple event frequency reports. When an event frequency report is generated (e.g., from a database), it is given a birth timestamp, which is the time at which the report was originally created. An event frequency report can also specify the beginning and end times of the event. In the example shown in FIG. 22, Alice can hover over each bar in region 2204 to see actual frequency values. Frequency metrics can also be determined outside of specific events, as applicable. For example, a fast food restaurant may choose to set an arbitrary time period (e.g., a week or a month) and measure on a recurring basis (e.g., with a histogram similar to that depicted in 2204) the number of visits made by customers in that time period.

The return rate (also referred to herein as “revisitation”) of visitors after an event has concluded is depicted in region 2206. In various embodiments, event revisitation data is kept in a table in RDS 242 called “d4_event_revisitation.” A returning visitors report can be run at any time after the conclusion of an event, and reports on the percentage of visitors seen during an event who have been recorded in a customer's zones for the first time since the end of the event. Percentages are reported over 24-hour periods. The maximum timespan covered by the report is determined by the lesser of two values: (1) the length of time at which 100% of visitors seen during the event have been recorded in a customer's zones since the conclusion of the event, and (2) a configurable time period that defaults to six months. Alice can hover over each point in the graph shown in region 2206 to see actual values.

Depicted in region 2208 is an indication of other events visited by visitors to the instant event (e.g., at the instant location). The report includes the percentage of visitors who were present during each event in the report compared to the total number of distinct visitors to all events in the report. One way to determine metrics on which devices have been to which (multiple) events is to tag records associated with devices the event identifiers. Another way to determine “other events visited” metrics (e.g., as shown in region 2208) is as follows. Each event at a given location has associated with it event metadata. A given event has a start date and an end date. All of the devices observed within the start/end date of a first event can then be checked to determine whether they were also observed within the start/end date of each of the other events (e.g., a comparison against the dates of the second event, a comparison against the dates of the third event, etc.). The results are ranked and the events with the highest amount of overlapping observed devices are presented in region 2208.

The following are examples of scenarios in which data in the visitor profile is used by a representative of a customer of platform 170:
The analytics manager from the fast casual restaurant can use the visitor profile to understand if a recent menu promotion encouraged repeat visits during the allotted time that the promotion ran. With that information, the manager can start to compare events and opt to plan future promotions based on the stickiness of past ones.
Suppose the regional operations manager at the mid-sized specialty retailer has rolled out a new training to his staff in which they create closer relationships with customers and sometimes seek their contact information for follow-up. The manager can use the visitor profile to see if this tactic is effective at encouraging an increase in repeat visitors over time, signaling that loyalty is being nurtured by his staff.
Suppose a marketing campaign manager for a national pet food/supplies chain has been urging management to pull back from doing discount-driven promotions, as she suspects that such promotions do not attract valuable customers for the chain. The manager could test two promotions: one that is discount-driven (e.g., 20% off all pet bedding) and one that is not (e.g., “check out our new indestructible chew toys”). With the discount-driven promotion, she will be able to tell if the overlap with other events confirms her suspicion about a customer segment that only visits during discounts. Furthermore, she might be able to tell which promotion encourages more repeat visits after the conclusion of the event.

Visitor Loyalty Behavior

Also included in interface 2200 is region 2210, which indicates visitor loyalty behavior. In particular, region 2210 reports on the percentage of customers who are new (2212), re-engaged (2214), or recent (2216). In addition to the current breakdown of visitor types (49.2% new; 19.8% re-engaged; 29.9% recent), a comparison between the current breakdown and a previous time period (e.g., a previous event) is included (i.e., −3.6%; −0.5%; 3.2%).

A new visitor is one who has not been seen previously (e.g., at the reporting location, or at any location, as applicable). A visitor will remain classified as new until he returns to a previously visited location. A re-engaged visitor is one who has visited the same location at least twice, and whose last visit to that location was more than 30 days ago. In various embodiments, 30 days is used as a default threshold value. The value is customizable. For example, certain types of businesses (e.g., oil change facilities) may choose to use a longer duration (e.g. 60 or 90 days) to better align with their natural customer cycle, whereas other businesses (e.g., coffee shops) may choose to use a shorter duration (e.g., 14 days). A recent visitor is one has visited the same location at least twice, and whose previous visit was within the last 30 days.

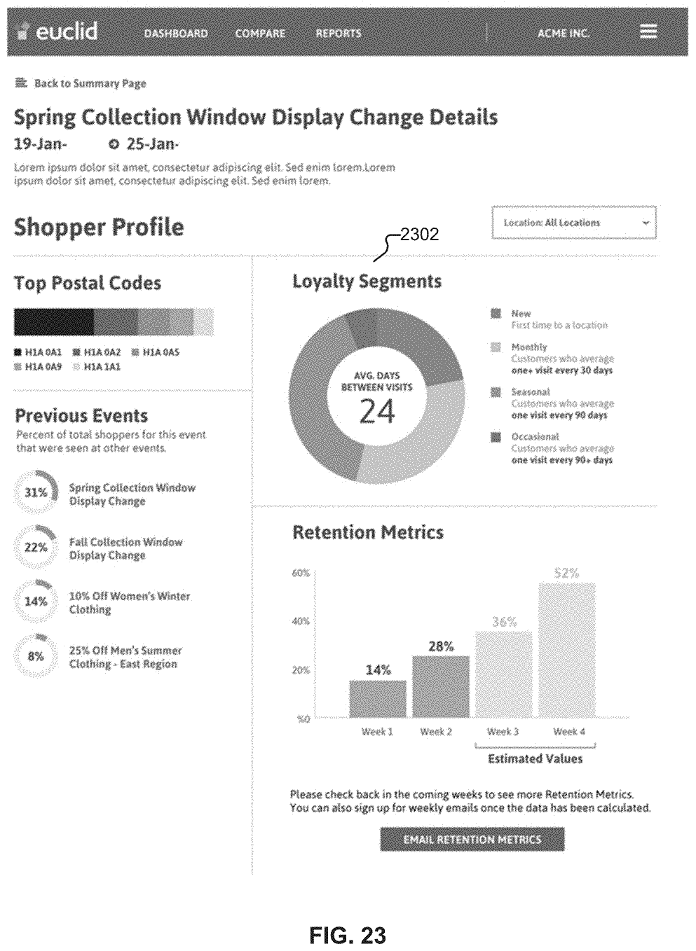

An alternate embodiment of an interface depicting loyalty information is shown in FIG. 23 (in region 2302).

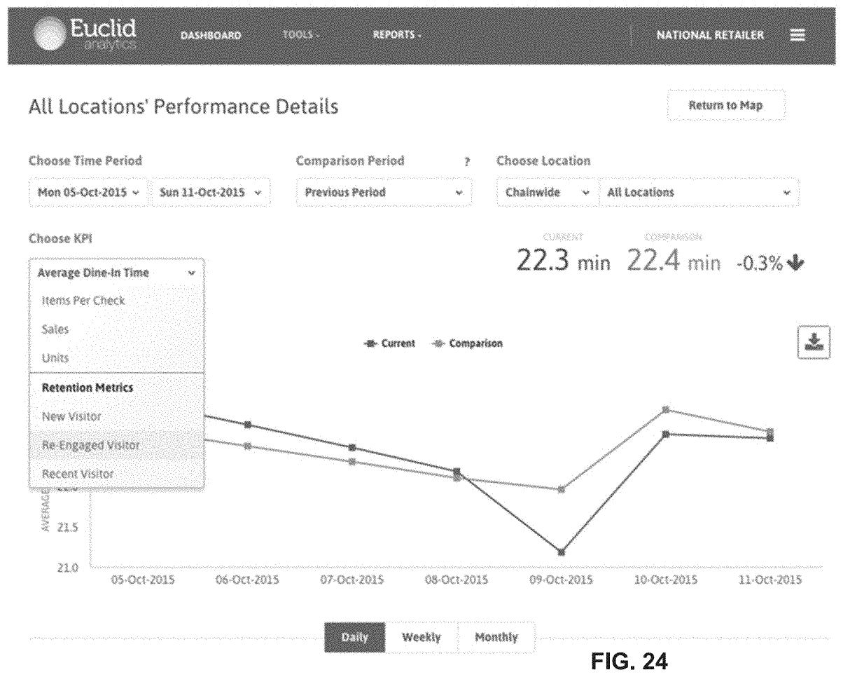

The following are examples of scenarios in which a user of platform 170 is interested in the ability to differentiate between kinds of visitor loyalty behavior:
Sean is responsible for regional merchandising for a national retail chain for teens. He currently plans for a large shipment every 30 days. Knowing that his more loyal customers visit that frequently, he configures the chain's account with platform 170 such that a “recent” shopper is one who visits every 30 days. Using the “re-engaged” metric, Sean will be able to see if a certain month's merchandise is more effective at bringing in customers who may be slipping away. Similarly, should he choose to push the merchandise with an in-store event or advertising, he may be able to observe whether the additional marketing spend increased the “re-engaged” metric with the end goal of moving “re-engaged” customers into the “recent” bucket.
Jenn manages marketing campaigns for a regional coffee and tea chain. She knows that her Fall menu typically drives increased traffic into the locations, particularly from non-regular customers. This year, she would like to see if she can bring those less loyal customers in before the seasonal items are introduced, and also see if she can keep them longer. One option she has is to start promotion early and track the success through the “re-engaged.” Once the Fall menu is formally introduced she can compare the subsequent “re-engaged” metric to the one observed after her early promotion kicks off. An example of performing a comparison between two periods' re-engaged metrics is shown in FIG. 24. Over the course of the Fall season, Jenn can also track the “new” visitor number closely (e.g., to ensure it has decreased steadily but not too much).

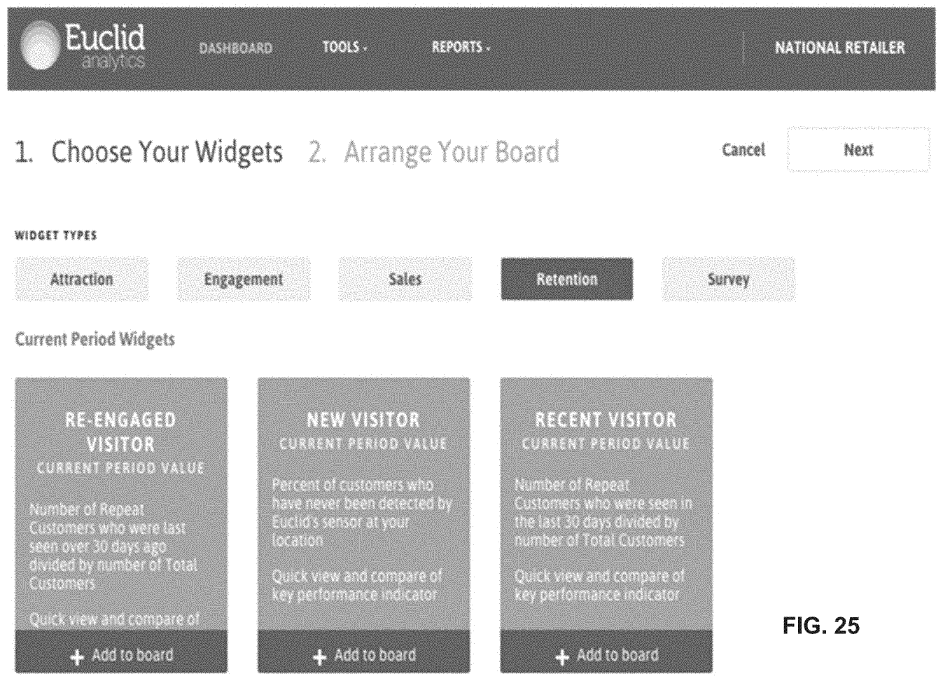

In various embodiments, the interface provided to a user of platform 170 is configurable by that user. For example, a user can indicate which widgets should be presented to the user in a dashboard view. In the interface shown in FIG. 25, the user is reviewing options for including visitor loyalty data in the dashboard view.

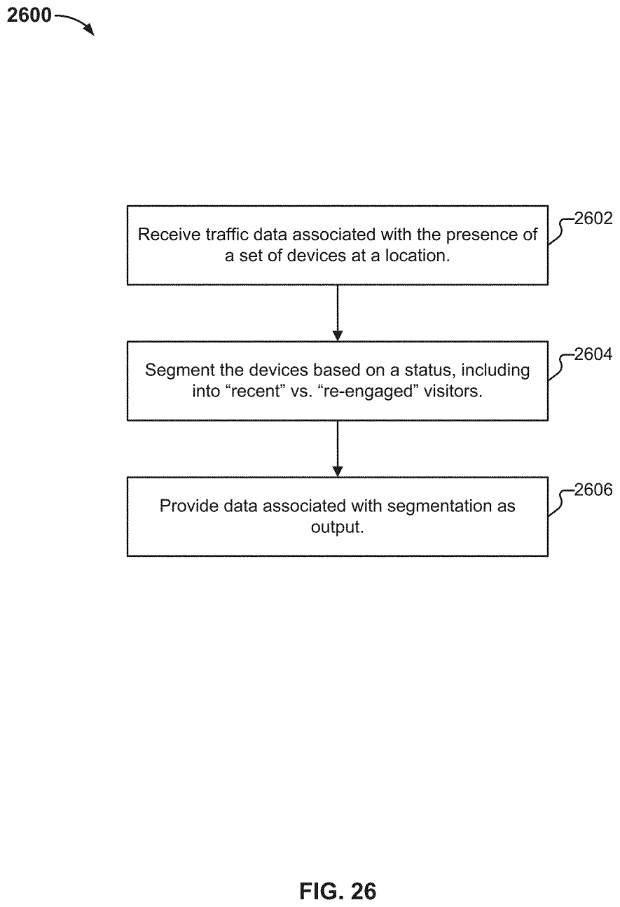

FIG. 26 illustrates an embodiment of a process for assessing visitor composition. In various embodiments, process 2600 is performed by platform 170. The process begins at 2602 when traffic data associated with the presence of a set of devices at a location is received. As one example, such traffic data is received at 2602 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 2602 of the process may be repeated several times (e.g., with data about the observation of device 112 also being received at 2602, whether from sensor 108, or another sensor, and/or from a controller). At 2604, the devices are segmented based on a status. Examples of device status include (for a given location) whether the device is “new,” “re-engaged,” or “recent.” In various embodiments, segmentation is performed by metrics pipeline 230 (described in more detail above) evaluating log data (e.g., in storage 212, RDS 242, Redshift 236, and/or Cassandra 228) as applicable and annotating the log data in accordance with rules such as those provided above (i.e., using the definitions of new/re-engaged/recent visitors). At 2606, data associated with the segmentation is provided as output. As one example, a breakdown of visitor composition is depicted (e.g., at 2606) in the interface shown in FIG. 22 in region 2210. As shown in FIG. 22, the view presented in interface 2200 is dynamic, and portion 2606 can be repeated (e.g., in response to user interactions with interface 2200).

Events Pipeline Wrapper

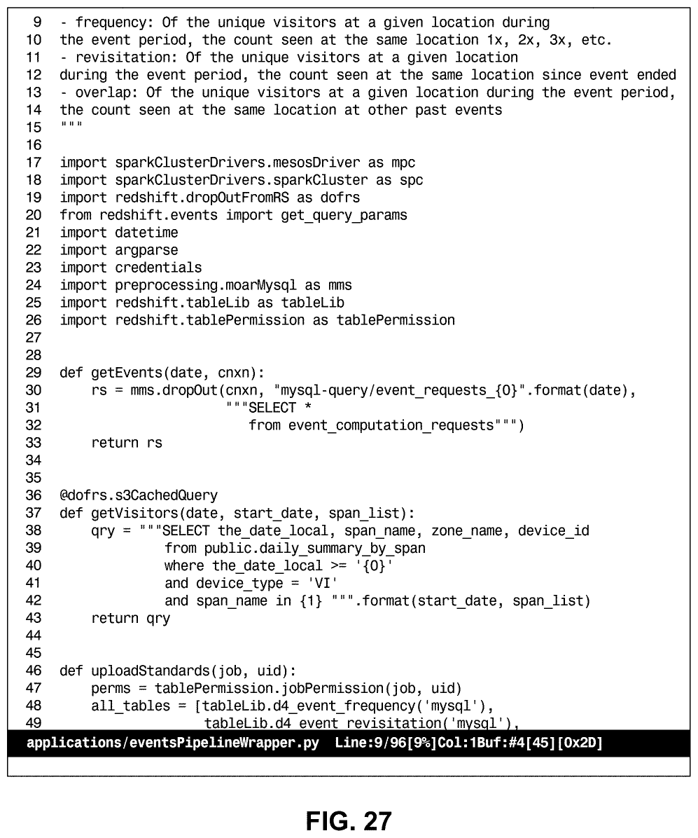

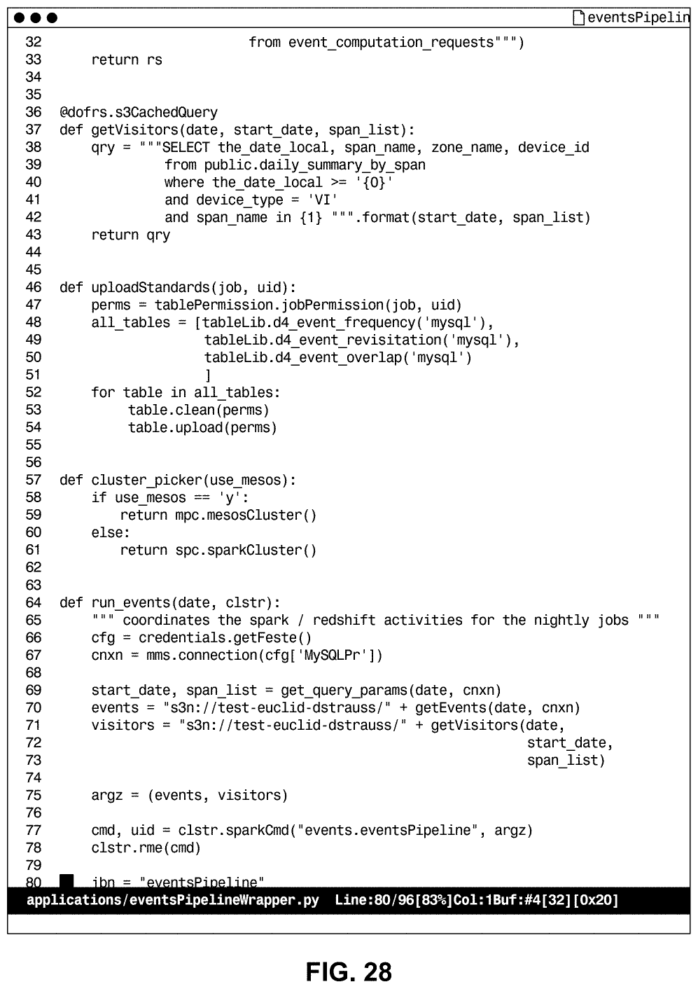

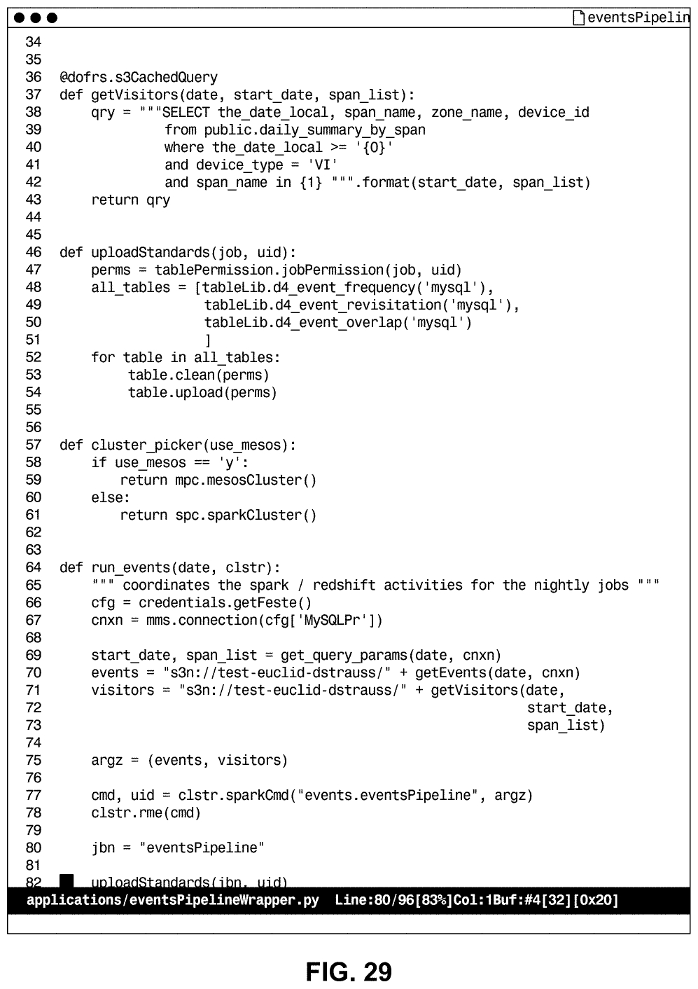

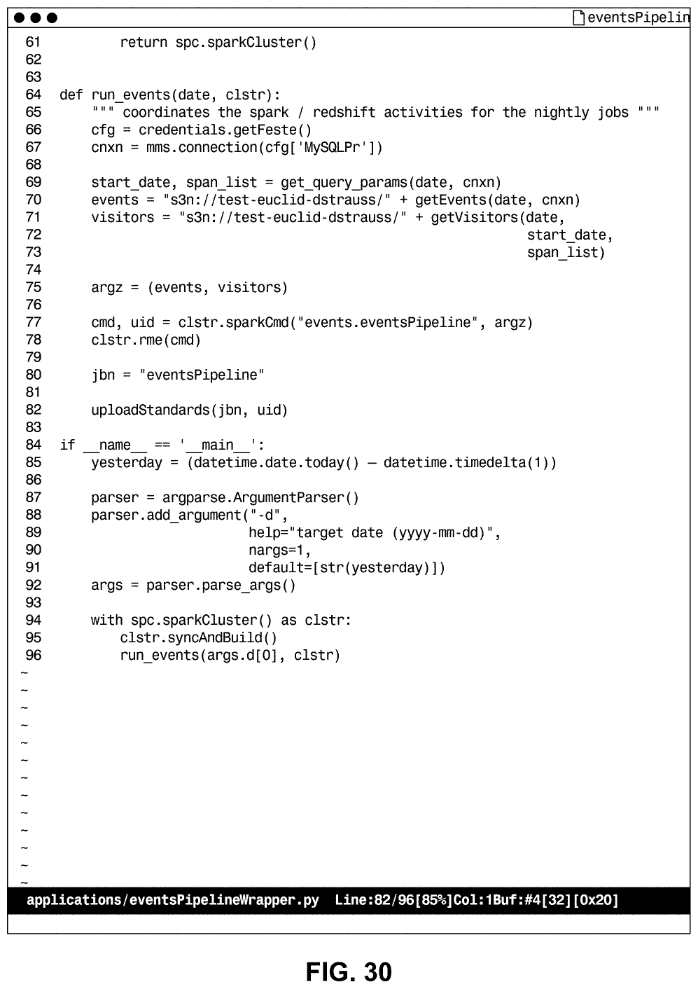

Events pipeline wrapper 240 (eventsPipelineWrapper.py) is a Python script that calculates events-based metrics in various embodiments. In particular, events pipeline wrapper 240 outputs the following: (1) event frequency; (2) revisitation; and (3) overlap. FIGS. 27-30 collectively depict an example implementation of an events pipeline wrapper script.

In various embodiments, an RDS table called “d4_event_frequency” (keyed by customer, zone, an event identifier, and start/end times) is includes the following fields:

| Field | Description |
|---|---|
| client_name | The customer name |
| hierarchy_ | The zone name |
| node_id | |
| start_date | The beginning of the event |
| end_date | The end of the event |
| Birth | The time at which the metric was calculated |
| Metric | The metric calculated (visitor-frequency) |
| frequency_ | The number of days for which visitor |
| level | frequency was calculated |
| Value | The count of distinct visitors detected |
| | by the zone's sensors for the number |
| | of days in the “frequency_level” column |
| sample_size | The total number of visitors detected by |
| | the zone's sensors over the entire |
| | duration of the event. |

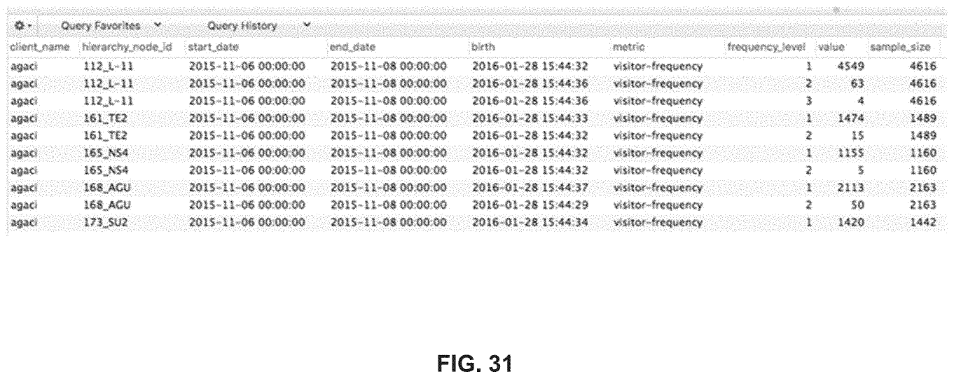

Sample data from the “d4_event_frequency” table is shown in FIG. 31. In the example of FIG. 31, a three day event was held. A total of 4616 unique devices were seen at sensor 112_L-11 during the three day event. Of those devices, 4549 visited once, 63 visited two of the three days, and 4 visited all three days. A total of 1489 unique devices were seen at sensor 161 TE2. Of those devices, 1474 visited once, 15 visited two of the three days, and no devices visited all three days.

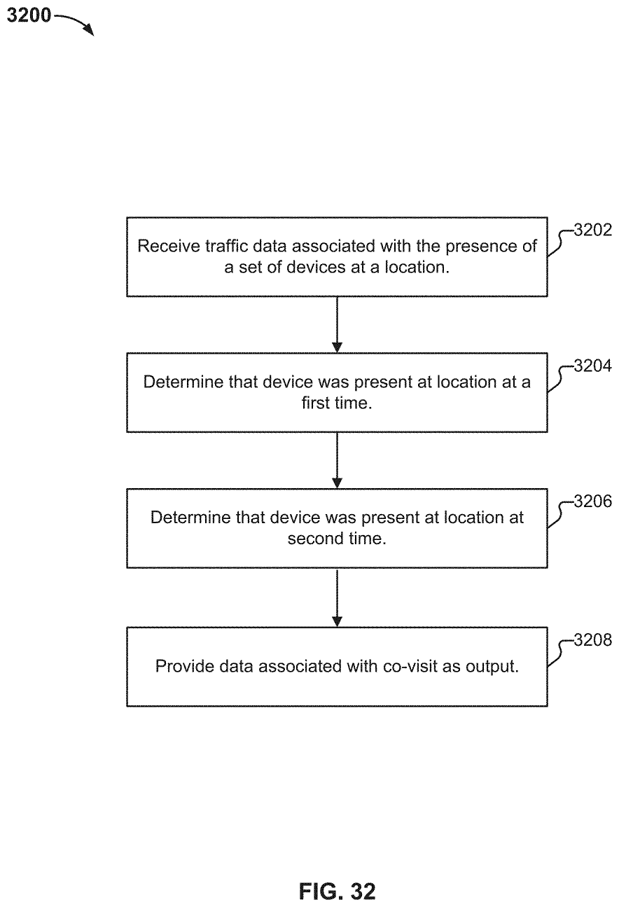

FIG. 32 illustrates an embodiment of a process for determining co-visits by visitors. In various embodiments, process 3200 is performed by platform 170. The process begins at 3202 when traffic data associated with the presence of a set of devices at a location is received. As one example, such traffic data is received at 3202 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3202 of the process may be repeated several times (e.g., with data about the observation of device 112 also being received at 3202, whether from sensor 108, or another sensor, and/or from a controller). At 3204, a determination is made that a first device was present at a first location at a first time (e.g., during an event). In various embodiments, the determination is made by events pipeline wrapper 240. At 3206, a determination is made that the device was also present at the first location at a second time (e.g., during a subsequent event). In various embodiments, the determination is also made by events pipeline wrapper 240. In various embodiments, portions 3204 and/or 3206 of process 3200 are performed by metrics pipeline 230 (described in more detail above) evaluating log data (e.g., in storage 212, RDS 242, Redshift 236, and/or Cassandra 228) as applicable and annotating the log data. Finally, at 3208, data associated with the co-visit (of the device to the first location on two different occasions) is provided as output. As one example, a breakdown of visitor co-visits is depicted (e.g., at 2608) in the interface shown in FIG. 22 in region 2202. Additional discussion of aspects of process 3200 are provided above (e.g., in conjunction with discussion of FIG. 22).

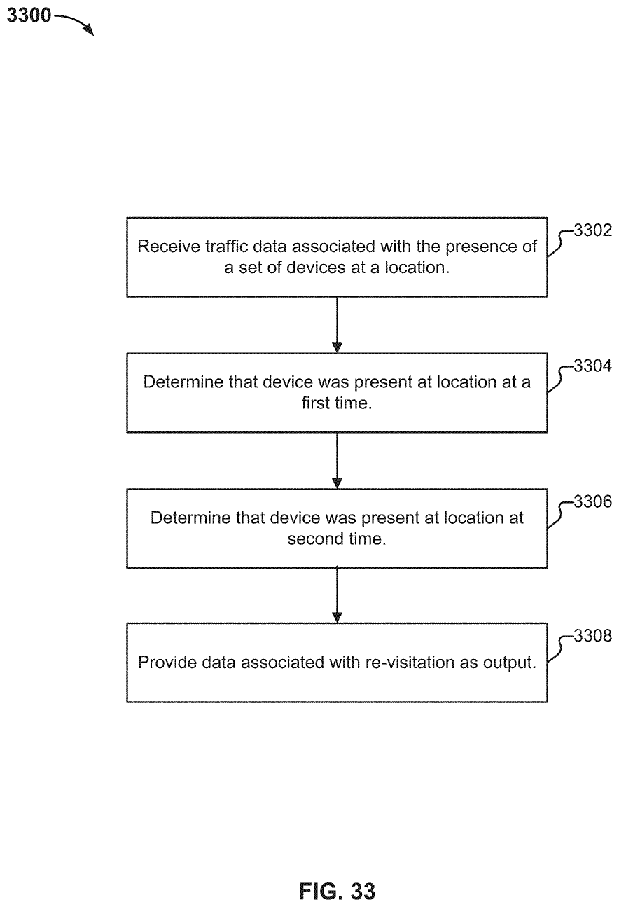

FIG. 33 illustrates an embodiment of a process for determining re-visitation by visitors. In various embodiments, process 3300 is performed by platform 170. The process begins at 3302 when traffic data associated with the presence of a set of devices at a location is received. As one example, such traffic data is received at 3302 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3302 of the process may be repeated several times (e.g., with data about the observation of device 112 also being received at 3302, whether from sensor 108, or another sensor, and/or from a controller). At 3304, a determination is made that a first device was present at a first location at a first time (e.g., during an event). In various embodiments, the determination is made by events pipeline wrapper 240. At 3306, a determination is made that the device was also present at the first location at a second time (e.g., at a time subsequent to the event). In various embodiments, the determination is also made by events pipeline wrapper 240. In various embodiments, portions 3304 and/or 3306 of process 3300 are performed by metrics pipeline 230 (described in more detail above) evaluating log data (e.g., in storage 212, RDS 242, Redshift 236, and/or Cassandra 228) as applicable and annotating the log data. Finally, at 3308, data associated with the re-visit (of the device to the first location at a subsequent time) is provided as output. As one example, a breakdown of the lengths of time it took for visitors to re-visit is depicted (e.g., at 2606) in the interface shown in FIG. 22 in region 2202. Additional discussion of aspects of process 3300 are provided above (e.g., in conjunction with discussion of FIG. 22).

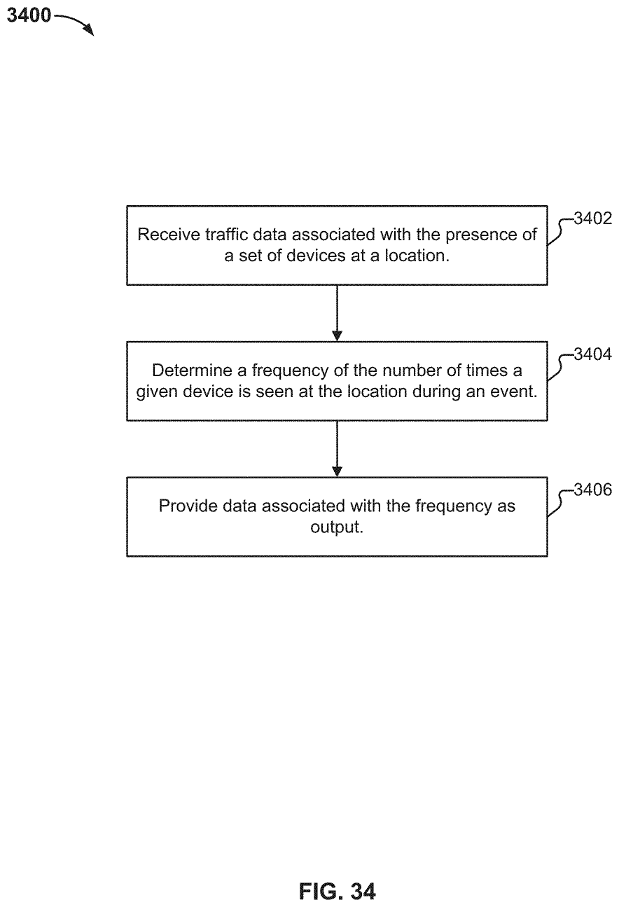

FIG. 34 illustrates an embodiment of a process for assessing visitor frequency during an event. In various embodiments, process 3400 is performed by platform 170. The process begins at 3402 when traffic data associated with the presence of a set of devices at a location is received. As one example, such traffic data is received at 3402 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3402 of the process may be repeated several times (e.g., with data about the observation of device 112 also being received at 3402, whether from sensor 108, or another sensor, and/or from a controller). At 3404, a determination is made of the frequency of the number of times that a given device was observed at the location. In various embodiments, the frequency analysis is performed by events pipeline wrapper 240. In various embodiments, the frequency analysis is performed by metrics pipeline 230 (described in more detail above) evaluating log data (e.g., in storage 212, RDS 242, Redshift 236, and/or Cassandra 228) as applicable and annotating the log data. At 3406, data associated with the frequency is provided as output. As one example, a breakdown of visitor frequency is depicted (e.g., at 3406) in the interface shown in FIG. 22 in region 2204. Additional discussion of aspects of process 3400 are provided above (e.g., in conjunction with discussion of FIG. 22).

Personalized Visitor Connection, Engagement, and Segmentation

Using the techniques described above, devices can be detected and visit behavior data about the devices determined. The device detection and data collection can be performed passively, where the user carrying the device can remain anonymous. Described below are techniques for connecting a detected device with information about the user of the device. For example, using the techniques described herein, an identity of a user associated with a detected device can be determined, facilitating personalized experiences for the user. As another example, using the techniques described herein, the visitor behavior determined from observed devices (e.g., zoning, loyalty, duration, bounce rate, cross-visits, etc.) can be segmented according to user information (e.g., user demographics) about the users carrying the observed devices. As with the techniques described above, the techniques described herein can be deployed on existing infrastructure.

For illustrative purposes, examples involving a shopper at ACME Clothing, John, are described. The techniques described herein can be variously adapted to accommodate visits at other types of locations.

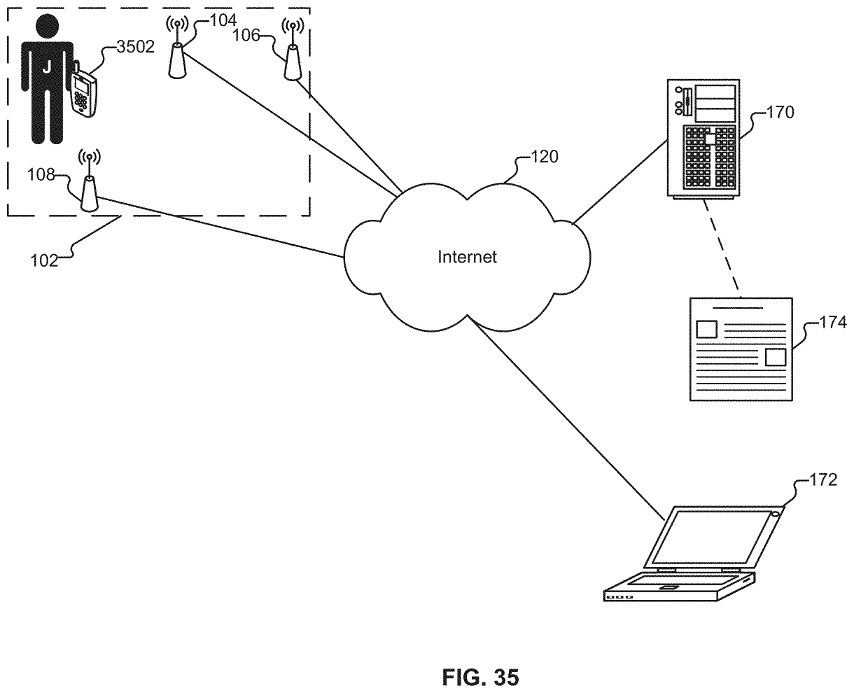

FIG. 35 illustrates an example of an environment in which sensors collect data from mobile electronic devices and information about the users of the mobile electronic devices is obtained. In the example shown, John is present and shopping in retail space 102, in particular, the brick-and-mortar clothing store “ACME Clothing”. John is carrying mobile device 3502 (e.g., a cellular phone).

John is prompted by a sign at ACME Clothing to log into the store's WiFi. For example, the sign indicates by logging into the store's WiFi, John will receive access to free WiFi, as well as a coupon to use in store. Other examples of promotions usable to incentivize a user to opt in to being identifiable offers such as sweepstakes, discounts, gifts, etc.

In this example, John, on his mobile device, uses his phone to select ACME Clothing's WiFi network (e.g., from a menu on his phone that allows him to choose which WiFi network he would like to connect to). His association or connection request is detected and handled via sensor 108 (an example of a commodity WiFi access point).

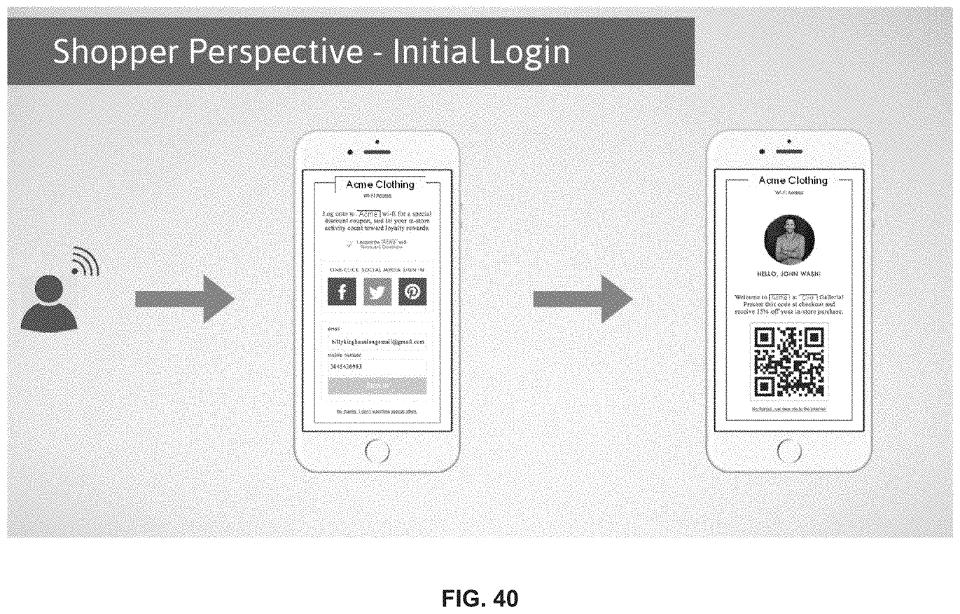

John is guided through a flow for logging into ACME Clothing's WiFi. For example, a registration page or portal is displayed on John's phone with instructions for how to log onto ACME Clothing's WiFi. In this example, the initial login page provides various options for how John can log into ACME Clothing's WiFi. For example, John can login or sign in via a social media sign-in (e.g., his Facebook or Google account) and/or by providing his contact information, such as an email address or mobile phone number. The initial login page also includes a field for accepting terms and conditions for allowing ACME Clothing to have knowledge of John's identity (and access to some personally identifiable information (PII) associated with him). Personally identifiable information is also referred to herein as “opt in data” (where devices associated with anonymous devices are referred to herein as “opt-out” devices or users). An example of an initial login page is described below in conjunction with FIG. 40.

In this example, suppose that John has elected to log into ACME Clothing's WiFi network using his email address, “cooljohn@awesome.com”. After signing in with this email address, John's device is directed to a splashscreen (or any other page or site, as appropriate) that includes a welcome message and a code (e.g., QR code) that he can present at checkout to receive 15% of his in-store purchase. John is also provided with WiFi access. John need only log onto WiFi once using his email, and he will be provided complimentary WiFi access for his future visits to ACME Clothing's WiFi. For example, during a future visit, when John's device associates with ACME Clothing's WiFi, platform 170 can determine, based on stored records, that a device with John's phone's MAC address has already opted into being identifiable. Thus, when logging into ACME Clothing's WiFi, John's device will not be caused to render a log in page requesting him to sign in using his email address or other information, and will instead be automatically connected with the WiFi. Other splash screens can be presented to John as well. As one example, a splash screen welcoming him back to the store and/or providing him with coupons for returning, etc. can be opened on John's device as well. As another example, the splash screen can display a welcome message, and John is sent an email linked to a coupon, or any other exchange of value as appropriate.

In this example, sensor 108, which facilitated John's access to ACME Clothing's WiFi collects the device identifier (e.g., MAC address) for John's mobile device. Sensor 108 sends to platform 170, via network 120, the sensor's own MAC address (or any other appropriate device identifier), the MAC address of John's phone, an indication that John has provided consent to be identified by ACME Clothing, as well as the email address provided by John. As will be described in further detail below, platform 170 is configured to process the collected information, which includes determining that the user of mobile device 3502 (identified by the MAC address) has consented (based on the indication of consent) to being identified by ACME Clothing (where the store location is determined based on the MAC address of the sensor, for example, using a sensor network hierarchy, as described above), and that the user of the mobile device is identifiable by the provided email address. Thus, platform 170 now has knowledge that the user of mobile device 3502 has opted into being identifiable (i.e., is no longer anonymous) at ACME Clothing. John's identity information (e.g., PII) can be used to create a more robust profile for his device (e.g., by adding personally identifiable information to visitor metrics determined for his device).

Thus, whenever mobile device 3502 is observed by sensors at an ACME Clothing store (e.g., using the techniques described above), platform 170 can determine that a user identified as “cooljohn@awesome.com” is in the store, rather than an anonymous device or visitor. The in-store activity of John's mobile device, determined based on the observations of the mobile device's movements, can then be linked to John's identity. For example, using the techniques described above, the activity of a device (e.g., visit duration, loyalty, visit frequency, zoning, etc.) can be determined. The determined visit behavior can then be associated with the MAC address of the device whose movements are being observed. The device, identified by its MAC address, can in turn be associated with a corresponding user. Thus, the MAC address of the device can be used to link observed in store activity to a particular user identity.

Once visitor activity can be connected with a particular user identity or profile, a variety of actions can be facilitated. As one example, a single view of visitors can be provided by platform 170, allowing users to be identified, analyzed, and engaged. As another example, with the addition of the layer of user identity to visit activity, relevant context can be delivered in various scenarios. For example, actions can be taken based on knowledge of when a user has entered into a store. In various embodiments, functionality that can be facilitated includes direct to consumer actions, customer relationship management (CRM) integration, personalized visitor experiences, etc. In some embodiments, the functionality is provided via application programming interfaces. Further details and examples of such identification, analysis, and personalized engagement will be described below.

Traffic Insights Platform

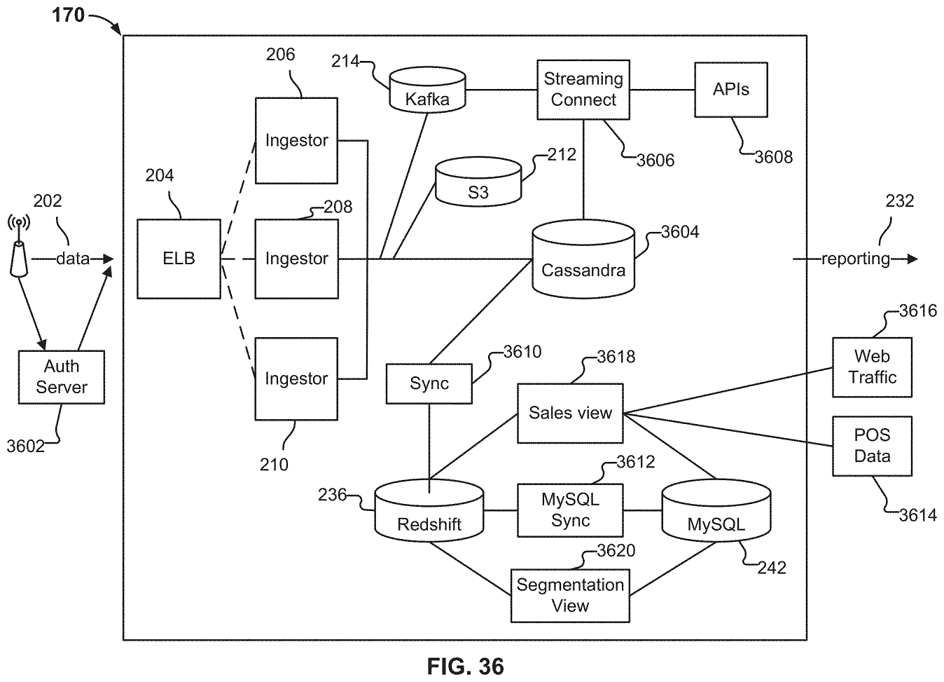

FIG. 36 illustrates an embodiment of a traffic insight platform, such as platform 170. In some embodiments, platform 170 of FIG. 36 is an alternate view of platform 170 as shown in FIG. 1 and FIG. 2.

Obtaining User Information

Information about the users who have opted in to having their identity known for a location is obtained by platform 170. The information can be obtained as part of the log data 202 collected by sensors such as access points. For example, in the example environment of FIG. 35, when John logs into ACME Clothing's WiFi, he provides his email address. An access point such as sensor 108 packages John's contact information with the MAC address of the device John used to login, the MAC address of the sensor, an indication of an opt in, and any other information as appropriate.

As described above, a user such as John can also opt in or login via his social media account. For example, suppose that John elects to login with his Facebook account. John enters his Facebook account credentials into a login page provided on his mobile device. In some embodiments, the sensor communicates with an authentication server 3602. The authentication server in turn communicates with Facebook. For example, the authentication server uses OAuth to authenticate John and obtain authorization to access John's information. The information about John obtained from Facebook can include personally identifiable information such as John's name (first name, last name), profile picture, contact information, birthday, preferences, etc.). Other examples of information about John that can be obtained include non-personally identifiable information, such as demographic information about John (e.g., age, gender, income bracket, zip code, etc.).

The information about John obtained by the authentication server is packaged into a data packet, which is then sent to platform 170. The data packet also includes the MAC address of the sensor that handled the authentication request, as well as the MAC address of John's mobile device and an indication that a user with John's identity information has opted into being identified (not anonymous).

The user information obtained, as described above, is then processed by platform 170. For example, similarly to as described with respect to data 202 of FIG. 2, the user information is processed through ELB 204 and ingested via ingestors (e.g., ingestors 206-208). In some embodiments, the personal information is ingested through a separate portion of ingestors 206-208 than data about device activity.

The obtained user information is then parsed by the ingestors. In some embodiments, the user information is written to Amazon S3 (212). In the example shown, the user information is also directly written to database 3604, which as one example, is implemented as a Cassandra database. In some embodiments, the user information stored to Cassandra database 3604, which can include PII, is encrypted. Thus, opt in data (i.e., personal data about users that have opted into being identifiable) can be processed in real-time.

An example of the processing and encryption performed when storing personally identifiable information to database 3604 is as follows. In some embodiments, device MAC addresses are hashed twice to create an irreversible string of characters that is unique to the original MAC address. An MD5 hash of the original MAC address can be performed. In some embodiments, a static salt is also used (i.e., salted hash). A Scrypt hash of the resulting MD5 hash is then computed. In some embodiments, any PII to be accessed (e.g., email, phone numbers, first and last names, birthdays, etc.) is encrypted in its raw form. The PII can be made available only to specific customers or partners or clients of platform 170. In some embodiments, AES 128 encryption is used for all partners with client specific keys. In this example, each piece of PII is stored in its encrypted form in Cassandra database 3604, as well as other data stores such as Redshift 236 and MySQL 242. The data can be decrypted, for example, for display (e.g., at an API layer for display).

Layering Personally Identifiable Information on Passive Data

As described above, platform 170 is configured to passively collect data about the behavior of devices in locations. Each device is uniquely identified by a corresponding device identifier, such as a MAC address. Similarly, when a user opts in to having their identity known at a location, their consent to opt in is associated with the MAC address of the device that the used to perform the opt in. Any information about the user, such as PII, demographic information, etc. is also tied to a specific device (identified by its MAC address). Thus, the MAC address can be used to link or bridge collected passive data with obtained user information.

By tying together passive data determined from device activity with information about the user of the device, additional insights can be gained. For example, a representative of ACME Clothing, such as Rachel, can now view the actual people (and the information about them) who were in the store in the last day (versus anonymous devices). As another example, the visitor metrics and other measures described above such as duration, visit frequency, bounce rate, zoning, loyalty, etc., which were determined anonymously, can now be linked with identified users and information about the users. For example, platform 170 can now determine that a specific user, John, with certain characteristics and attributes, spends on average thirty minutes at a store during a visit, where he spends 67% of his time at a specific zone, that he has visited a store ten times in the last two years, and that his last visit was a month ago. Since he hasn't been back in a while, John can be sent a free coupon to incentivize him to return, using the contact information that he has provided when opting in to being identifiable.

Those visitor metrics can also then be viewed in reports or dashboards at finer levels of granularity. For example, the metrics can be segmented based on user information such as demographics. As another example, the visitor data that is no longer anonymous, but tied to specific individuals, can be integrated with other data sets to allow for a complete view of a user. In the example of a shopper, the shopper's online behavior and purchase history can be joined with their in-store visitor behavior that is determined by platform 170.

In one example embodiment, such data integration, analysis, and reporting is performed as follows. The user information written to database 3604 is synced (using sync engine 3610 and MySQL sync engine 3612) to a data warehouse such as Redshift 236 and MySQL 242, In some embodiments, the syncing of the user information is performed to other data stores to facilitate querying and data access. For example, because Cassandra is optimized for high throughput and performing a large number of parallel writes, the data from real-time streams processed by Kafka bus 214 can be quickly written to Cassandra. The data can then be synced to slower data stores such as data warehouses and databases for querying.

The user information can then be analyzed or integrated with other data sets (e.g., for reporting). For example, user identifiable information can be integrated with metrics data (e.g., generated using metrics pipeline 230) as well as external data sets such as point of sale data (3614), web traffic data (3616), or any other appropriate data set to generate more complete and robust views of users. For example, personal information for a given user and visitor metrics data for the user can be joined together based on a matching unique device identifier (e.g., hashed MAC address of a mobile device). The metrics data determined based on device movement can then be integrated with John's online data based on John's personal information, such as his email address, which is tied with his mobile device at opt in, and which also happens to be the email he used to register with ACME Clothing's online website.

The integrated data sets can be used to provide additional insights into sales views (3618) and segmentation views (3620). For example, a representative of ACME Clothing can view the identities of the people who visited their store during the day, how long certain segments of people were in certain zones, etc. Further details regarding a segmentation tool will be described in further detail below. The integrated data sets can also be used to provide enriched personalized experiences, etc. For example, a shopper such as John can be provided with a personalized shopping experience. For example, John can be provided personalized engagement both within and without a location (e.g., in store and out of store). For example, the integrated data about a user can be queried, packaged, and sent (e.g., via an API) to applications such as employee engagement apps, or used to send messages to the user, as will be described in further detail below.

Real Time Connection of Detected Devices with User Identities

As described above in the example of FIG. 2, platform 170 ingests data collected from various sensors about devices (passively) observed by the sensors. The information includes real time raw data about the mobile devices that have been detected by sensors. For example, the information ingested by platform 170 for a detected device includes the device identifier of the observed mobile device (e.g., device MAC address string), the device identifier of the sensor that detected the presence of the mobile device (e.g., MAC address string of Access Point), signal strength, and a timestamp of when the mobile device was detected by the sensor.

In some embodiments, the raw data is written to Amazon S3 (212). The raw data is also written to real-time messaging bus 214 (e.g., Apache Kafka). In the example shown, the messaging bus is implemented as a high throughput, highly parallelized publisher/subscriber system, which provides a real-time subscription of the output of the ingestors (i.e., providing a real-time data feed of the raw data that is being processed by the ingestors).

The real-time data feed from bus 214 is passed to streaming connect engine 3606. The streaming connect engine is configured to determine, in real-time, for a detected device (included in the real-time data feed), whether there is a user of the detected device that has opted into being identifiable at the location at which the device was detected. In some embodiments, the streaming connect engine comprises a streaming job that is configured to fuse or join the identifiable information maintained in Cassandra database 3604 with the passively detected devices included in the data stream provided by Kafka bus 214.

For example, suppose that several months later, John returns to ACME Clothing. His device is detected by a sensor (which may be a different sensor than sensor 108) at the store, which passes on the information to platform 170. Platform 170 obtains the data (e.g., device MAC, AP MAC, timestamp, etc.) in real time, which is passed to the streaming connect engine. The streaming connect engine performs a lookup using the AP MAC address to determine the store location (ACME Clothing store in San Francisco) that includes the sensor and the customer of platform 170 that operates the store (ACME Clothing). Thus, the streaming connect engine has identified the store and/or platform customer. The streaming connect engine then uses the device MAC address and the identified store (or operator) to perform a lookup of the Cassandra database 3604 and determine whether the device has opted in to being identifiable at the location (e.g., a user has used the device to log into the store's WiFi and agreed to be identifiable, as described above). As one example, based on the lookup, the streaming connect engine obtains a list of locations for which the user of the device has agreed to be identifiable. The list indicates whether there is a user associated with the device that has granted consent to allow themselves to be identified by the particular determined store and/or platform customer (where John may have opted into being personally identifiable to ACME Clothing, but not to another store brand, Fashion Forward). In some embodiments, the locations at which a user has consented to being identifiable is stored in a profile or record associated with the user. In this example, the streaming connect job determines, in real time that John's device has previously logged into being identifiable at the determined ACME Clothing store.

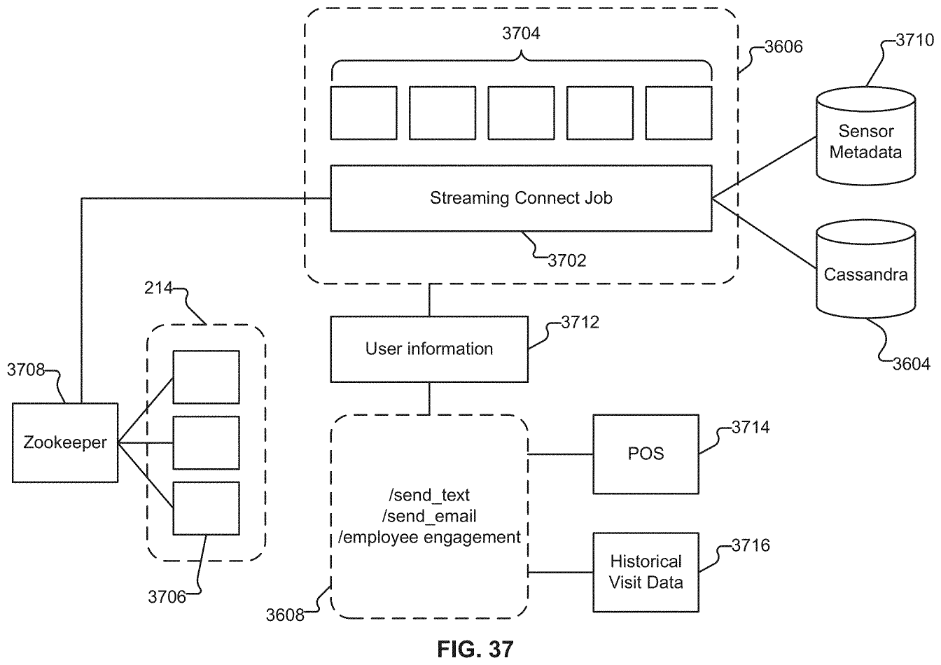

Further details regarding the streaming connect engine are described below in conjunction with FIG. 37.

Upon determination, in a real-time, that the user of the device has opted in to being identifiable at the location at which the device was detected, information about the user can be used to perform various actions, as well be described in further detail below. In some embodiments, the actions are facilitated via APIs (3608).

Streaming Connect Engine

FIG. 37 illustrates an example embodiment of a streaming connect engine, such as streaming connect engine 3606 of FIG. 36. Also shown in this example are embodiments of Kafka bus 214, Cassandra database 3604, and APIs 3608.

In one example embodiment, a streaming connect job (3702) used to implement the logic of streaming connect engine 3606 is written in a distributed parallel processing framework, such as the Spark streaming framework. The distributed parallel processing framework is run on top of a computation cluster (3704) such as Mesos (an open source Apache, top level domain project for distributed computing—e.g., a distributed systems kernel).

In this example, Kafka bus 214 is implemented on its own computation cluster 3706. A state maintenance engine 3708 is used to maintain or otherwise keep track of the state of the computation cluster on which the bus operates. As one example, state maintenance engine is implemented using a tool such as Zookeeper. For example, Zookeeper keeps track of the data streams that are processed using Kafka, keeping track of the state of each node in the Kafka computation cluster.

In the example shown, the streaming connect job is connected to Kafka bus 214 via state maintenance engine 3708. The streaming connect job is configured to pull data in real time from bus 214. In some embodiments, the streaming job places the real time data into a data structure corresponding to the implementation of the streaming job. In this example, the streaming job is implemented as a Spark streaming job, and the real time data is packaged into a Spark resilient distributed dataset (RDD), a distributed data structure with a temporal component that keeps track of similar data sets over time. The Spark streaming job then performs real time calculations on the placed data.

As one example, the streaming job performs processing on a block of ten seconds (or any other appropriate temporal window) of data pulled from bus 214 (e.g., every ten seconds, the spark streaming data takes all of the data that is seen in those ten seconds and performs processing on the ten seconds of data).

One example of the processing performed by the streaming job is as follows. For the last ten seconds of data from all of the streams processed by Kafka bus 214, the data is grouped by device identifier (e.g., mobile device MAC address) and sensor identifier (e.g., access point MAC address). A join is then performed on the data with opt in data from Cassandra database 3604 (database of PII) as well as sensor metadata 3710, which includes metadata that maps sensors to particular locations and/or customers of platform 170 (e.g., a sensor network hierarchy/hierarchy of access points, as described above).

The streaming job determines for each visitor (detected mobile device), using the accompanying sensor MAC address that observed the mobile device and sensor metadata 3710, what physical location (or operator of the location, e.g., retailer) the mobile device was detected at. The MAC address of detected device is used to access PII database 3604 to determine whether the device is associated with a user that has consented to being known or identified by the store at which the mobile device detected (i.e., has opted in for the determined store or store operator). As one example, the streaming job obtains from database 3604 a list of tuples, where each tuple includes a device id (MAC Address) and an indication of a location or locations with which the user of the device has consented to being known. In some embodiments, the tuple is a tuple of the device id and the sensor that was used to handle the opt in of the device. Sensor metadata can then be used to determine what location or entity the sensor is associated with. Thus, even if a device is detected by a sensor different from the one previously used to opt in the user of the device, the device can still be determined to be associated with an opt in user if a common location or entity is identified using the sensor metadata.

The various obtained pieces of information (e.g., which device has allowed identification of its user at a location, and the location that the mobile device was detected at and user information associated with the mobile device) are fused or combined or joined together by the streaming connect job to determine whether there is a user of the detected device that has opted in to being identifiable (not anonymous) to the particular store (or entity operating the store). Thus, for the ten seconds of real time data processed at a time by the streaming connect job, the streaming connect job determines which devices have opted in (i.e., user of the device has agreed to be identifiable) to the location that they were detected at. Information about the users identified as carrying the detected devices can then be obtained to perform various actions.

For example, requests can be sent to other services via APIs 3608, triggered based on the real time determination of the identity of the person whose presence has been detected at a location. In various embodiments, APIs 3608 are implemented as REST APIs, Streaming APIs, push APIs, dynamic APIs, or any other type of API as appropriate.

In some embodiments, APIs 3608 can be used to integrate user information 3712 (associated with the user that has been identified by streaming connect job 3702), point of sale information 3714, historical visit data 3716, or any other data, as appropriate to perform actions.

As one example of an action that can be performed, a messaging API can be used to send messages such as text and email directly to a user's mobile device using their contact information obtained from database 3604. Thus, for example, a customer of a store can be sent a notification in real time (e.g., welcoming them to the store) in an unobtrusive and transparent manner, without requiring any action on behalf of the customer or store associates.

PII or demographic information-based decisions can also be made now that a specific or particular user can be identified as having entered a location (not just an anonymous device). As described above, other information such as point of sales data and historical visit data (e.g., visitor metrics, as described above) can also be used to perform actions. Examples of such personalized actions will be described in further detail below.

Additional Details

As described above, a traffic insight platform such as platform 170 can use information collected from sensors such as WiFi access points to detect the presence of devices (e.g., devices with WiFi, cellular, and/or Bluetooth capabilities) and gain insights about the individuals carrying those devices. Platform 170 can also be configured, as described above, to connect or attribute the detected devices with the identity of the individual carrying the devices. Platform 170 can then use the information about the identified user of the device to gain insights about those users, as well as facilitate various actions, such as engagement, analysis, and providing personalized experiences.

The following are examples of functionality supported by the connection of visitor behavior (determined from observation of device movement) with information about the users carrying those devices, as described above using a platform such as platform 170.

Opt-In and Opt-Out Solution

Using the techniques described herein, the physical, real-world activity of users can be monitored anonymously (i.e., the identities of users are anonymous) based on the passive detection of device movement, where no personally identifiable information about the users carrying the observed devices is collected. In addition, users can also elect to opt into being identifiable. Thus, within a single ecosystem (e.g., store location), both identifiable and anonymous users can be supported and co-exist using the techniques described herein,

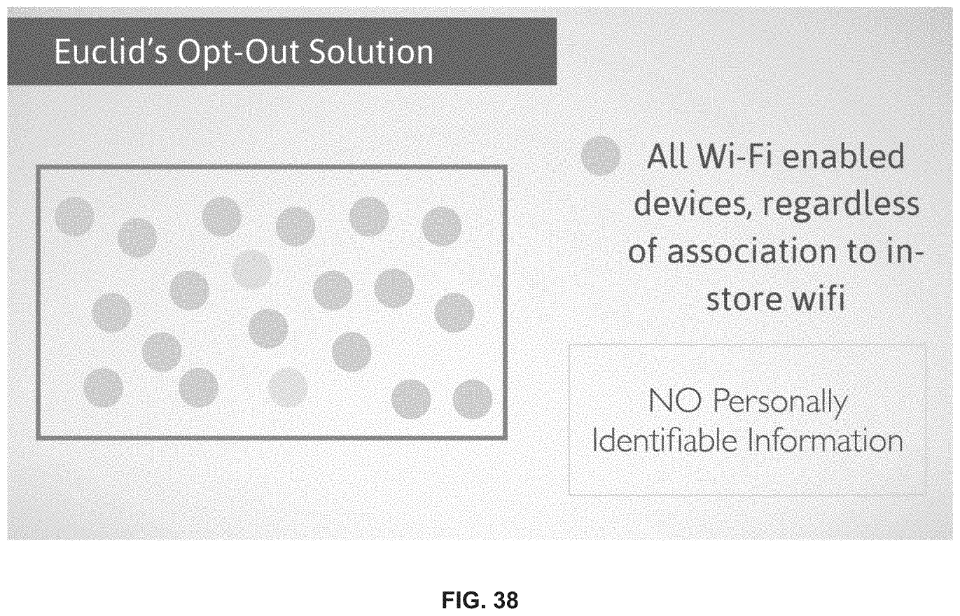

FIG. 38 is a diagram illustrating an example embodiment of an opt-out solution supported by a platform such as platform 170. In the example shown, the highlighted devices include WiFi enabled devices whose presence have been detected in a store, regardless of whether the WiFi enabled devices have associated to in-store WiFi. In the example shown, there is no personally identifiable information associated with the detected devices.

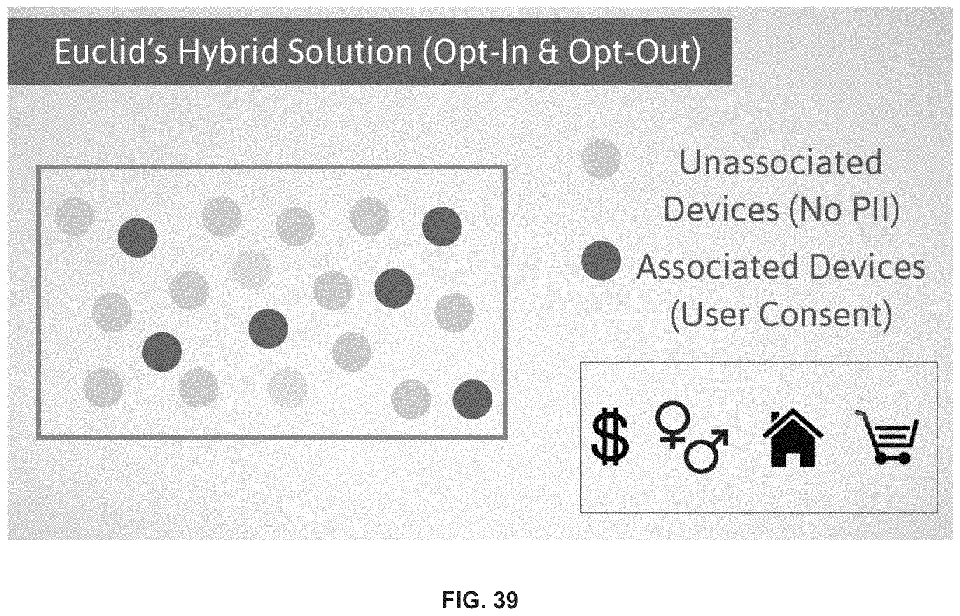

FIG. 39 is a diagram illustrating an example embodiment of a hybrid opt-in and opt-out solution. In this example, devices both unassociated and associated with the store's Wi-Fi are shown. In this example, no PII is known for those devices unassociated with the store's Wi-Fi. Those devices that have associated with the store's WiFi include devices whose users have provided consent to opt in to being identifiable at the location. An example of a user logging into a store's WiFi and providing user consent and authentication for personalization is described in conjunction with FIG. 40.

Initial Login

FIG. 40 is an example embodiment of a user interface for initial login. In this example, John is presented with a login interface for logging into Acme Clothing's WiFi. The login screen includes an option for a user to provide acceptance of terms and conditions for logging into the store's WiFi. The login interface also provides options to sign in via social media (e.g., the user's Facebook, Twitter, Pinterest, etc. accounts). Fields for entering contact information such as email address and mobile number are also provided. The user can then sign in. Using the information provided by the user (e.g., social media information and/or contact information), the user's personally identifiable information, such as that shown in FIG. 37 can be obtained and associated with the MAC address (or any other appropriate device identifier) of the user's device. As described above, in one example embodiment, if the user logs into their social media account, the user's personal information can be obtained via a mechanism such as OAuth. The user's personal information is associated with the user device's MAC address and can then be provided to a platform such as platform 170. For example, when John logs into Acme Clothing's WiFi, his personal information (contact information, social information, etc. for which John has granted access) is associated with his device's MAC address. This coupled tuple of information can then be sent to platform 170 for further processing as described herein.

After signing in, the user is provided with a second interface, which includes a personalized greeting (e.g., using the name obtained from the social media access that was granted by the user), as well as a coupon code.

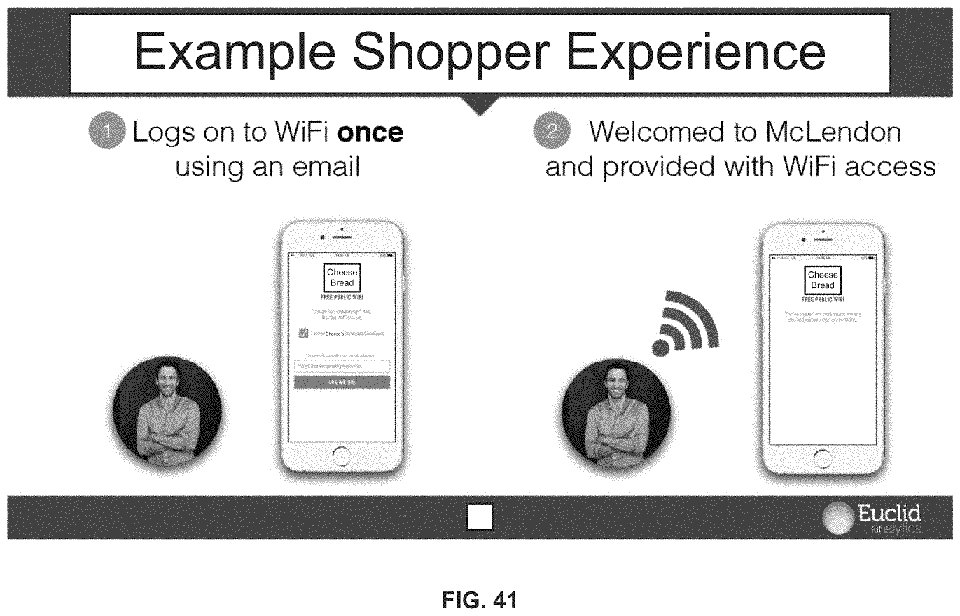

FIG. 41 illustrates an example experience for shoppers of a store. In this example, a user logs onto the store's WiFi once using an email address. The user is then provided with WiFi access.

Engagement

Direct to Consumer

Direct to consumer engagement actions can be taken based on visitor activity determined based on observed device movement. As one example, real-time actions based on detection of John's device can be performed. As one example, because John has previously provided his email address, when John's device is observed in or near an ACME Clothing store (which could be another physical ACME Clothing location at which John has not yet logged into WiFi), his email address can be identified by platform 170 based on his device's MAC address having been collected. Platform 170 can then send John an email to his email address with a coupon welcoming him back to the store. If John had provided his mobile phone number instead, he can be provided a text message when it is detected that his device is in an ACME Clothing store. In some embodiments, to prevent John from being spammed with messages, platform 170 records the time at which a message is sent. If a message has already been sent in the last 24 hours, no further messages are sent. In some embodiments, a messaging application programming interface (API) is used to send messages to users of detected devices.

Other direct to consumer communications can also be facilitated. For example, John's contact information can be used to engage him even outside of a store, where John is periodically sent emails about new ACME Clothing campaigns or promotions.

As one example, a campaign or promotion builder can be used to create targeted campaigns to incentivize users to return to a store. For example, users who have not been seen in a threshold amount of time can be sent a coupon encouraging them to return to the store. Thus, campaigns can be sent to users who are segmented based on visitor metrics determined based on device observations using the techniques described above. Dynamic loyalty programs can also be created that target certain segments of users based on the loyalty determined based on their detected devices, as described above. Campaigns can also be sent to users of certain demographics (using the user information obtained as described above).

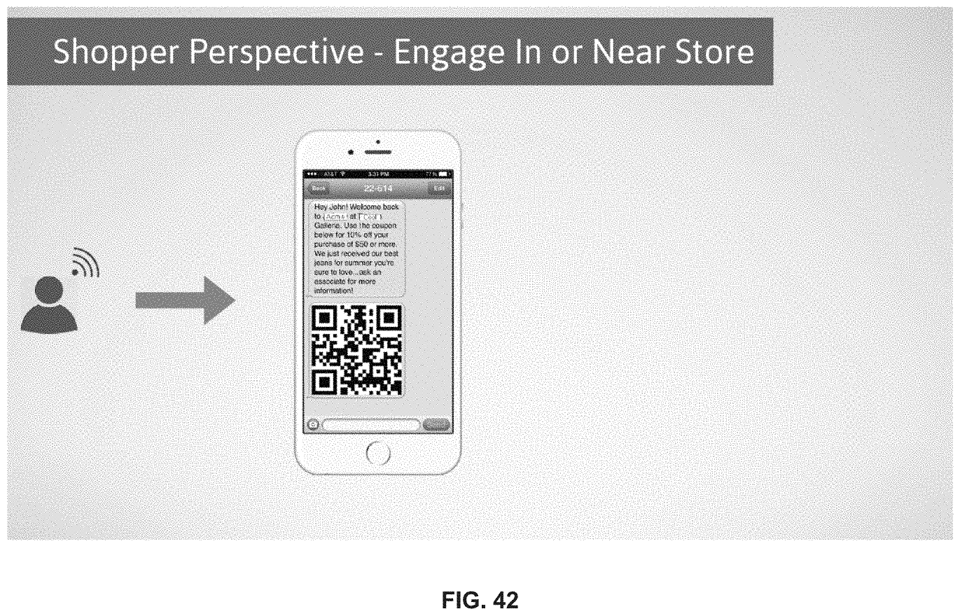

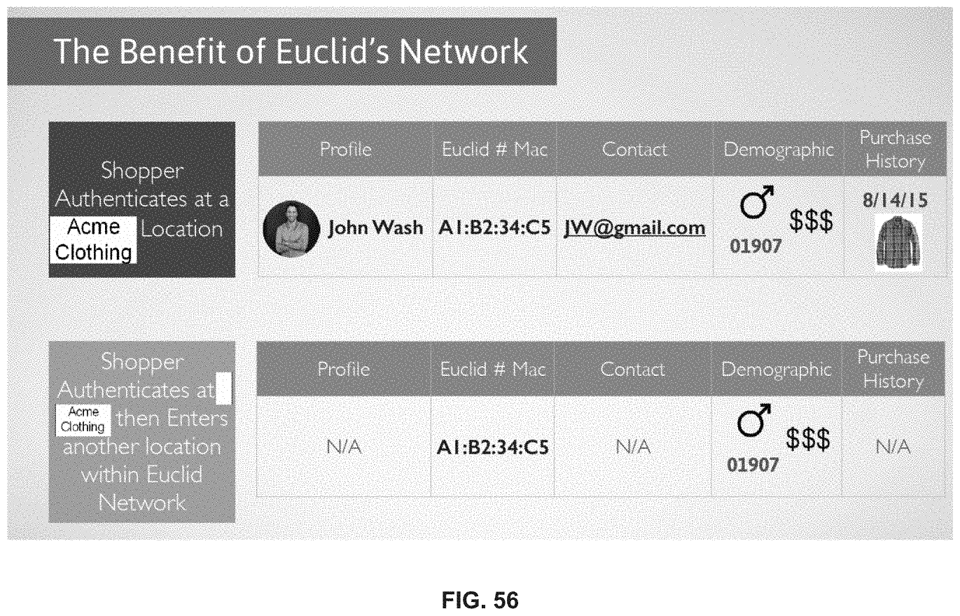

FIG. 42 is an example embodiment of an interface for engagement of a shopper in or near a store, from the shopper's perspective. In the example, shown, the presence of John's device in or near Acme Clothing is detected (e.g., using the zoning techniques described above) during a return visit. The MAC address of John's detected device is obtained. The record for John's device (e.g., a record such as the record shown in FIG. 56) is looked up using the obtained MAC address. John's name and contact information (e.g., phone number) is obtained from the record. A personalized message is sent to John welcoming him back to the store location. A coupon is also provided via text. In some embodiments, John's search or purchase history with Acme Clothing (e.g., historical purchases in store or online and/or search history when visiting Acme Clothing's website) are used to provide recommendations of other items that he may be interested in.

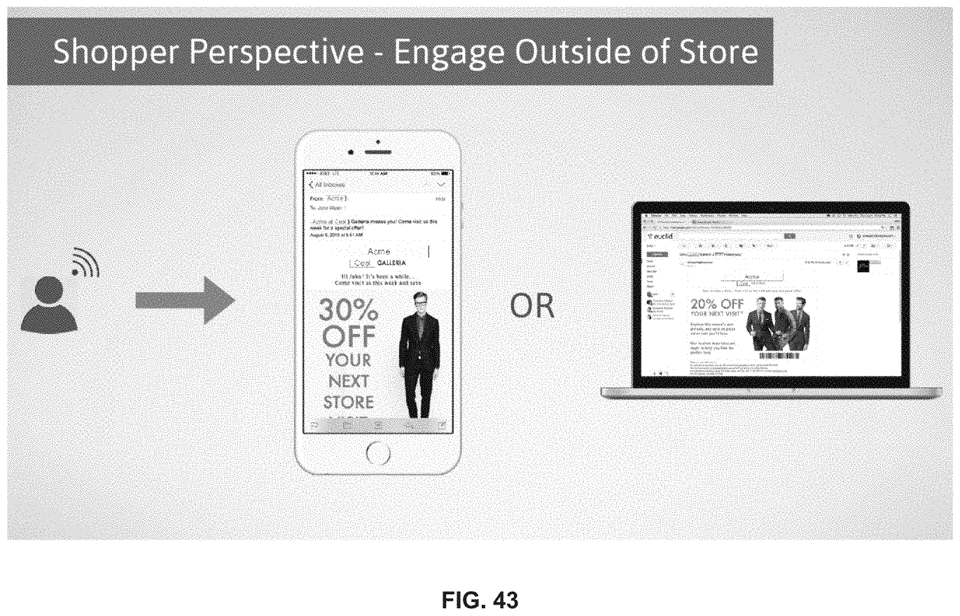

FIG. 43 is an example embodiment of an interface for engagement of a shopper while outside of a store, from the shopper's perspective. In this example, John has not visited the Acme Clothing location in some time. An email message is sent to him inviting him back to the store. A coupon is also provided.

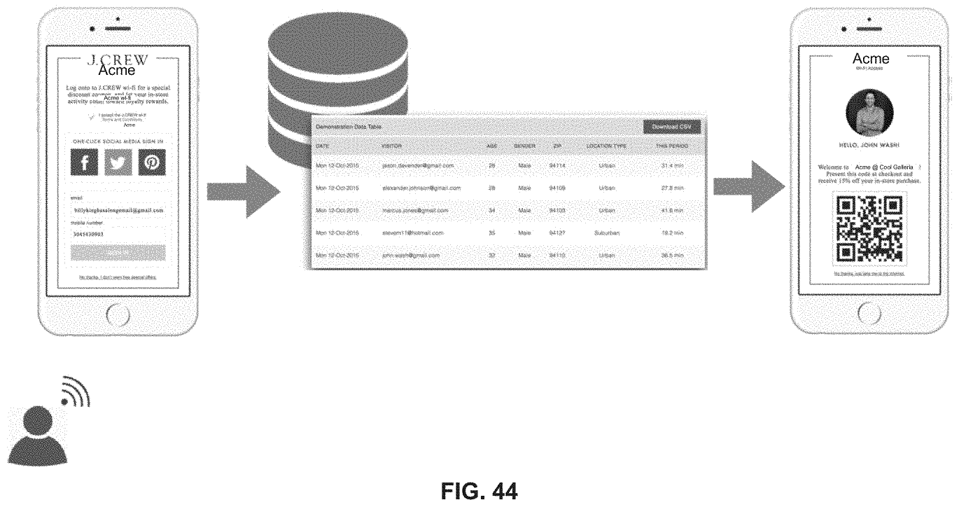

FIG. 44 illustrates an example embodiment of a flow in which a device's user is identified and the user is contacted. In this example, a customer such as John uses their device to log into a store's WiFi. The customer gives consent to the store (and platform 170) to obtain access to personal information (through their social media sign, providing their contact information, etc.) as well as demographic information. Platform 170 collects the information and associates it with the visitor's device, allowing the platform to identify the individual carrying the device whose presence is detected using sensors such as WiFi access points. This combined device and user information can be used to perform personalized actions such as sending email messages to individuals.

As another example, the ability to identify users that enter a location can be used to provide relevant context for digital displays resident at locations. For example, suppose that ACME Clothing has a digital display in its store. The digital display is connected to platform 170 (e.g., over a network such as the Internet via an API or other interface). When John walks into the store, he is identified by platform 170 using the techniques described herein. Because John has been identified, platform 170 can use information known about John (e.g., profile information, preferences, online web visit history, online purchases, online shopping cart, etc.) to determine what content that the digital display should show to John that is relevant to him.

For example, suppose that John's preferences (e.g., indicated by him on a preferences page or from his social media network) indicate that he likes skiing. When John enters ACME Clothing and is detected by platform 170, platform 170 can obtain his preference information and instruct the digital display at the store to show John (when he is near the display) directions to the section of the store that includes winter clothing.

As another example, John's web visit data can be used to determine what content should be displayed to him by a digital display. Suppose for example, that based on a lookup of John's recent web visit history at ACME Clothing's online store, John had put a belt in his cart, but had not purchased it. Platform 170 can instruct the digital display to display instructions to john that show the aisle in which belts are in.

As another example of direct to consumer engagement, platform 170 can provide relevant user context to chatbots. As one example, suppose that John is sitting at a sofa in the ACME Clothing store. John, while on the sofa, is engaged with a chatbot (e.g., supported using artificial intelligence) communicating on behalf of ACME Clothing. Suppose that John moves from the sofa and begins shopping. Platform 170 can detect John's change in position (based on the observed movement of his device using the techniques described above). Platform 170 can notify the chatbot of John's transition to an active shopper, which can then change the manner in which it engages with John accordingly (e.g., beginning chatting with John about shopping).

Employee Engagement Application

As described above, platform 170 can determine, in real time, the identity of an individual whose device has been detected at a physical location. The connection of observed device activity to a particular user identity can be used to facilitate personalized visitor experiences. As one example, the information captured by platform 170 can be used to provide relevant context for applications such as employee engagement applications.

For example, suppose that John had previously signed into ACME Clothing's WiFi network using a social media login (e.g., during the current visit or a past visit). As part of authenticating with his social media account, platform 170 obtains information about John from the social media network, such as PII including his name, profile picture, birthday, etc., as well as non PII including demographic information (e.g., gender, age, income bracket, zip code, etc.).

Suppose that a store associate at ACME Clothing has installed on their work phone an employee engagement app, which is connected to platform 170 (e.g., via an API). The employee engagement app allows the store associate to view information about visitors. In this example, when John walks into ACME Clothing the presence of his device is detected by platform 170. Because John has opted into being identifiable at ACME Clothing, platform 170 also determines that it is in fact John that has walked into the store (and not just an anonymous device). Platform 170 can then send/push (e.g., via a messaging API) an alert or notification to the store associate's engagement app indicating that John has just entered the store. Profile information associated with John, if available to platform 170 (e.g., online behavior, purchase behavior, etc.), can also be accessed using the employee engagement app, empowering the store associate to provide John with a richer and more personalized shopping experience. For example, the employee engagement app can query, via an API, John's personal information, point of sale data, historical visit data (e.g., when was the last time John was seen at the store), online behavior data, etc. that has been integrated at platform 170.

For example, ACME Clothing can upload, via an API, information to platform 170 about John such as the purchases he's made online, items that he has placed in his cart, his sizes for various articles of clothing, etc. The information can also be obtained via a CRM integration, as described in further detail below. Platform 170 can associate such information with John's profile (e.g., add his online behavior and purchase history to his profile). This information can be made to an employee engagement app. For example, suppose that an employee using the app sees that John had placed a suit in his online shopping cart, but did not purchase the suit. The employee can then find John and indicate that they have the suit in stock in the store if he would like to try it on.

Thus, if ACME Clothing is observing John's behavior online, platform 170 can pull that information, completing the entire shopper journey for John, from his online shopping to his in-store activity, as well as the purchases he makes at a point of sale. This provides a complete view of John as a shopper, including both his online and real-world shopping behavior,

As shown in this example, using the techniques described above, a store associate can automatically be notified of John's presence at the store without any active steps taken by either the store associate or John (e.g., the store associate and John do not need to actively seek each other out and John does not need to go through the process of providing his information to the store associate), creating a non-obtrusive process by which the store associate can provide a more personalized shopping experience for John.

In some embodiments, users, during initial login to ACME Clothing's WiFi, can also set preferences with respect to their being identifiable. As one example, suppose that another customer of ACME Clothing, Deborah, has also opted into being identifiable. Deborah can be presented with a preferences page during login which allows her to indicate that she would not like to be approached by store associates when entering a store. These preferences can be appended to a profile for Deborah, which can include the MAC address of her phone, her contact information, demographic information, etc. For such users, platform 170 can send a notification to (or otherwise display on) the employee engagement app that the users do not wish to be disturbed or bothered. Thus, Deborah's preferences are honored automatically and transparently. Other preferences for the user can also be viewed.

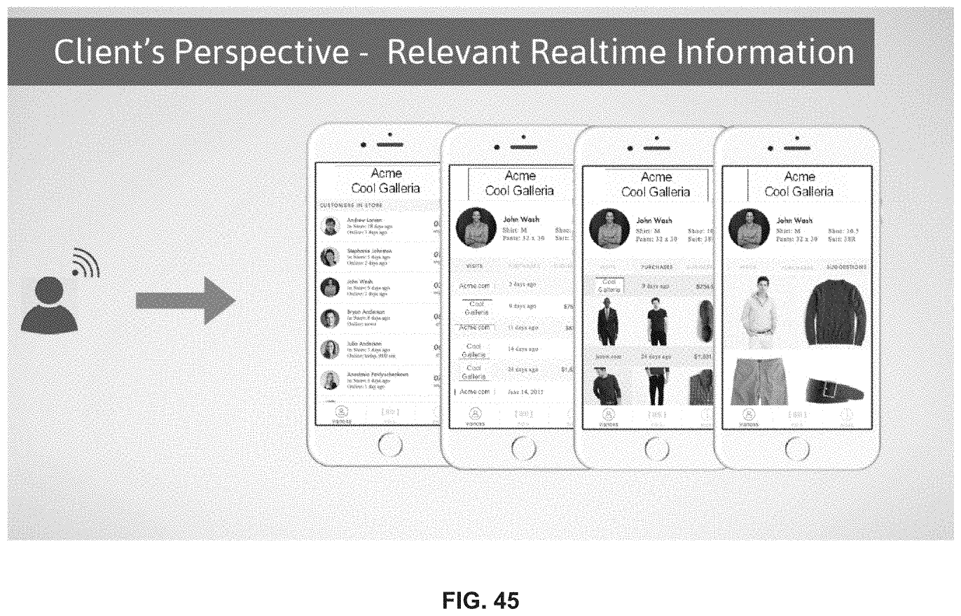

FIG. 45 is an example embodiment of interfaces displaying relevant realtime information that can be provided. For example, platform 170 can provide an employee engagement app with information about the customers that are currently in the store. The associate can then further view additional information individual customers, such as their previous visit history (either to physical location or to entity's online store), their sizes for various articles for clothing, previous purchases, as well as suggestions for what to recommend to a customer to purchase. Thus, the associate can provide a better and more personalized shopping experience for a customer such as John Wash, who has opted into the service.

Thus, as described above, personalized engagement can be provided for identifiable visitors.

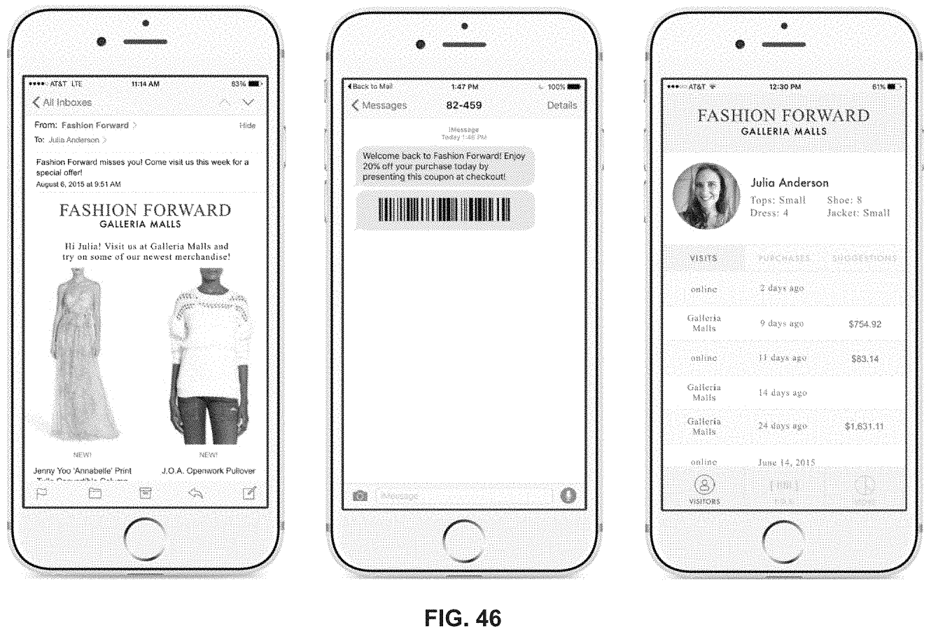

FIG. 46 illustrates example interfaces for engagement and personalization. In this example, direct consumer engagement, such as email or text messages sent to a visitor, are shown. Also shown is an example app interface for viewing visitors (and attributed information) of a store. As shown in this example, information about a specific visitor can be viewed. In this example, the historical visit information for a visitor is shown, along with information such as the visitor's sizes with respect to various types of clothing. Other information, such as purchases and suggestions can also be viewed via the employee engagement app.

Data Integration

In some embodiments, the visitor activity information, now coupled with information about a specific user identity, can be integrated with other data sets. For example, information from CRM systems or other external systems can be integrated at platform 170 and used by platform 170 to perform various functionality and actions. Similarly, via an API, the device activity and corresponding user information can be exported to CRM systems for entities such as ACME Clothing that utilize the services of platform 170.

As one example, using the techniques described herein, ACME Clothing can now have a more robust, and complete view of John as a shopper. For example, suppose that John has an online account with ACME Clothing. ACME Clothing has information about John's online behavior (e.g., when he is browsing ACME Clothing's online storefront). Suppose that John's ACME Clothing username is the same email address that he provided to sign into the WiFi at the ACME Clothing physical location. Now, ACME Clothing can integrate (e.g., via a customer relationship management (CRM) system) John's online visit information with his physical store visit information, as well as with other information, such as point of sale information. ACME Clothing can thus have an integrated view of John's online behavior, real world visit behavior, and purchase behavior, which can be used to provide rich, omni-channel experiences for John. For example, John can be provided personalized engagement in a variety of engagement mediums such as digital (e.g., emails), physical (e.g., in-store), and environmental (e.g., providing relevant context to mediums such as digital displays, an example of which will be described below).

As one example, web visit data and purchase data can be combined with store visit data. For example, a service such as Mixpanel may be used to track John's web visit data. When John logs into his online account on AMCE Clothing's website, he is tagged with a cookie in order to know that he has logged in, and will collect data about his behavior on that website (e.g., average time per visit to the site, how often he goes to the site, what departments he clicked on the website, etc.). Via an API integration, John's online behavior can be combined with his real-world, in-store behavior. As another example, purchase data obtained from services such as Square (e.g., from point of sales systems) can also be combined with store visitor data. Such information can be added to a user's profile stored on platform 170.

In some embodiments, users who have opted into being identifiable can be added from platform 170 to CRM systems (e.g., adding rows to the CRM system) if they are not already in the CRM systems. (e.g., represented by new email addresses). For users who already exist in the system (as well as for new users added by platform 170), new types of fields can be added for the user (e.g., adding columns to the CRM system), including information about their visit behavior. This allows a profile of a user in the CRM system to be built upon with new information (e.g., when was the user's last visit, how long did they stay when they entered a location, etc.). Thus, platform 170 can provide or otherwise integrate physical, real-world profile information of users into CRM systems, which integrate various data sources to provide a centralized view of end user customers.

Segmentation Tool

As another example, ACME Clothing, utilizing the services provided by platform 170, can also have greater granularity into the visitor activity determined using the techniques described above. As one example, a service such as Rapply can be used to obtain demographic information about John based on the email address he provided. Demographic information can also be obtained from social networks if John opts into being identifiable using his social media account. This demographic information (e.g., age, gender, income bracket, zip code) can be associated with his in store or visitor activity. A representative of ACME Clothing can then use platform 170 to view reports on in store activity that can be segmented based on demographic dimensions, providing further insight into in-store activity.

For example, metrics associated with zoning, bounce rate, duration, visit frequency, loyalty, etc. can be segmented based on demographic information, allowing a representative of ACME Clothing, for example, to determine bounce rate for males in their 30s, as compared to females in the same age demographic. Various dimensions and user characteristics can be used to create segmentation views of users, as appropriate.

Thus, more granular insights into groups of visitors, as well as information about specific visitors can be viewed by layering user information on top of the visitor metrics and measures determined based on device observation, as described above.

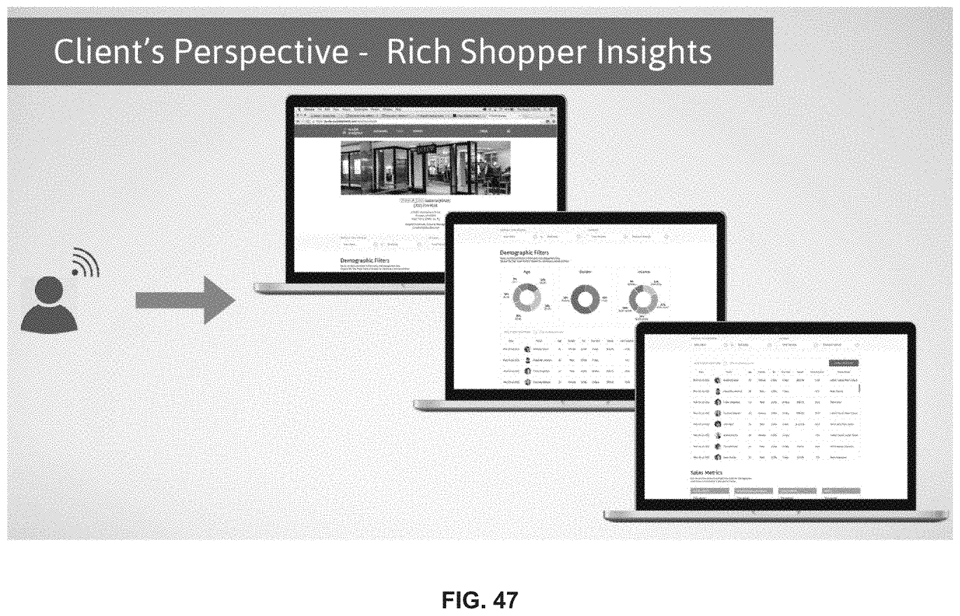

FIG. 47 is an example embodiment of interfaces for providing rich shopper insights, from the perspective of an entity utilizing the services of platform 170. For example, a representative of Acme Clothing can access Acme Clothing's account on platform 170, as described above. Various dashboards can be presented to Rachel that provide rich information about visitors to Acme Clothing's stores. For example, demographic filters can be used to segment collected information. The users that fit within the demographic can be identified.

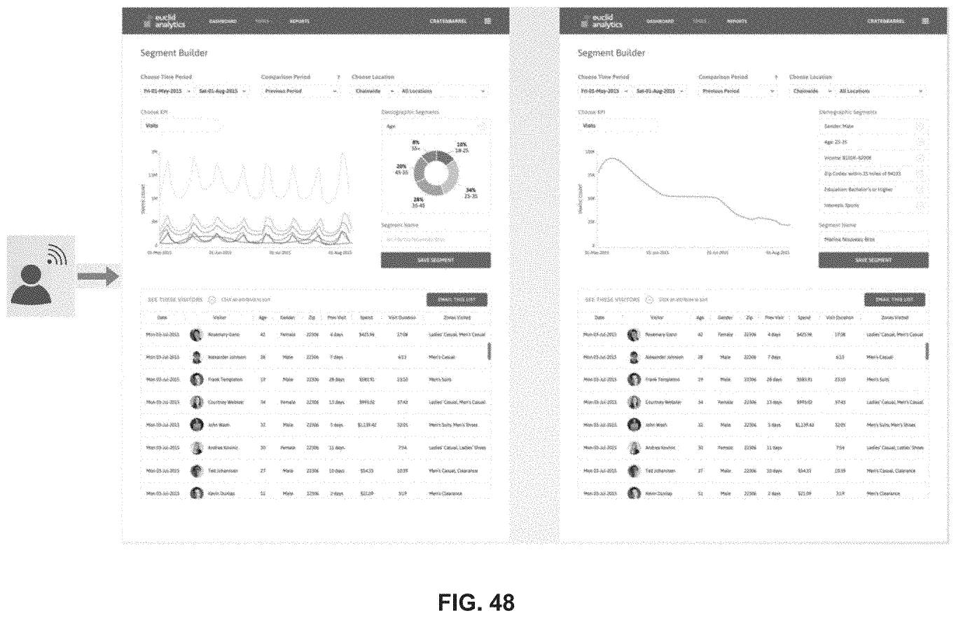

FIG. 48 is an example embodiment of a segmentation builder interface. In the example shown, a representative can view information about visitors to Acme Clothing locations. For example, the representative can segment the visitors by time period, comparison period, location, etc. The representative can also view a breakdown of visitors according to various demographics (e.g., such as age, as shown in this example). The representative can also segment visitors by demographic information. Rachel can also view personalized information about opt-in visitors (whose identities are now known), who have provided access to personalized information, such as name, age, zip code, amount spent during a visit, etc. Other information about the visitor, such as zone visited, visit duration etc. can be viewed as well. In some embodiments, the information about various segments of visitors can be exported (e.g., emailed, exported to a comma separated values (CSV) file, spreadsheet, etc.).

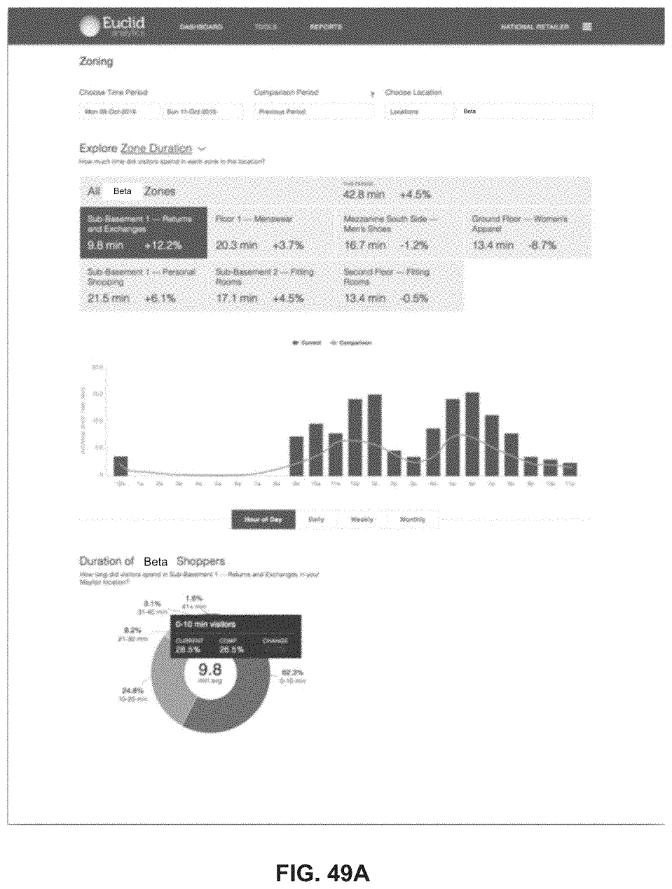

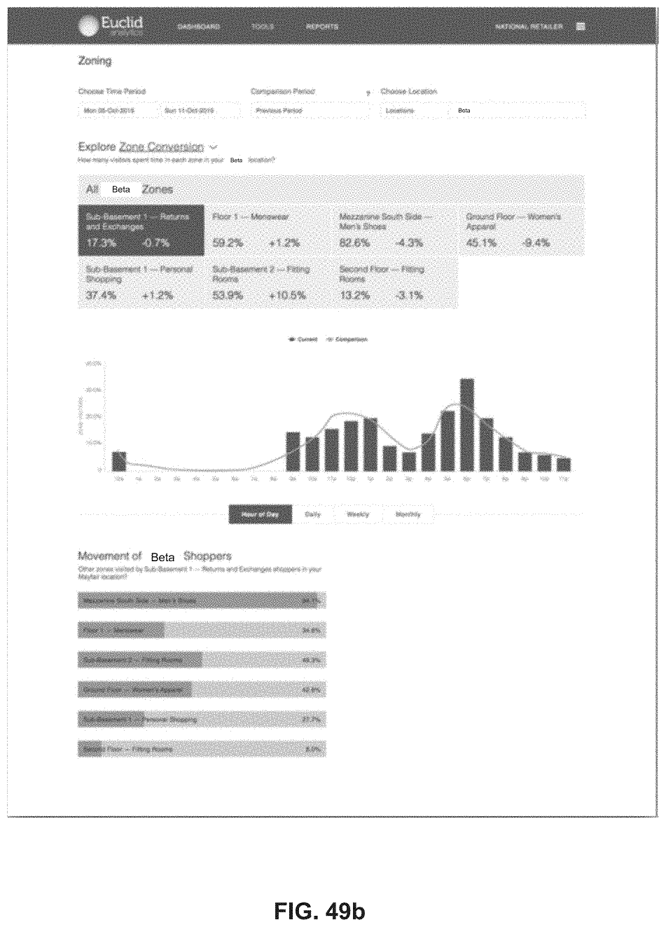

FIG. 49A illustrates an example embodiment of an interface for exploring zoning. For example, reports on zone duration and zone conversion can be provided by platform 170.

FIG. 49B illustrates an example embodiment of an interface for exploring zoning. In some embodiments, the report shown in FIG. 49B is provided by platform 170.

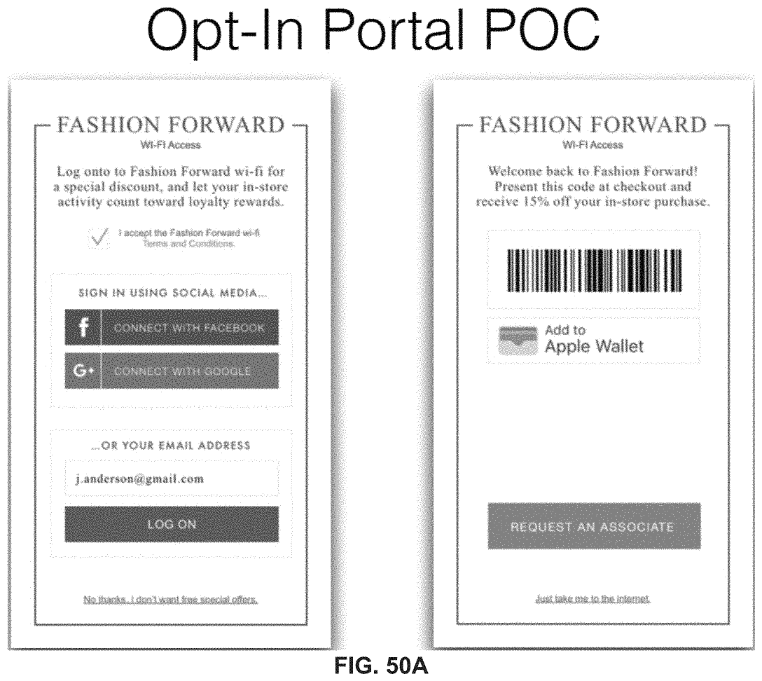

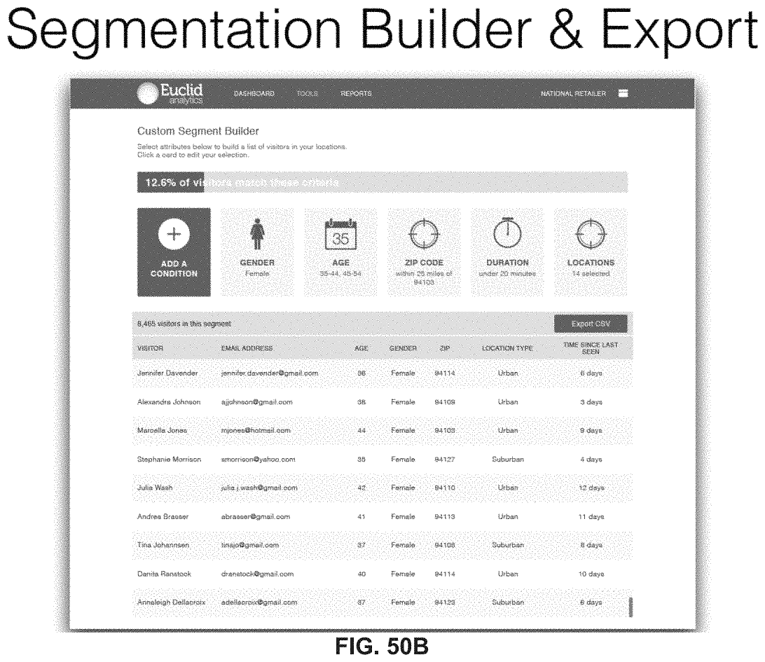

FIG. 50A illustrates an example embodiment of opt-in portal POC interfaces.

FIG. 50B illustrates an example embodiment of a segmentation builder and export interface.

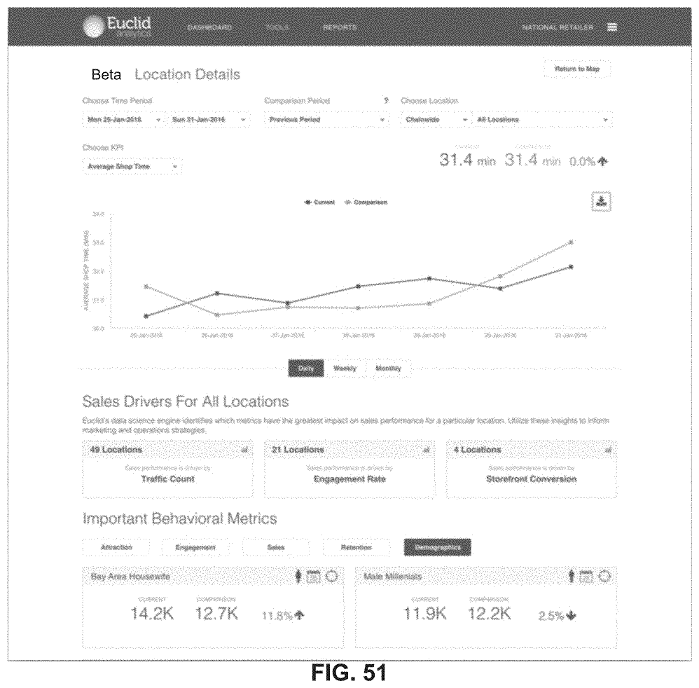

FIG. 51 illustrates an example embodiment of a segments view for a location. As shown in this example, information about particular demographics such as bay area housewives and male millennials can be viewed.

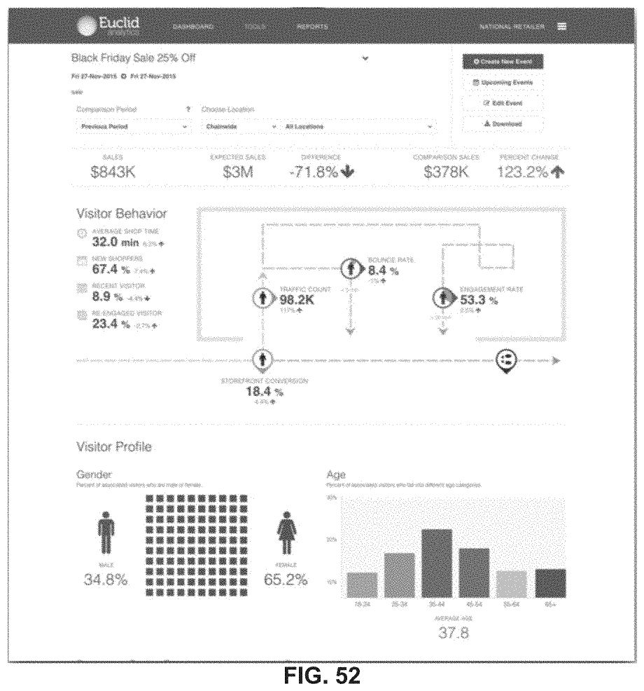

FIG. 52 illustrates an example embodiment of a segments view. In the example shown, the breakdown of associated visitors (who have opted into being identified at all locations for chain) for a certain period of time can be viewed based on gender and age.

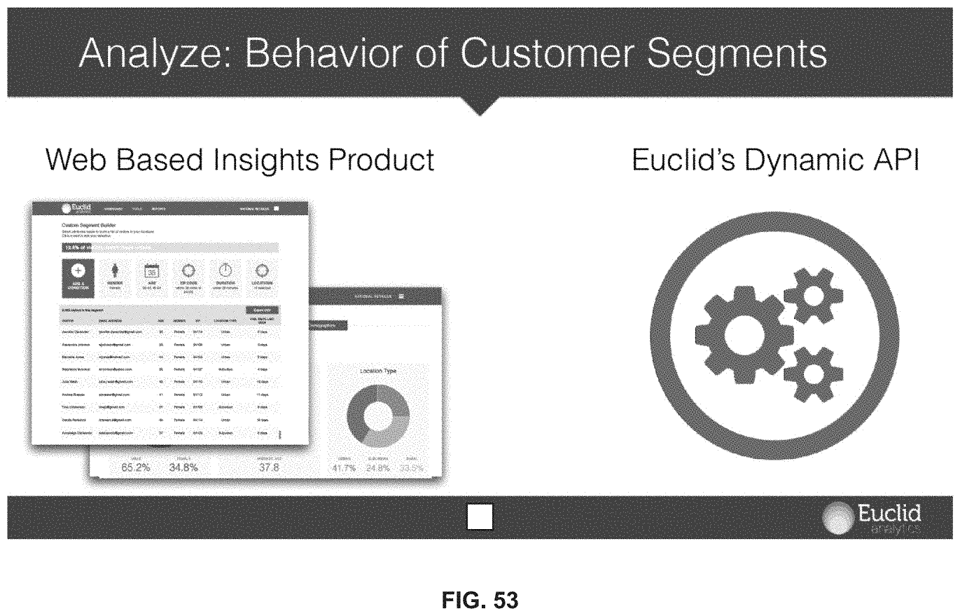

FIG. 53 illustrates an example showing analysis of behavior of customer segments. In this example, web-based dashboards and reports can be viewed providing insight into the behavior of customer segments. Customers can be segmented based on demographic information as well as location information determined for detected devices. In some embodiments, platform 170 provides a dynamic API by which the information collected and determined by platform 170 can be accessed by other entities.

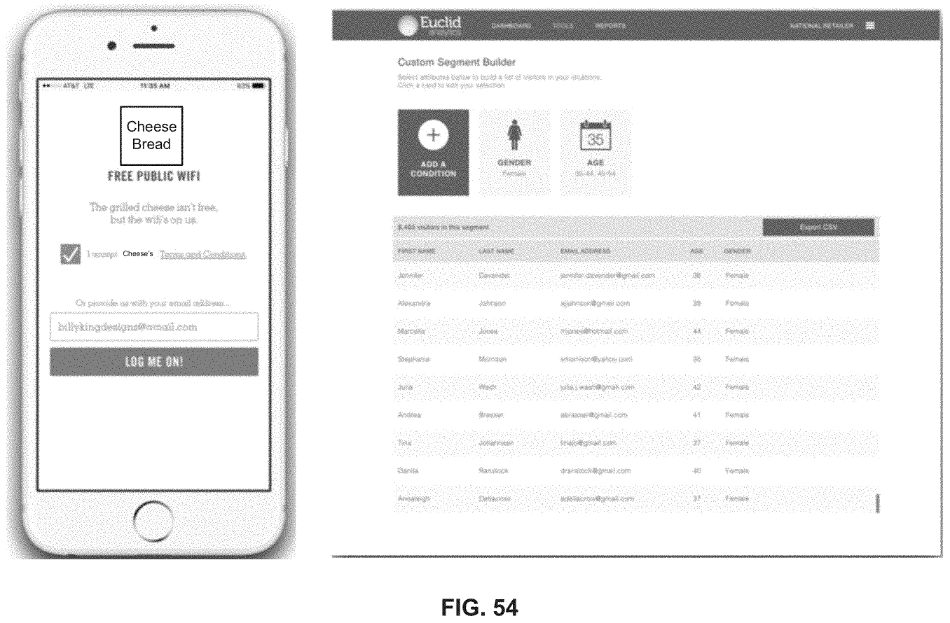

FIG. 54 illustrates an example of email capture and attribution. As shown in this example, guests (e.g., visitors of store) can use their mobile devices to provide information such as an email address to access infrastructure such as WiFi. The obtained contact information (and any other captured information) can be attributed to guest visits and used by the store to view, segment (e.g., using a segmentation tool described herein), and export guest visits. For example, demographic attributes can be used as conditions on which to filter visitors and determine segments. In this example, a user has used the segment builder to build a segment of visitors that are female and between the ages of 35-44 and 45-54. The list of visitors that fit this segment, and the information about the visitor (e.g., first name, last name, email address, age, and gender) are also shown. The list of visitors in this segment can also be exported (e.g., to CSV, a spreadsheet, email, etc.). Various other reports can be provided as output as well.

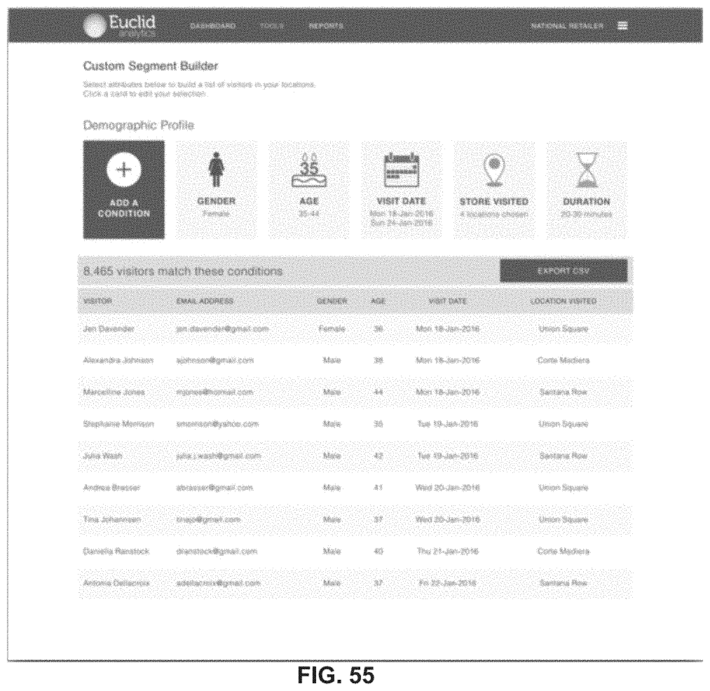

FIG. 55 illustrates an example experience for entities utilizing the services of platform 170 described herein. For example, entities can export lists of shoppers filtered by various conditions and criteria such as visit date, gender, age, store visited, duration. As another example, entities can also receive a report of when targeted shoppers (e.g., targeted segments of users) visited the entity's location. Filtering visitors based on certain demographic profiles (using information obtained using the techniques described herein) allows for granular insights into the visitors at locations.

Preventing Convergence of Sales Associates

As described above, when John walks into ACME Clothing, store associates can be notified automatically of his presence. While there may be multiple store associates, each of whom receives the notification of John's presence, it would be beneficial to prevent multiple associates from converging on John. Prevention of convergence of multiple associates on a single customer can be performed in a number of ways. As one example, a user such as John can set a preference for an employee that he already has a relationship with. When John's presence is detected at ACME Clothing, only that employee will be sent an alert that John is present.

As another example, only the associate closest to John is alerted so that not every associate attempts to assist him. The closest associate can be determined using the techniques described above. For example, a device can be inferred as belonging to a store associate, or the store associate's device can be explicitly indicated as a store associate device (versus a visitor device). The location of the store associates' devices can be determined by sensors, and the nearest store associate to John (whose position can also be determined) can be identified and alerted.

Asymmetric User Information Sharing

As described above, a user can be identified at a location if they have opted into being identifiable at that location. For example, because John has opted into being identifiable at ACME Clothing stores, whenever he enters an ACME Clothing store, his personally identifiable information may be used to provide a personalized experience for him. Suppose that John also visits another store, Fashion Forward. Fashion Forward, like ACME Clothing also makes use of the services provided by platform 170. However, John has not opted into being identifiable at Fashion Forward. Therefore, even though platform 170 has John's personally identifiable information, Fashion Forward will not have access to it. However, some information, such as non-PII, can be asymmetrically shared with Fashion Forward, without revealing John's identity. For example, when John's device is detected at Fashion Forward, platform 170 can provide John's demographic information (e.g., age, gender, income bracket, zip code, etc.). This allows Fashion Forward to have enhanced insight into the user of John's device, without revealing John's identity to Fashion Forward, thereby maintaining his privacy.

FIG. 56 is a diagram illustrating an example embodiment of benefits of a multi-location network provided by platform 170. In this example, platform 170 provides services to multiple locations/entities. Some information captured by platform 170 for one location can be associated with other locations in the multi-location network. In some embodiments, only partial information is shared (i.e., asymmetrically shared) among locations (e.g., for privacy reasons), an example of which is described below.

In the example of FIG. 56, John has authenticated at an Acme Clothing location. For example, John has logged into Acme Clothing's WiFi and granted permission to platform 170 to obtain personally identifiable information about him.

In this example, personally identifiable information about John, such as his name and contact information, as well as other information such as his demographic information (e.g., gender, income, etc.), and purchase history are obtained and associated with the MAC address of his device. The information is included in a profile for John.

In this example, platform 170 also detects the presence of John's device at another location in the multi-location network. John has not authenticated at this other location as with at Acme Clothing. However, the presence of John's device can be detected and his device's MAC address obtained. Because John has not authenticated at this other location, his PII (e.g., profile name and contact information) is not made available to the location. However, other information, such as his demographic information can be associated with the MAC address and made available.

Thus, information determined at one location can be leveraged and applied to another location based on the detection of the presence of a device (identified by a device identifier such as MAC address) at the different locations.

If John eventually decides to opt into Fashion Forward, the visitor activity previously determined for his device can be retroactively layered or otherwise associated with John's personally identifiable information.

One example of retroactive layering is as follows. Suppose, for example, that Fashion Forward subscribed to platform 170's service for identifying users at their stores at the beginning of the year. Since that time, John has visited Fashion Forward four times, but has never opted into being identifiable. Thus, Fashion Forward has data about John's device from his four visits, without having any knowledge of John's identity. On his fifth visit, John decides to log into the store's WiFi and opt into being identifiable by Fashion Forward. Now that platform 170 has access to his PII, which is associated with the MAC address of his device, the PII can be associated with the visitor activity data that has previously been determined for the MAC address. John's visitor activity is now connected with his personal information, and his past, present, and future visits are no longer anonymous.

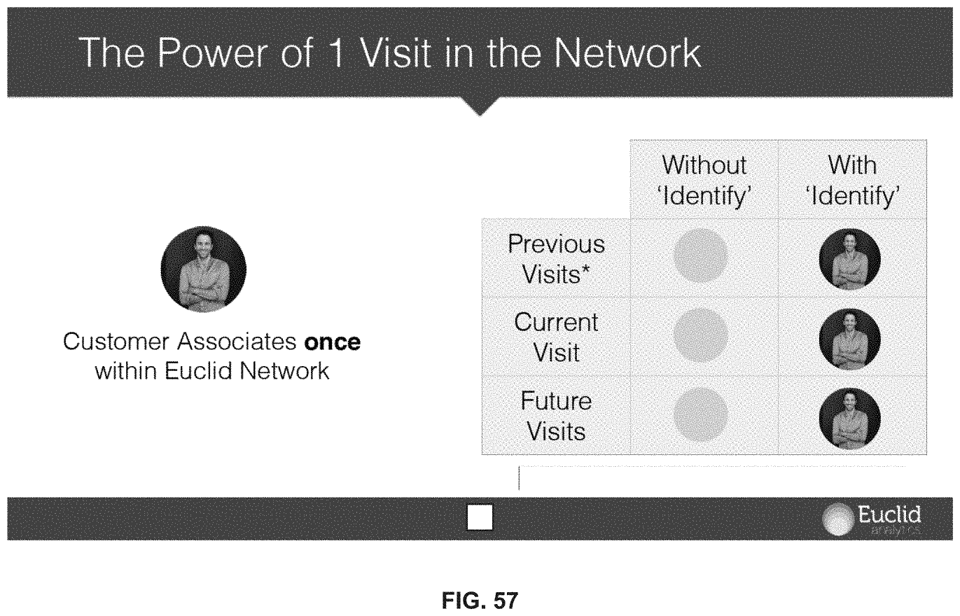

FIG. 57 illustrates an example embodiment of capabilities provided by platform 170. For example, a customer such as John need only associate once with platform 170 in order for platform 170 to associate John's identity with previous visits, current visits, and future visits. For example, previous visits by John's device can be associated with John's identity, as they share a common device identifier (e.g., MAC address). Thus, detected previous visits by John's device (for which there was no PII at the time) can be retroactively associated or attributed with John's personal and demographic information.

Recommendations

The ability to connect user information with devices as described above can be used to improve the recommendations that can be made to users.

As one example, recommendations can be made based on information integrated from multiple data sources and channels. For example, a user's physical visit data can be integrated with their online data, connecting the user's online and offline information. For example, John's browsing history on ACME Clothing's website can be used to determine what to recommend to John when he is visiting a brick and mortar location. The recommendation can be determined by platform 170 and communicated, for example, to an employee engagement app as described above. A store associate can then provide John a recommendation of an in-store item based on his online data. Similarly, when John visits ACME Clothing's website, a recommendation to him online can be made based on his in store visit behavior, or the behavior of other users determined to be similar to him (e.g., based on similar demographic characteristics).

Various types of recommenders can be used to make recommendations of objects for users. For example, a person-based recommender can be used. Suppose, for example, that John has bought items A, B, and C. If another user, James, buys items A and B, then item C can be recommended to James. An item-based recommender can also be used as well. For example, items can be classified (e.g., based on categories). If John has bought a certain item, other items determined to be related to what John has previously purchased can be recommended to him either online or in store.

The inputs to the recommenders can include, in various embodiments, identifiers of inputs (e.g., stock keeping units (SKUs), a user's online behavior (e.g., what online departments they visited, what items they have placed in their cart), a user's online/offline purchase history, a user's visit activity (e.g., zoning, loyalty), etc. The recommenders can also take into account temporal factors, where certain items are recommended on a time driven basis (e.g., if a person has just bought socks, do not recommend socks for several months until they might wear out and the person will need new socks).

Look Alike Audiences

In some embodiments, the user information obtained for users that have opted into being identifiable is used to determine look alike audiences within the opt out data set (data for devices whose users are anonymous) maintained by platform 170. Profiles for the users of devices of the opt out data set can then be built using the information of similar opt-in users.

As one example, suppose that in addition to ACME Clothing, John also visits certain types of bars, restaurants and sporting venues. Suppose that another device detected by platform 170, associated with an anonymous user, is observed as visiting similar places as John. Platform 170 can infer that the user of the anonymous device is demographically similar to John. John's demographic information can be added to the profile associated with the anonymous device.

As one example, platform 170 can perform a match (e.g., fuzzy match) to determine devices (identified by MAC addresses) that have visited similar locations, or have similar visit behavior. For example, the users of anonymous devices that have the same movement patterns within a location (e.g., similar visit frequency, duration in certain zones, loyalty, etc.) as devices with opt-in users can be determined to have similar user attributes. The identification, using opt-in data, of look-alike audiences within an opt-out data set allows platform 170 to leverage the opt out of network to have a much larger sample size of visit behavior when analyzing for various segments of users. For example, more devices with certain demographic characteristics can be identified.

Changing Devices

The following is an example of platform 170 managing changing of devices by users. Suppose for example, that John, when opting in, used an iPhone 5. At a later time, John obtains a new phone. If John logs into ACME Clothing's WiFi again (performing the login process again, as described above), and provides his email address once again, the email address can be used to associate the information collected about his new device with the information previously collected about him and his older device.

Example Timeline

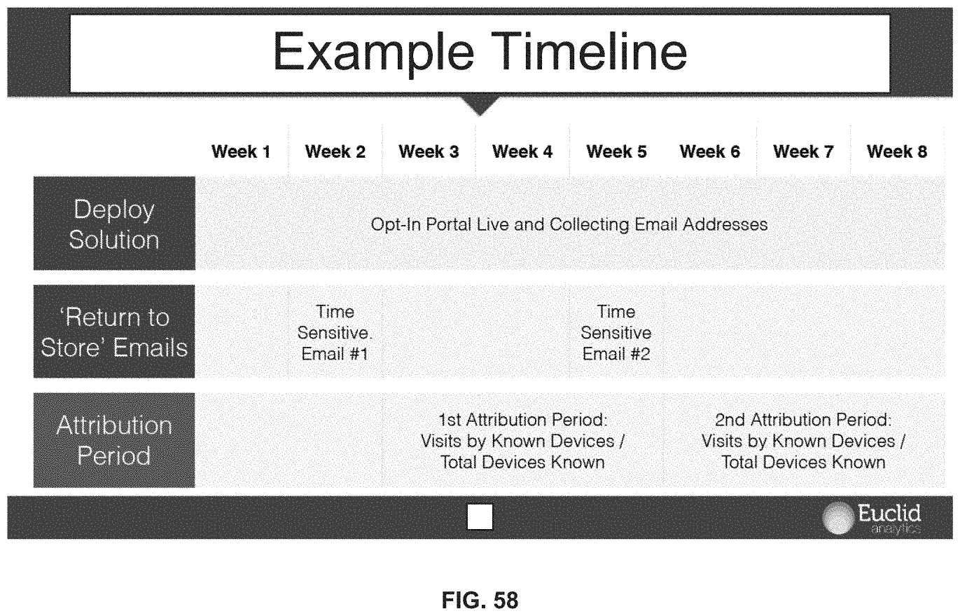

FIG. 58 illustrates an embodiment of a timeline associated with attributing device visits to the sending of time sensitive emails. For example, deploying the solution described herein includes providing opt-in portals and collection of email addresses. While the solution is deployed, “return to store” emails can be sent (an example of direct to consumer engagement outside the four walls of a store). These emails can include time sensitive emails sent at particular points in time. Following each of the time sensitive emails are corresponding attribution periods, where visits by known devices detected during an attribution period can be attributed to the sending of a particular or corresponding time sensitive “return to store” emails preceding the attribution period. In some embodiments, the attribution of device visits to the sending of time sensitive emails can be computed as a proportion of total devices known. The effectiveness of sending time sensitive emails can then be determined.

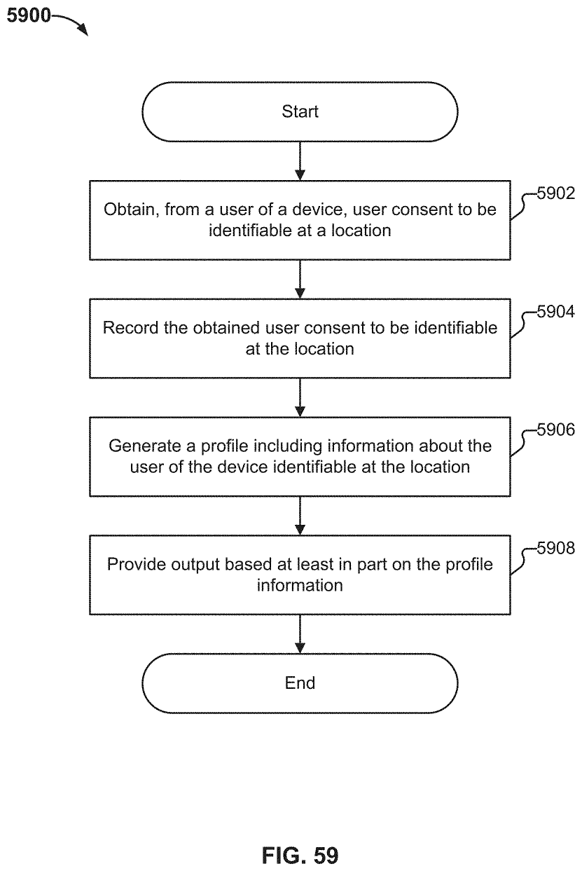

FIG. 59 is a flow diagram illustrating an embodiment of a process for associating a user identity with a device. In some embodiments, process 5900 is executed by platform 170. The process begins at 5902 when user consent to be identifiable at a location is obtained from a user of a device present at the location. For example, as described above in the example environment of FIG. 35, a user connects their device to a WiFi access point at the location. The access point can facilitate acquisition of the user consent as a condition of logging into or associating with a location's WiFi. In some embodiments, the device identifier (e.g., MAC address) of the device used by the user is captured (e.g., by the sensor with which the device is connecting).

In some embodiments, information about the user is obtained. For example, the user can be prompted to provide access to user information when consenting to being identifiable. As one example, the user can provide contact information (e.g., email address, phone number, etc.) when opting into being identifiable.

As another example, the user can opt in by logging in via a social media account (e.g., Facebook account, Google account, etc.). In some embodiments, when a user performs a social media login, their credentials are used to authenticate the user and authorize (e.g., via OAuth) access to the user's information. For example, auth server 3602 is used to perform the authentication and authorization. User information is obtained from the external account. The user information can include personally identifiable information (PII) such as name, birthdate, contact information, etc. The obtained user information can also include non-PII such as demographic information including age, zip code, gender, income bracket, etc.

The user information can be packaged (e.g., by a sensor or auth server in communication with platform 170) and obtained by platform 170. In some embodiments, the packaged data includes the user's device identifier and an identifier of the location (e.g., store or any other physical location, as appropriate) at which the user is providing consent are obtained by a platform such as platform 170 (e.g., from the sensor). An example of a location identifier is a MAC address of the sensor (e.g., access point) used to facilitate acquisition of the user consent.

At 5904, the user consent to be identifiable at the location is recorded. As one example, the identifier of the device (e.g., MAC address) with which the user provided consent is stored with an identifier representative of the location (e.g., sensor MAC address) at which the consent was provided. This tuple (of device and location at which the user of the device has opted into being identifiable) can be stored to a list of tuples that indicate the locations at which the user of the device has consented to being identifiable. If the location is one of multiple locations operated by an entity, an identifier of the entity can be stored as well. For example, while John opted into being identifiable at an ACME Clothing store in San Francisco, ACME Clothing may operate many branches. When John opts in at the San Francisco store, he becomes identifiable at any ACME Clothing location that he may visit. In some embodiments, the operating entity is determined using sensor metadata, such as a sensor network hierarchy as described above.

At 5906, a profile for the user of the device identifiable at the location is created. An example of a profile is shown in FIG. 56. For example, a record can be created that includes the device identifier (e.g., MAC address) and any user information (e.g., PII and non-PII user information, as described above) for the user of the device. As described above, when, for example, a user opts in to being identifiable using their social media account, PII and demographic information about the user can be obtained by platform 170. This information can then be stored to the user's profile. In the case of a user providing contact information such as an email address, a service such as Rapply can be used to obtain demographic information for the email address. The contact information and the demographic information are stored as part of the user's record. In some embodiments, the information about the user is encrypted, as described above.

The profile of the user can be augmented with various information. For example, the user profile can be augmented with visit behavior data. In some embodiments, the device identifier associated with the user's profile is used as a key (e.g., hashed key) to obtain visit behavior of the user's device, such as zoning information, loyalty information, and metrics (e.g., duration, bounce rate, visit frequency, repeat rate, etc.) determined as described above.

As another example, the user's profile can be augmented with user preferences with respect to being identifiable. For example, when the user provides consent to being identifiable, they can be provided the option to select various preferences. As one example, the user can indicate that they do not wish to be bothered when they are detected as being in a location (e.g., the user does not want store associates to come up to them when they are at a store).

The user profile information can also be augmented or integrated with other information. For example, a user's profile information and physical visit behavior (e.g., zoning, loyalty, duration, bounce rate, visit frequency, etc.) at a location can be integrated with information that an entity associated with the location has for the user. As shown in the examples described above, John's physical visit behavior can be integrated with his ACME Clothing online store behavior. His physical visit behavior can also be integrated with his purchase history (e.g., obtained from point of sale information). This allows various information about John as a shopper, from his online and offline visit information to his purchase history, to be integrated together. For example, if John's email address is also used as his username for his online account, ACME Clothing can integrate information about what he has searched for online with his user profile on platform 170. Thus, his online and offline information is connected. Various actions can then be performed.

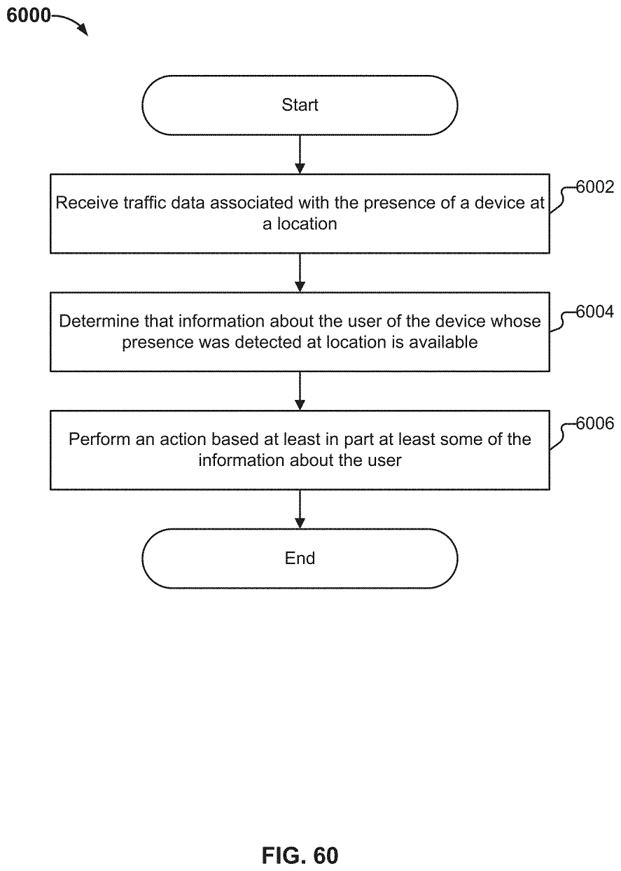

At 5908, output is provided based at least in part on the information included in the generated profile of the user. Various outputs and actions can be performed based on the connection of a user identity to a detected device. As described above, the integrated information about a user can be provided to an employee engagement app. In the examples above, John's ACME Clothing information, such as his size information, purchase history, historical visit data and behavior, etc. can be packaged and sent to an employee engagement app, allowing a store associate to provide John with a personalized shopping experience when he is detected at the store (e.g., using process 6000 of FIG. 60 described in further detail below).

The information about the user can also be used to facilitate direct to consumer promotions. For example, as described above, if the user's contact information is obtained, messages can be sent to the user. For example, text messages can be sent to a user when the presence of their device is detected at a location. As another example, email messages can be sent to a user when they are outside of the store.

As another, John's information with respect to the location can be used to (e.g., his size information for various articles of clothing, known to ACME Clothing based on his online searches and purchases, can be added to his profile on platform 170.

With the addition of user identity information and the integration of data from other sources (e.g., purchase history and online visitor behavior information from external sources), various types of recommendations can be performed as well. As described above, by integrating online visitor behavior data, when a user is detected at a store, a recommendation can be made to the user about an in-store item based on what was seen in the user's online shopping cart. Likewise, in store purchases can be used to recommend items for both online and future in store visits.

Recommendations for one user can also be made based on the purchase history of other users. For example, suppose that John has bought a particular shirt, a particular pair of pants, and a particular belt. Another user, Finn, has bought the same shirt and pants. The belt that John bought can be recommended to Finn, either online or in-store.

Recommendations can also be made on an item basis. For example, items (identified by SKUs) can be categorized. If a user buys one type of item online, a related item can be recommended to them when they are in-store. In some embodiments, platform 170 is integrated with a store inventory checker, which can be used to determine whether a recommended item is in a store's inventory. If so, then the item can be recommended. If not, then another item can be recommended. The store can also be notified that it should stock the recommended item.

In some embodiments, the user identity information obtained for opt in devices/users can be used to determine lookalike audiences in opt-out/anonymous devices. An example process for determining lookalike audiences is described below in conjunction with FIG. 6100. For example, suppose that John and Finn are determined to be similar because the locations that they visit (e.g., bars, restaurants, stores, etc.) are similar. John has opted into being identifiable, but Finn has not, and thus, platform 170, while having information about Finn's device movement and visit behavior, has no information about Finn. In this example, because Finn is inferred as being similar to John based on device movement, John's profile information can be used to build Finn's profile. For example, John's non-PII information, such as his demographic information can be applied to Finn's profile (e.g., his device identifier can be associated with the same demographic information as John), because it has been inferred that Finn should be demographically similar to John based on their visiting the same or similar locations in the real world. Thus, user information associated with opt-out or anonymous device can be inferred or otherwise determined. This in turn can provide a large population when performing analysis of visitor behavior or other data. For example, the visit behavior data of larger demographic segments can be leveraged to determine insights into detected devices.

In some embodiments, the user information for an identified user can be used to provide relevant context in various scenarios. As described above, when a user is detected at a location, a digital display can be provided the relevant context for the user (e.g., information about the detected user) so that content personalized to the user can be displayed. As another example, if a user is communicating with a chatbot, as described above, relevant context about the user (e.g., their movements in a store, their purchase history, online visit behavior, zoning behavior, etc.) can be used by the chatbot to provide personalized engagement with the user.

In some embodiments, as described above, the layering of user identity on physical visit behavior can be used to provide insights about detected devices. For example, the visitor metrics determined above (e.g., zoning, loyalty, duration, visit frequency, bounce rate, etc.) can be segmented based on user demographic information (e.g., age, gender, zip code, income bracket, etc.). Reports, such as those described above, can be provided as output.

In some embodiments, the user identity and physical visit behavior data can be integrated (e.g., exported to) CRM systems of customers utilizing the services of platform 170. For example, a CRM system may already include data about a particular user. Because platform 170 can determine the identity of the user of a detected device, the physical visit behavior of the user can be exported and added to a record for the user in the CRM system. As another example, suppose that a user has opted into being identifiable at ACME Clothing and has provided information about themselves, such as their contact information. However, that user has never been seen before by ACME Clothing, and ACME Clothing has no record of them in their CRM system. The new user can be added as a new entry to ACME Clothing's CRM system, along with his profile information and visit behavior collected by platform 170.

FIG. 60 is a flow diagram illustrating an embodiment of a process for obtaining information associated with a user associated with a detected device. In some embodiments, process 6000 is executed by platform 170. The process begins at 6002 when traffic data associated with the presence of a device at a location is received. As one example, such traffic data is received at 6002 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). The presence of the device at the location is detected from the received traffic data.

At 6004, it is determined whether user information is available for the device detected at the location. The determination can be made dynamically, in real time. In some embodiments, this includes determining whether the device is associated with a user that has opted into being identifiable at the location.

For example, in some embodiments, a MAC address (or any other appropriate identifier) of the detected device, as well as the MAC address (or any other appropriate identifier) of the sensor that detected the device is obtained along with the traffic data obtained at 6002. For example, the device MAC address can be used to access a corresponding list of MAC address and location tuples, as described above, which indicate the locations for which the user of the device has consented to being identifiable

As described above, sensor metadata can be used to determine the location in which the sensor is included (e.g., human friendly location, name of the owner of the sensor, etc.) can be determined. The MAC address and the location information can be used to determine whether a user of the device has previously consented to being identifiable at the location that includes the sensor (e.g., using process 5900 of FIG. 59).

If it is determined that the user of the detected device has consented to being identifiable at the location, then the user is identified and personal information about the user (e.g., name, birthday, contact information, demographic information, etc.) is obtained (e.g., using the detected device's MAC address as a key to access the user's profile). In some embodiments, keys for the operator of the location are used to access location-specific information (e.g., the user's online behavior for the specific location). The key can be used to prevent John's shopping history associated with another entity (e.g., another customer utilizing the services of platform 170) being accessed. Other information associated with the user, such as demographic information (e.g., age, gender, zip code, income bracket, etc.) as well as information from other sources (e.g., online data, purchase data, etc.) can also be obtained. As another example, preference data (e.g., indicating the user does not wish to be bothered while at a location) can be obtained.

In some embodiments, if the user of the device has not consented to being identifiable at the location (e.g., an anonymous device), it is determined whether there is non-personally identifiable information that can be obtained available that can be associated with the detected device. As described above, if the user is determined to have been identifiable at another location and there is therefore information about the user that is available, the non-PII (e.g., demographic data) is obtained. An example of asymmetric sharing of user information is described in conjunction with FIG. 56. As described above, if the user of the device consents to being identifiable at the location, then the user's profile for the location can be back populated.

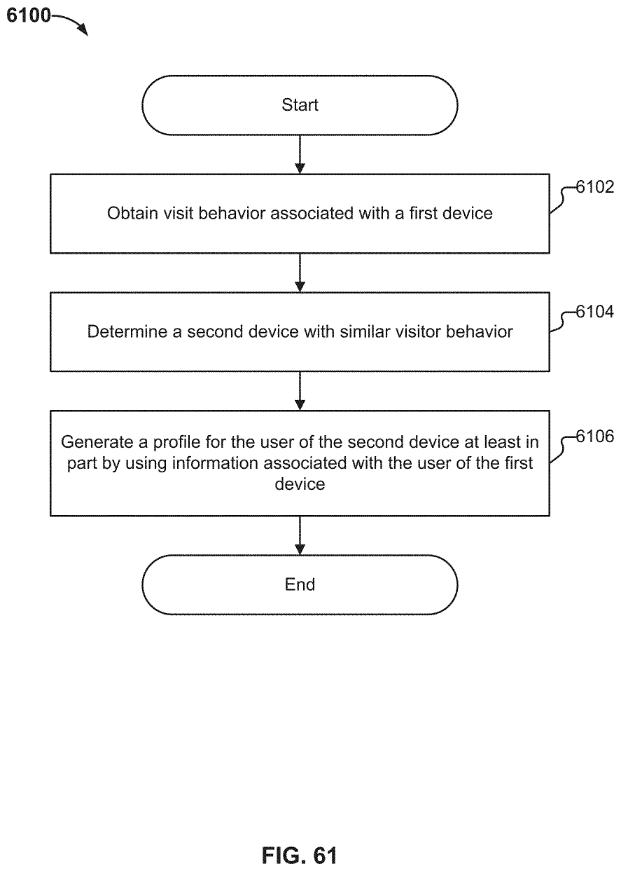

In some embodiments, if the user of the detected device is not identifiable at any location, there may still be a profile for the user of the device (including only non-personal information) that is built based on the non-personal information (e.g., demographic data) for similar opt-in users (e.g., using process 6100 of FIG. 61). The non-PII user information can then be obtained. Thus, both opt-in and opt-out devices/users can be supported.

At 6006, an action is performed based on the obtained information. As one example, real-time actions can be performed. For example, if contact information for the user of the device is available, it can be used to directly message the user when their device's presence is detected. As described above, if the phone number of the user is available, then a text message can be sent to the user's phone welcoming them (back) to the store.

The obtained information about the user can be used to perform other actions while the user is detected at the location. As another example, information about the user can be sent to an employee engagement app of a store associate at the location, as described above. This allows for the associate to provide a personalized experience to the identified user of the device. As described above, the information about the detected user can also be used to provide relevant context to other services such as chatbots, as well as digital displays. Recommendations based on the information about a user, as described above, can also be provided while the user is detected at the location (e.g., to the employee engagement app, chatbots, digital displays, etc.).

Regardless of whether the detected device is associated with an opt in or anonymous user, the visit behavior determined using the techniques described above can still be performed. For example, determining qualified devices using zone information (as described in conjunction with process 500 of FIG. 5), assessing visitor composition (as described in conjunction with process 2600 of FIG. 26), determining co-visits (as described in conjunction with process 3200 of FIG. 32), determining re-visitation (as described in conjunction with process 3300 of FIG. 33), and assessing visitor frequency (as described in conjunction with process 3400 of FIG. 34) can be performed for detected devices regardless of whether there is user information available for the user of the device. Other visit behavior metrics such as those described throughout can be computed for the detected device.

FIG. 6100 illustrates an example embodiment of a flow diagram for generating a profile for an anonymous user of a device. In some embodiments, process 6100 is executed by platform 170. The process begins at 6102, when the visit behavior associated with a first device is obtained, the first device associated with a user who has opted into being identifiable and has a profile with user information such as personally identifiable or non-personally identifiable information (e.g., demographic information).

At 6104, a second device with similar visitor behavior is determined. In some embodiments, the second device is determined to be similar to the first device if both devices have been observed as visiting similar locations (e.g., the same locations or similar types of locations).

If the second device is anonymous, the user of the second device can be inferred as being similar to the user of the first device based on the determination that the two devices have similar physical world visit patterns.

At 6106, a profile of the user of the second device is generated based at least in part on information about the user of the first device. For example, non-personal information about the user of the first device, such as demographic information (e.g., age, gender, zip code, income bracket, etc.) can then be used to build a profile for the user of the second device. Thus, information about the user of the second device is inferred or otherwise determined. Opt out devices, now associated with demographic information, can be leveraged to provide greater insights about visitor behavior with respect to certain demographic segments. For example, a larger number of devices can be identified as being part of particular demographic segments (not just opt in devices). Various analysis can then be performed. As one example, an analysis of zoning behavior by certain segments can be performed that leverages the data of both opt in and opt out users.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
detect, based at least in part on traffic data obtained from a sensor, a presence of a device at a location;
determine an identity of a user associated with the device whose presence is detected at the location; and
perform an action based at least in part on the determined user identity; and
a memory coupled to the one or more processors and configured to provide the one or more processors with instructions.

2. The system recited in claim 1 wherein determining the identity of the user includes determining that the user has previously consented to being identifiable at the location.

3. The system recited in claim 1 wherein determining that the user has previously consented to being identifiable at the location is based at least in part on at least one of an identifier associated with the device and an identifier associated with the sensor.

4. The system recited in claim 1 wherein the one or more processors are further configured to access profile information associated with the determined user identity.

5. The system recited in claim 4 wherein the profile information associated with the determined user identity is accessed based at least in part on an identifier associated with the device.

6. The system recited in claim 1 wherein performing the action includes:
obtaining contact information associated with the user; and
transmitting, based at least in part on the obtained contact information, a message to the device while the device is detected at the location.

7. The system recited in claim 6 wherein the contact information includes a phone number and wherein the transmitted message comprises a text message.

8. The system recited in claim 1 wherein performing the action includes transmitting a notification to an employee engagement application indicating that the identified user is present at the location.

9. The system of claim 8 wherein the one or more processors are further configured to transmit information associated with the determined user identity to the employee engagement application.

10. The system of claim 9 wherein the information transmitted to the employee engagement app includes at least one of historical visit activity, online behavior, and purchase history.

11. The system of claim 9 wherein the information transmitted to the employee engagement app includes a recommendation to be made to the user while at the location.

12. The system of claim 11 wherein the recommendation to be made at the location is based at least in part on online activity information associated with the user.

13. The system of claim 1 wherein performing the action includes transmitting instructions to a digital display at the location.

14. The system of claim 13 wherein the transmitted instructions include content to be displayed on the digital display, wherein the content is determined based at least in part on information associated with the determined user identity.

15. The system of claim 1 wherein the one or more processors are further configured to transmit a message to the user associated with the device at a time that the presence of the device is not detected at the location.

16. The system recited in claim 1 wherein the one or more processors are further configured to export information associated with the user to an external customer relationship management (CRM) system.

17. The system recited in claim 1 wherein the one or more processors are further configured to:
receive traffic data associated with the presence of a plurality of devices at the location; and
segment the devices based at least in part on a demographic condition, wherein the detected device is included in the segment based at least in part on demographic information associated with the user associated with the detected device.

18. The system recited in claim 1 wherein the one or more processors are further configured to detect, based at least in part on the traffic data obtained from the sensor, a presence of another device at the location, wherein a user associated with the other device is anonymous.

19. A method, comprising:
detecting, based at least in part on traffic data obtained from a sensor, a presence of a device at a location;
determining, using one or more processors, an identity of a user associated with the device whose presence is detected at the location; and
perform an action based at least in part on the determined user identity.

20. A computer program product, the computer program product being embodied in a non-transitory computer readable storage medium and comprising computer instructions for:
detecting, based at least in part on traffic data obtained from a sensor, a presence of a device at a location;
determining, using one or more processors, an identity of a user associated with the device whose presence is detected at the location; and
performing an action based at least in part on the determined user identity.
